(19) United States
(12) Patent Application Publication
(10) Pub. No.: US 2011/0122153 A1
(43) Pub. Date: May 26, 2011

(54) INFORMATION PROCESSING APPARATUS, INFORMATION PROCESSING METHOD, AND PROGRAM

(76) Inventors: Yuki OKAMURA, Saitama (JP); Daisuke Mochizuki, Chiba (JP); Akiko Terayama, Tokyo (JP); Takuro Noda, Tokyo (JP); Eijiro Mori, Tokyo (JP); Takuo Ikeda, Tokyo (JP)

(21) Appl. No.: 12/908,779

(22) Filed: Oct. 20, 2010

(30) Foreign Application Priority Data
Nov. 26, 2009 (JP) P2009-268661

(51) Int. Cl. G09G 5/00

(52) U.S. Cl. 345/629

(57) ABSTRACT

An information processing apparatus includes a transformed-coordinate calculating section that calculates transformed coordinates for each of a plurality of superimposed images associated with coordinates in a background image, by transforming coordinates of other superimposed images with respect to one superimposed image as a reference image in such a way that coordinate intervals within a predetermined area with respect to the reference image become denser with increasing distance from the reference image toward the boundary, a coordinate setting section that sets coordinates of the reference image on the basis of a mean value obtained by calculating a mean of the calculated coordinates of the other superimposed images with respect to the reference image, and a display control section that displays the background image and the plurality of superimposed images on a display section in such a way that the reference image is placed at the set coordinates in the background image.

### BACKGROUND OF THE INVENTION

1. Field of the Invention

The present invention relates to an information processing apparatus, in particular, an information processing apparatus which displays contents such as image files, an information processing method, and a program for causing a computer to execute the information processing method.

2. Description of the Related Art

In recent years, there has been a proliferation of image capturing apparatuses such as a digital still camera and a digital video camera (for example, an integrated camera-recorder) which capture a subject such as a landscape or a person to generate an image, and record the generated image as an image file (content). Also, there are image capturing apparatuses which can record a generated image in association with positional information on the position where the image is captured. There have been proposed information processing apparatuses with which, when displaying contents generated in this way, the generated positions of the contents identified by their positional information are displayed in association with the contents.

For example, there has been proposed an information processing apparatus which arranges thumbnail icons of images side by side in time series and displays the thumbnail icons in a film window, displays position icons indicating the shooting locations of these images in a map window, and displays these icons in association with each other (see, for example, Japanese Unexamined Patent Application Publication No. 2001-160058 (FIG. 12)). This information processing apparatus is configured such that, for example, when a click operation on a thumbnail icon is performed by the user, a position icon indicating the shooting location of an image corresponding to the clicked thumbnail icon is displayed at the center of the map window.

Also, there has been proposed an information processing system which arranges thumbnail images side by side in time series and displays the thumbnail images on an image list display section, displays markers at positions on a map corresponding to the shooting locations of these images, and displays these images and markers in association with each other (see, for example, Japanese Unexamined Patent Application Publication No. 2007-323544 (FIG. 7)). In this information processing system, when a click operation on a marker displayed on the map is performed by the user, an image associated with the clicked marker is displayed on the map as a pop-up.

### SUMMARY OF THE INVENTION

According to the related art described above, images representing contents are displayed while being arranged side by side, and marks indicating the generated positions of these contents are displayed on a map. Thus, the user can grasp the correspondence between individual contents and their generated positions on a single screen. Also, the correspondence between each individual content and its generated position can be grasped more clearly through a click operation on an image representing a content or a mark indicating its generated position.

However, in the related art described above, images representing contents, and marks indicating the generated positions of these contents are displayed relatively far apart from each other, which supposedly makes it difficult to intuitively grasp the geographical correspondence between individual contents.

Also, for example, it is supposed that images taken by a person living in Tokyo include relatively many images of Tokyo and its vicinity (for example, Shinagawa ward, Setagaya ward, and Saitama city), and relatively few images of other regions (for example, United States or United Kingdom visited by the person on a trip). Accordingly, when displaying the correspondence between images taken in Tokyo and its vicinity and images taken in other regions, and their generated positions, for example, it is necessary to display the map at a scale sufficiently large to show the countries of the world. In this case, marks indicating the generated positions of the images taken in Tokyo and its vicinity (for example, Shinagawa ward, Setagaya ward, and Saitama city) are displayed at substantially the same position on the map, which may make it difficult to grasp the geographical correspondence between the images taken in Tokyo and its vicinity.

On the other hand, for example, when the map is displayed at a scale sufficiently small to show regions in the vicinity of Tokyo, marks indicating the generated positions of the images taken in Tokyo and its vicinity (for example, Shinagawa ward, Setagaya ward, and Saitama city) are displayed in suitable placement on the map. Therefore, the generated positions of the images taken in Tokyo and its vicinity can be grasped. However, in this case, it is not possible to display the generated positions of images taken in other regions (for example, the United States or United Kingdom) on the map, making it difficult to grasp the generated positions of individual images.

Accordingly, when displaying images representing contents associated with positions on a map, it is important to be able to easily grasp the correspondence between a plurality of contents on the map, and each individual content.

It is thus desirable to be able to easily grasp, when displaying superimposed images associated with positions in a background image, the correspondence between a plurality of superimposed images in the background image, and each individual superimposed image.

According to an embodiment of the present invention, there are provided an information processing apparatus, an information processing method, and a program for causing a computer to execute the information processing method, the information processing apparatus including: a transformed-coordinate calculating section that calculates transformed coordinates for each of a plurality of superimposed images associated with coordinates in a background image, by taking one superimposed image of the plurality of superimposed images as a reference image, and transforming coordinates of other superimposed images on the basis of corresponding coordinates of the reference image in the background image, distances in the background image from the reference image to the other superimposed images, and a distance in the background image from the reference image to a boundary within a predetermined area with respect to the reference image, the coordinates of the other superimposed images being transformed in such a way that coordinate intervals within the predetermined area become denser with increasing distance from the reference image toward the boundary within the predetermined area; a coordinate setting section that sets coordinates of the reference image on the basis of a mean value obtained by calculating a mean of the calculated coordinates of the other superimposed images with respect to the reference image; and a display control section that displays the background image and the plurality of superimposed images on a display section in such a way that the reference image is placed at the set coordinates in the background image. Therefore, transformed coordinates are calculated for each of superimposed images by transforming coordinates of other superimposed images in such a way that coordinate intervals within a predetermined area become denser with increasing distance from a reference image toward a boundary within the predetermined area, and coordinates of the reference image are set on the basis of a mean value obtained by calculating a mean of the calculated coordinates of the other superimposed images with respect to the reference image, and a background image and a plurality of superimposed images are displayed in such a way that the reference image is placed at the set coordinates in the background image.

Also, in an embodiment of the present invention, the information processing apparatus may further include a second transformed-coordinate calculating section that calculates transformed coordinates for each of the superimposed images by transforming the set coordinates on the basis of a size of the background image on a display screen of the display section, the number of the superimposed images, and distances between the superimposed images in the background image, the set coordinates being transformed in such a way that the distances between the superimposed images increase under a predetermined condition in accordance with the distances between the superimposed images in the background image, and the display control section may display the background image and the plurality of superimposed images in such a way that the superimposed images are placed at the coordinates in the background image calculated by the second transformed-coordinate calculating section. Therefore, transformed coordinates are calculated for each of the superimposed images by transforming the coordinates in such a way that the distances between the superimposed images increase under a predetermined condition in accordance with the distances between the superimposed images in the background image, and the background image and the plurality of superimposed images are displayed in such a way that the superimposed images are placed at the calculated coordinates in the background image.

Also, in an embodiment of the present invention, the information processing apparatus may further include a magnification/shrinkage processing section that magnifies or shrinks the coordinates calculated by the second transformed-coordinate calculating section with reference to a specific position on the display screen, on the basis of a coordinate size subject to coordinate transformation by the second transformed-coordinate calculating section, and a size of the background image on the display screen of the display section, and the display control section may display the background image and the plurality of superimposed images in such a way that the superimposed images are placed at the coordinates in the background image magnified or shrunk by the magnification/shrinkage processing section. Therefore, the coordinates of the superimposed images are magnified or shrunk with reference to a specific position on the display screen, and the background image and the plurality of superimposed images are displayed in such a way that the superimposed images are placed at the magnified or shrunk coordinates in the background image.

Also, in an embodiment of the present invention, the background image may be an image representing a map, and the superimposed images may be images representing a plurality of contents with each of which positional information indicating a position in the map is associated. Therefore, images representing a map and a plurality of contents are displayed so that the reference image is placed at the set coordinates on the map.

Also, in an embodiment of the present invention, the information processing apparatus may further include a group setting section that sets a plurality of groups by classifying the plurality of contents on the basis of the positional information, and a mark generating section that generates marks representing the groups on the basis of the positional information associated with each of contents belonging to the set groups, and the display control section may display a listing of the marks representing the groups as the superimposed images. Therefore, a plurality of groups are set by classifying the plurality of contents on the basis of the positional information, marks representing the groups are generated on the basis of the positional information associated with each of contents belonging to the set groups, and a listing of the marks representing the groups is displayed as the superimposed images.

Also, in an embodiment of the present invention, the mark generating section may generate maps as the marks representing the groups, the maps each corresponding to an area including a position identified by the positional information associated with each of the contents belonging to the set groups. Therefore, maps are generated as the marks representing the groups, the maps each corresponding to an area including a position identified by the positional information associated with each of the contents belonging to the set groups.

Also, in an embodiment of the present invention, the mark generating section may generate the marks representing the groups by changing a map scale for each of the set groups so that each of the maps becomes an image with a predetermined size. Therefore, the marks representing the groups are generated by changing a map scale for each of the set groups so that each of the maps becomes an image with a predetermined size.

Also, in an embodiment of the present invention, the information processing apparatus may further include a background map generating section that generates a background map corresponding to each of the groups at a scale determined in accordance with a scale of each of maps generated as the marks representing the groups, and the display control section may display, as the background image, the background map generated with respect to a group corresponding to a map selected from among the displayed listing of maps. Therefore, a background map corresponding to each of the groups is generated at a scale determined in accordance with a scale of each of maps generated as the marks representing the groups, and as the background image, the background map generated with respect to a group corresponding to a map selected from among the displayed listing of maps is displayed.

### BRIEF DESCRIPTION OF THE DRAWINGS

FIG. 1 is a block diagram showing an example of the functional configuration of an information processing apparatus according to a first embodiment of the present invention;

FIGS. 2A and 2B are diagrams showing an example of the file structure of an image file stored in a content storing section according to the first embodiment of the present invention;

FIG. 3 is a diagram schematically showing information stored in an address information storing section according to the first embodiment of the present invention;

FIG. 4 is a diagram schematically showing a method of determining addresses assigned to cluster information generated by a cluster information generating section according to the first embodiment of the present invention;

FIG. 5 is a diagram schematically showing information stored in a cluster information storing section according to the first embodiment of the present invention;

FIGS. 6A to 6D are diagrams showing an example of distances in the case when a tree having a binary tree structure is generated by a tree generating section according to the first embodiment of the present invention;

FIG. 7 is a diagram schematically showing contents stored in a content storing section according to the first embodiment of the present invention;

FIG. 8 is a diagram schematically showing how contents are clustered by a tree generating section on the basis of positional information according to the first embodiment of the present invention;

FIG. 9 is a conceptual clustering tree diagram of a binary tree structure representing binary tree structured data generated with respect to contents by a tree generating section according to the first embodiment of the present invention;

FIG. 10 is a conceptual clustering tree diagram of a binary tree structure representing binary tree structured data generated on the basis of data and time information by an event cluster generating section according to the first embodiment of the present invention;

FIGS. 11A to 11F are diagrams each showing an example of a histogram generated by a hierarchy determining section according to the first embodiment of the present invention;

FIGS. 12A and 12B are diagrams each showing an example of comparison of histograms generated by a hierarchy determining section according to the first embodiment of the present invention;

FIGS. 13A and 13B are diagrams schematically showing the flow of a tree restructuring process by a tree restructuring section according to the first embodiment of the present invention;

FIG. 14 is a diagram showing a correspondence table used for generating map information by a cluster information generating section according to the first embodiment of the present invention;

FIGS. 15A and 15B are diagrams each showing an example of a map generated by a cluster information generating section according to the first embodiment of the present invention;

FIGS. 16A and 16B are diagrams each showing an example of a map generated by a cluster information generating section according to the first embodiment of the present invention;

FIG. 17 is a diagram showing an example of transition of the display screen of a display section which is performed by a display control section according to the first embodiment of the present invention;

FIG. 18 is an example of display of an index screen displayed by a display control section according to the first embodiment of the present invention;

FIG. 19 is an example of display of an index screen displayed by a display control section according to the first embodiment of the present invention;

FIG. 20 is an example of display of an index screen displayed by a display control section according to the first embodiment of the present invention;

FIG. 21 is an example of display of an index screen displayed by a display control section according to the first embodiment of the present invention;

FIG. 22 is a diagram showing an example of display of a content playback screen displayed by a display control section according to the first embodiment of the present invention;

FIG. 23 is a diagram showing an example of display of a content playback screen displayed by a display control section according to the first embodiment of the present invention;

FIG. 24 is a diagram showing an example of display of a content playback screen displayed by a display control section according to the first embodiment of the present invention;

FIG. 25 is a diagram showing an example of display of a content playback screen displayed by a display control section according to the first embodiment of the present invention;

FIG. 26 is a diagram showing an example of display of a content playback screen displayed by a display control section according to the first embodiment of the present invention;

FIGS. 27A and 27B are diagrams each showing an example of display of a cluster map display screen displayed by a display control section according to the first embodiment of the present invention;

FIG. 28 is a flowchart showing an example of the procedure of a content information generation process by an information processing apparatus according to the first embodiment of the present invention;

FIG. 29 is a flowchart showing an example of a hierarchy determination process of the procedure of a content information generation process by an information processing apparatus according to the first embodiment of the present invention;

FIG. 30 is a flowchart showing an example of a tree restructuring process of the procedure of a content information generation process by an information processing apparatus according to the first embodiment of the present invention;

FIG. 31 is a flowchart showing an example of the procedure of a content playback process by an information processing apparatus according to the first embodiment of the present invention;

FIG. 32 is a flowchart showing an example of a content playback screen display process of the procedure of a content playback process by an information processing apparatus according to the first embodiment of the present invention;

FIG. 33 is a flowchart showing an example of a content playback screen display process of the procedure of a content playback process by an information processing apparatus according to the first embodiment of the present invention;

FIG. 34 is a block diagram showing an example of the functional configuration of an information processing apparatus according to a second embodiment of the present invention;

FIG. 35 is a diagram schematically showing a case in which cluster maps to be coordinate-transformed by a non-linear zoom processing section are placed on coordinates according to the second embodiment of the present invention;

FIG. 36 is a diagram schematically showing the relationship between a background map and a cluster map displayed on a display section according to the second embodiment of the present invention;

FIG. 37 is a diagram schematically showing the relationship between a background map and a cluster map displayed on a display section according to the second embodiment of the present invention;

FIG. 38 is a diagram schematically showing a case in which cluster maps subject to a non-linear zoom process by a non-linear zoom processing section are placed on coordinates according to the second embodiment of the present invention;

FIG. 39 is a diagram schematically showing a coordinate transformation process by a non-linear zoom processing section according to the second embodiment of the present invention;

FIG. 40 is a diagram schematically showing a case in which cluster maps that have been coordinate-transformed by a non-linear zoom processing section are placed on coordinates according to the second embodiment of the present invention;

FIG. 41 is a diagram showing an example of a map view screen displayed on a display section according to the second embodiment of the present invention;

FIG. 42 is a diagram schematically showing cluster maps that are subject to a force-directed relocation process by a relocation processing section according to the second embodiment of the present invention;

FIGS. 43A and 43B are diagrams schematically showing cluster maps that are subject to a relocation process by a magnification/shrinkage processing section according to the second embodiment of the present invention;

FIGS. 44A and 44B are diagrams schematically showing a background map generation process by a background map generating section according to the second embodiment of the present invention;

FIG. 45 is a diagram showing the relationship between the diameter of a wide-area map generated by a background map generating section, and the diameter of a cluster map according to the second embodiment of the present invention;

FIG. 46 is a diagram showing an example of a scatter view screen displayed on a display section according to the second embodiment of the present invention;

FIG. 47 is a diagram showing an example of a scatter view screen displayed on a display section according to the second embodiment of the present invention;

FIGS. 48A and 48B are diagrams each showing an example of a scatter view screen displayed on a display section according to the second embodiment of the present invention;

FIG. 49 is a diagram showing an example of transition of the display screen of a display section which is performed by a display control section according to the second embodiment of the present invention;

FIG. 50 is a diagram showing an example of a play view screen displayed on a display section according to the second embodiment of the present invention;

FIG. 51 is a flowchart showing an example of the procedure of a background map generation process by an information processing apparatus according to the second embodiment of the present invention;

FIG. 52 is a flowchart showing an example of the procedure of a content playback process by an information processing apparatus according to the second embodiment of the present invention;

FIG. 53 is a flowchart showing an example of a map view process of the procedure of a content playback process by an information processing apparatus according to the second embodiment of the present invention;

FIG. 54 is a flowchart showing an example of a non-linear zoom process of the procedure of a content playback process by an information processing apparatus according to the second embodiment of the present invention;

FIG. 55 is a flowchart showing an example of a scatter view process of the procedure of a content playback process by an information processing apparatus according to the second embodiment of the present invention;

FIG. 56 is a flowchart showing an example of a force-directed relocation process of the procedure of a content playback process by an information processing apparatus according to the second embodiment of the present invention;

FIGS. 57A and 57B are diagrams for explaining a tree generation process performed by a tree generating section according to a modification of the first embodiment of the present invention;

FIGS. 58A and 58B are diagrams for explaining a tree generation process performed by a tree generating section according to a modification of the first embodiment of the present invention;

FIG. 59A to 59H are diagrams for explaining a tree generation process performed by a tree generating section according to a modification of the first embodiment of the present invention;

FIGS. 60A to 60C are diagrams for explaining a tree generation process performed by a tree generating section according to a modification of the first embodiment of the present invention;

FIGS. 61A and 61B are diagrams for explaining a tree generation process performed by a tree generating section according to a modification of the first embodiment of the present invention;

FIG. 62 is a flowchart showing an example of the procedure of a clustering process by an information processing apparatus according to a modification of the first embodiment of the present invention;

FIG. 63 is a flowchart showing an example of the procedure of a clustering process according to a modification of the first embodiment of the present invention;

FIG. 64 is a flowchart showing an example of the procedure of a clustering process according to a modification of the first embodiment of the present invention;

FIG. 65 is a flowchart showing an example of the procedure of a clustering process according to a modification of the first embodiment of the present invention; and

FIG. 66 is a flowchart showing an example of the procedure of a clustering process according to a modification of the first embodiment of the present invention.

### DESCRIPTION OF THE PREFERRED EMBODIMENTS

Hereinbelow, modes for carrying out the present invention (hereinafter, referred to as embodiments) will be described. The description will be given in the following order.

1. First Embodiment (cluster information generation control; example of generating cluster information on the basis of positional information and date and time information)

2. Second Embodiment (cluster information display control; example of displaying cluster information while taking geographical position relationship into consideration)

3. Modifications

### 1. First Embodiment

### Example of Configuration of Information Processing Apparatus

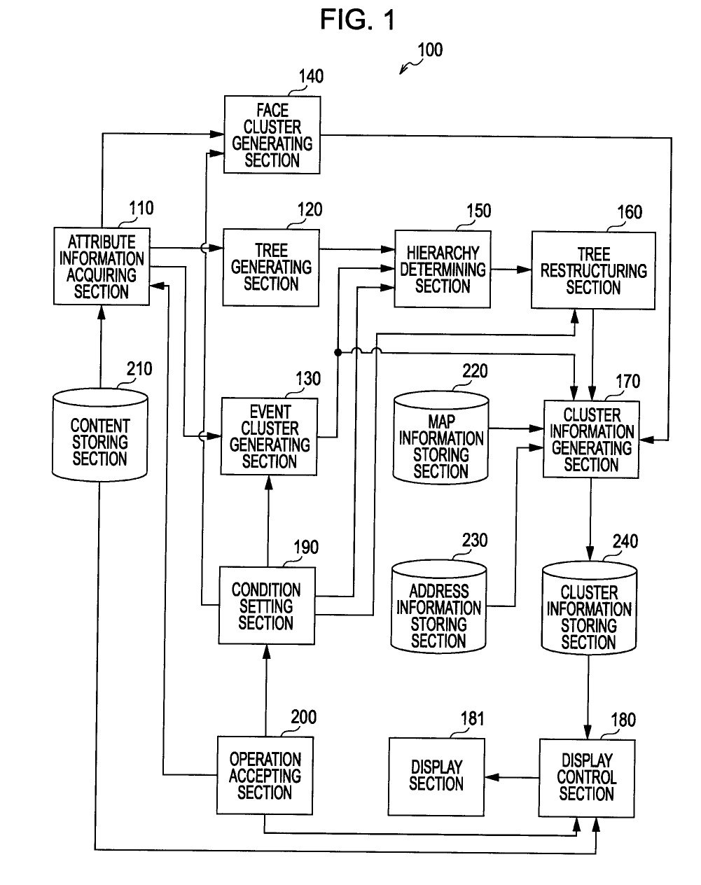

FIG. 1 is a block diagram showing an example of the functional configuration of an information processing apparatus 100 according to a first embodiment of the present invention. The information processing apparatus 100 includes an attribute information acquiring section 110, a tree generating section 120, an event cluster generating section 130, a face cluster generating section 140, a hierarchy determining section 150, a tree restructuring section 160, and a cluster information generating section 170. In addition, the information processing apparatus 100 includes a display control section 180, a display section 181, a condition setting section 190, an operation accepting section 200, a content storing section 210, a map information storing section 220, an address information storing section 230, and a cluster information storing section 240. The information processing apparatus 100 can be realized by, for example, an information processing apparatus such as a personal computer capable of managing contents such as image files recorded by an image capturing apparatus such as a digital still camera.

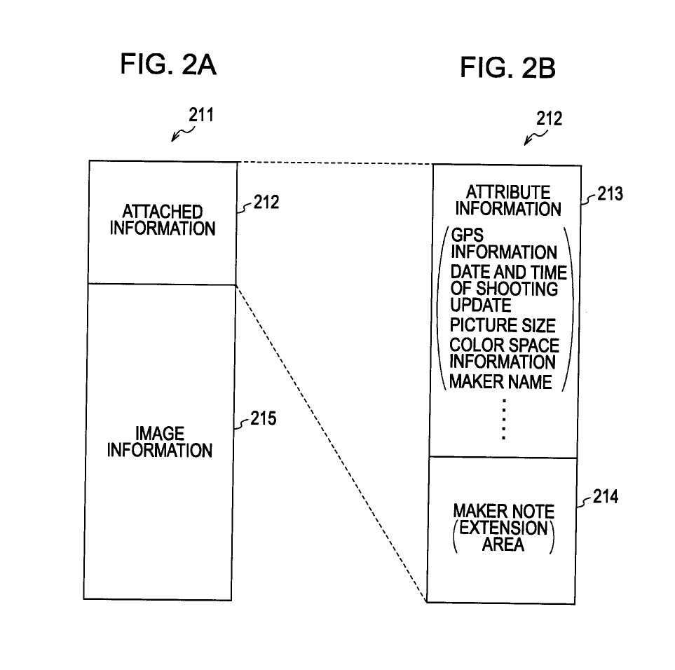

The content storing section 210 stores contents such as image files recorded by an image capturing apparatus such as a digital still camera, and supplies the stored contents to the attribute information acquiring section 110 and the display control section 180. Also, attribute information including positional information and date and time information is recorded in association with each content stored in the content storing section 210. It should be noted that a description of contents stored in the content storing section 210 will be given later in detail with reference to FIGS. 2A and 2B.

The map information storing section 220 stores map data related to maps displayed on the display section 181. The map information storing section 220 supplies the stored map data to the cluster information generating section 170. For example, the map data stored in the map information storing section 220 is data identified by latitude and longitude, and divided into a plurality of areas in units of predetermined latitude and longitude widths. Also, the map information storing section 220 stores map data corresponding to a plurality of scales.

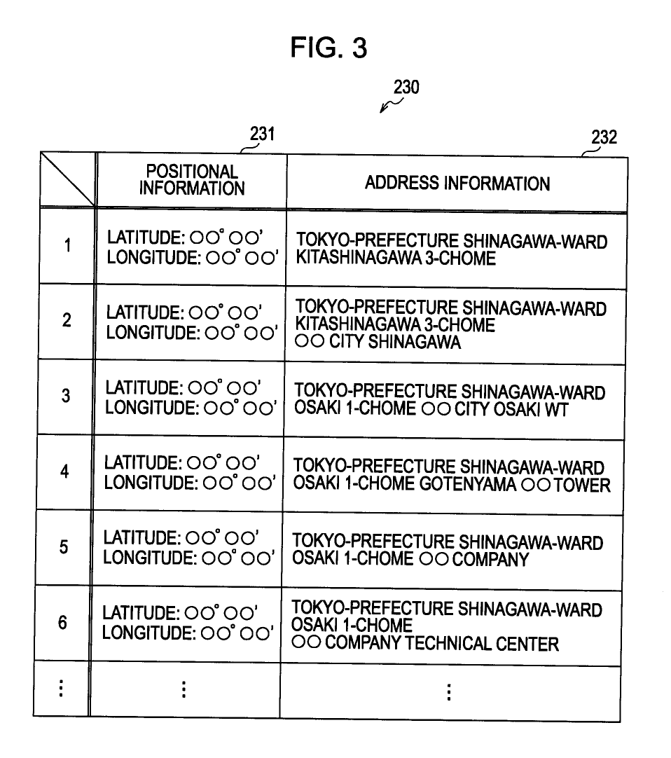

The address information storing section 230 stores conversion information for converting positional information into addresses, and supplies the stored conversion information to the cluster information generating section 170. It should be noted that information stored in the address information storing section 230 will be described later with reference to FIG. 3.

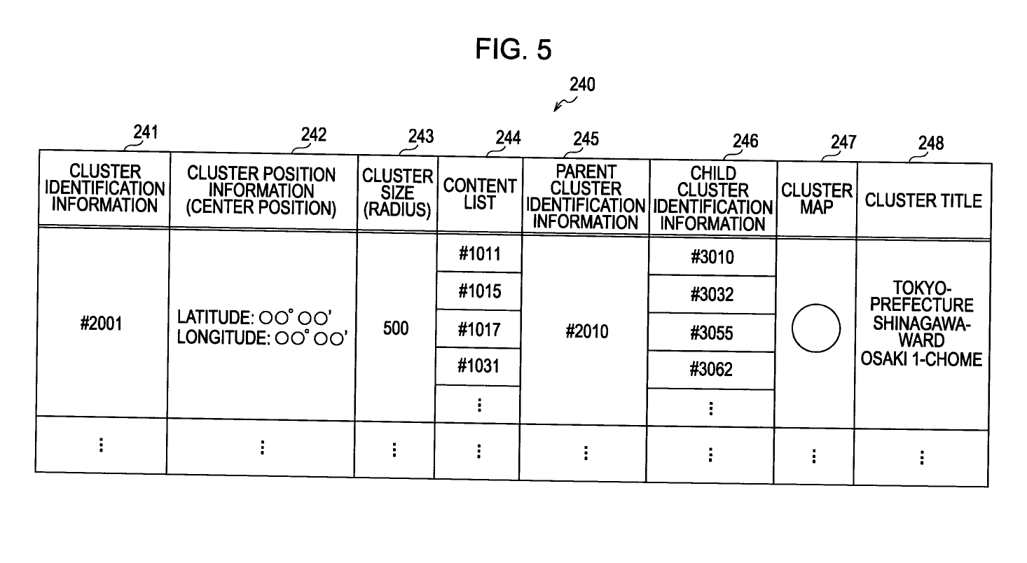

The cluster information storing section 240 stores cluster information generated by the cluster information generating section 170, and supplies the stored cluster information to the display control section 180. It should be noted that information stored in the cluster information storing section 240 will be described later with reference to FIG. 5.

The attribute information acquiring section 110 acquires attribute information associated with contents stored in the content storing section 210, in accordance with an operational input accepted by the operation accepting section 200. Then, the attribute information acquiring section 110 outputs the acquired attribute information to the tree generating section 120, the event cluster generating section 130, or the face cluster generating section 140.

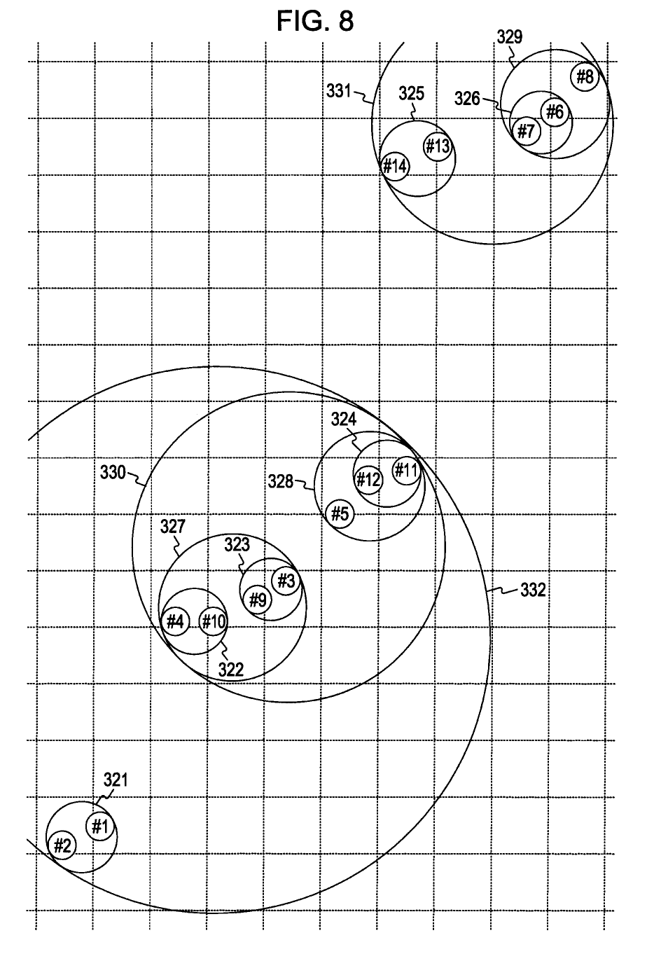

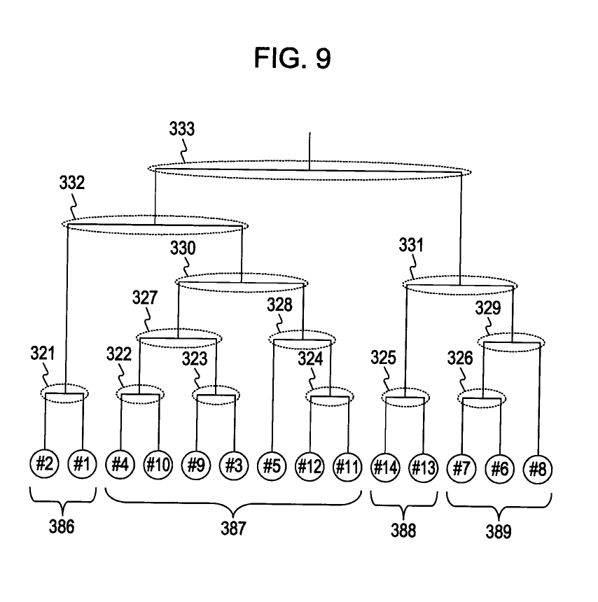

The tree generating section 120 generates binary tree structured data on the basis of attribute information (positional information) outputted from the attribute information acquiring section 110, and outputs the generated binary tree structured data to the hierarchy determining section 150. The method of generating this binary tree structured data will be described later in detail with reference to FIGS. 8 and 9.

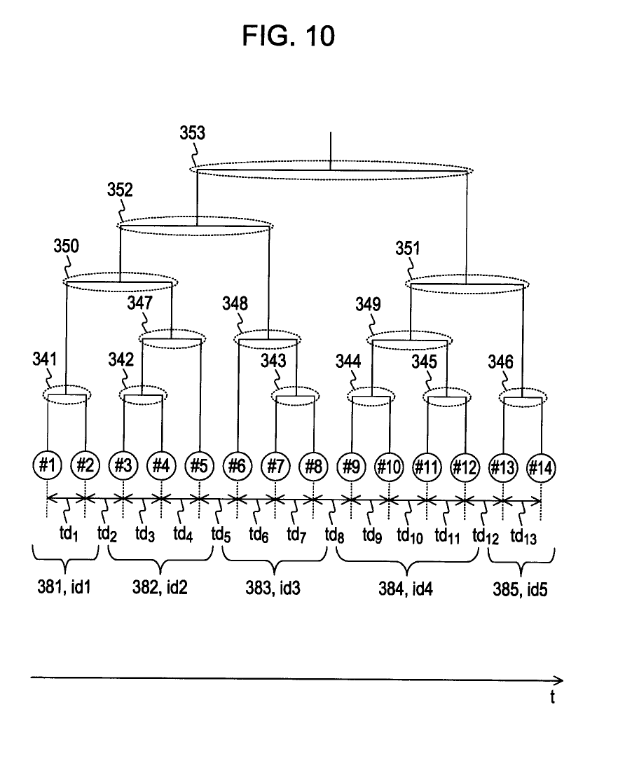

The event cluster generating section 130 generates binary tree structured data on the basis of attribute information (date and time information) outputted from the attribute information acquiring section 110, and generates event clusters (clusters based on date and time information) on the basis of this binary tree structured data. Then, the event cluster generating section 130 outputs information related to the generated event clusters to the hierarchy determining section 150 and the cluster information generating section 170. The event clusters are generated on the basis of various kinds of condition corresponding to a user operation outputted from the condition setting section 190. It should be noted that the method of generating the event clusters will be described later in detail with reference to FIG. 10.

The face cluster generating section 140 generates face clusters related to faces on the basis of attribute information (face information and the like) outputted from the attribute information acquiring section 110, and outputs information related to the generated face clusters to the cluster information generating section 170. The face clusters are generated on the basis of various kinds of condition corresponding to a user operation outputted from the condition setting section 190. For example, the face clusters are generated in such a way that on the basis of the similarity between faces, similar faces belong to the same face cluster.

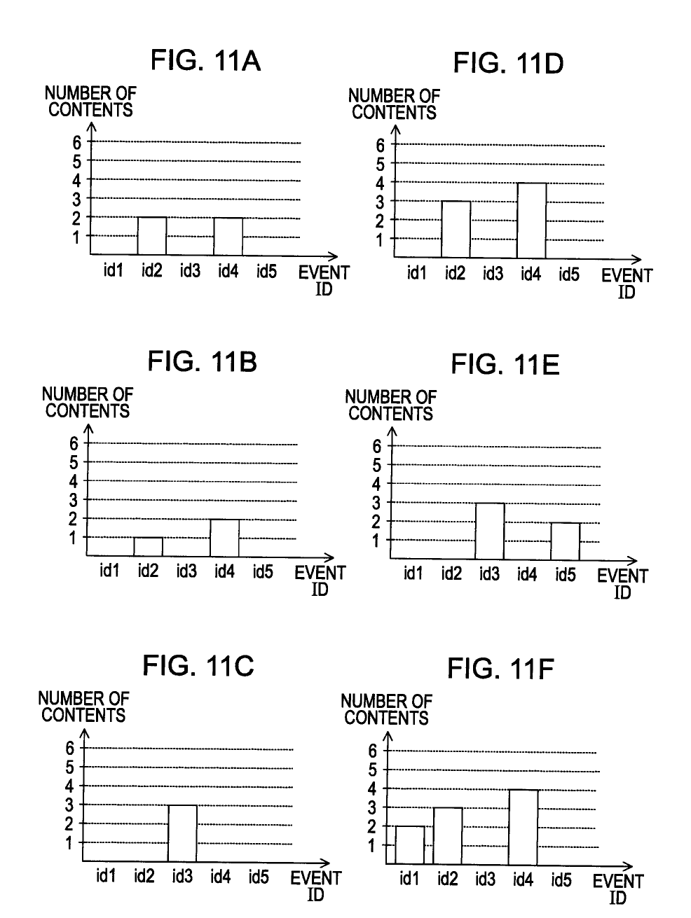

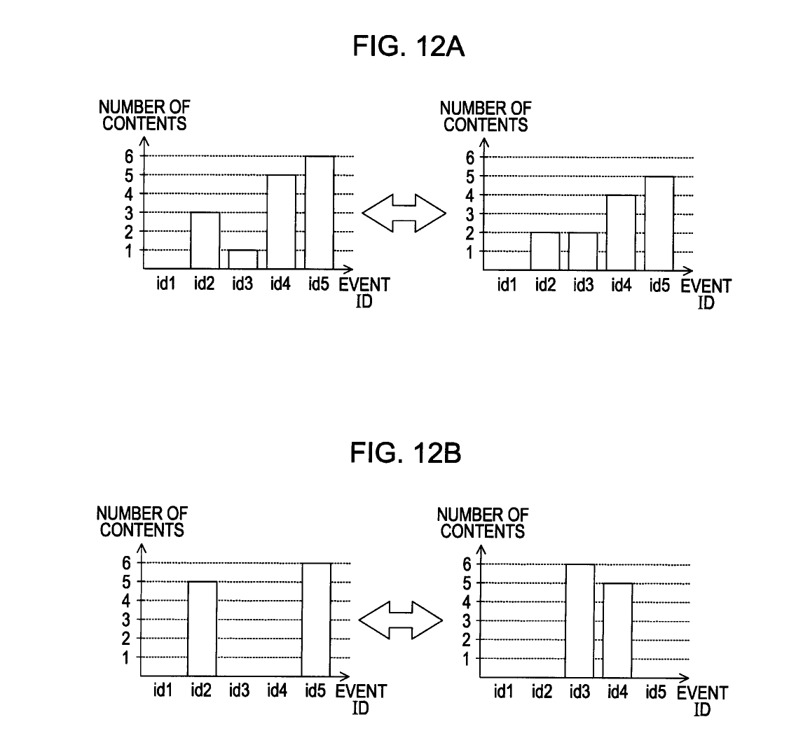

The hierarchy determining section 150 determines a plurality of groups related to contents, on the basis of information related to event clusters outputted from the event cluster generating section 130, and binary tree structured data outputted from the tree generating section 120. Specifically, the hierarchy determining section 150 calculates the frequency distributions of a plurality of contents with respect to a plurality of groups identified by the event clusters generated by the event cluster generating section 130, for individual nodes in the binary tree structured data generated by the tree generating section 120. Then, the hierarchy determining section 150 compares the calculated frequency distributions with each other, extracts nodes that satisfy a predetermined condition from among the nodes in the binary tree structured data on the basis of this comparison result, and determines a plurality of groups corresponding to the extracted nodes. Then, the hierarchy determining section 150 outputs tree information generated by the determination of the plurality of groups (for example, the binary tree structured data and information related to the extracted nodes) to the tree restructuring section 160. The extraction of nodes in the binary tree structured data is performed on the basis of various kinds of condition corresponding to a user operation outputted from the condition setting section 190. Also, the method of extracting nodes in the binary true structured data will be described later in detail with reference to FIGS. 11A to 11F and FIGS. 12A and 12B.

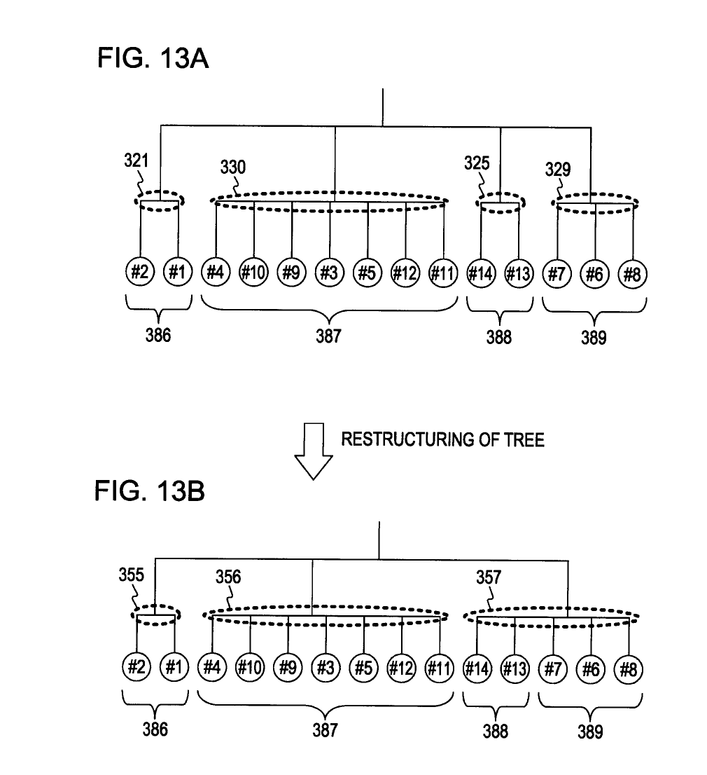

The tree restructuring section 160 generates clusters by restructuring tree information outputted from the hierarchy determining section, on the basis of various kinds of condition corresponding to a user operation outputted from the condition setting section 190. Then, the tree restructuring section 160 outputs information related to the generated clusters to the cluster information generating section 170. It should be noted that the method of restructuring tree information will be described later in detail with reference to FIGS. 13A and 13B. The tree generating section 120, the hierarchy determining section 150, and the tree restructuring section 160 each represent an example of a group setting section described in the claims.

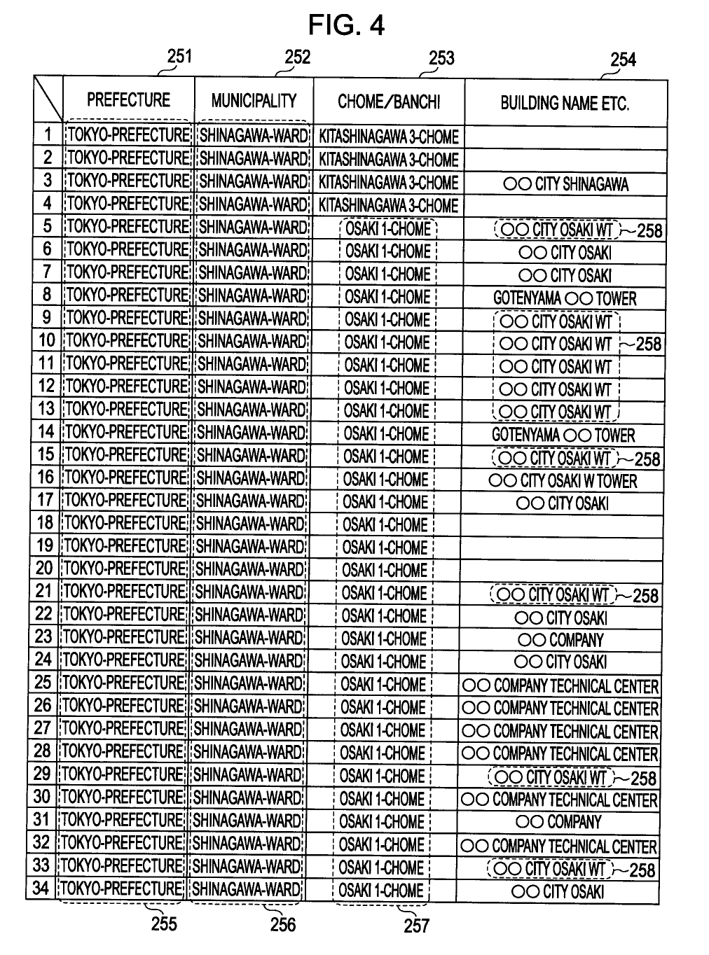

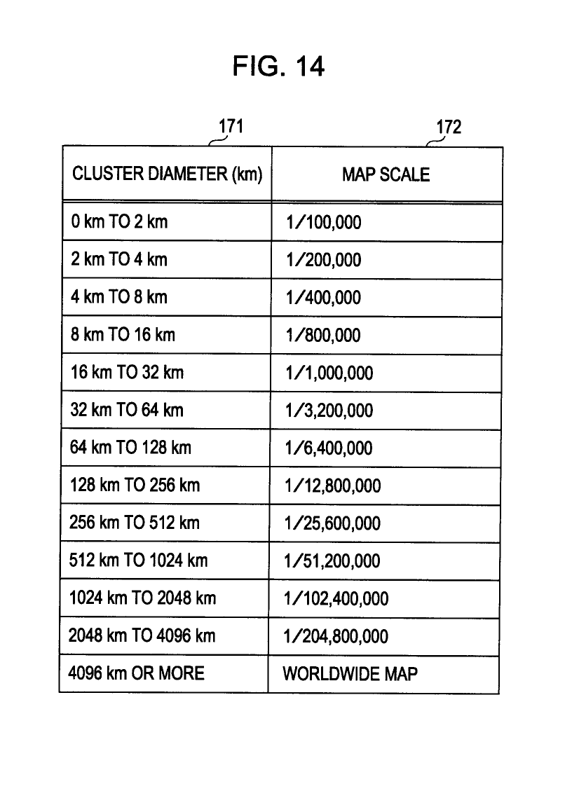

The cluster information generating section 170 records the information related to clusters outputted from the tree restructuring section 160, to the cluster information storing section 240 as cluster information. In addition, the cluster information generating section 170 generates individual pieces of attribute information related to clusters on the basis of the information related to clusters outputted from the tree restructuring section 160, causes these pieces of attribute information to be included in cluster information, and stores the cluster information into the cluster information storing section 240. These pieces of attribute information (such as Cluster Map 247 and Cluster Title 248 shown in FIG. 5) are generated on the basis of map data stored in the map information storing section 220, or conversion information stored in the address information storing section 230. In addition, the cluster information generating section 170 also records information related to clusters outputted from the event cluster generating section 130 and the face cluster generating section 140, to the cluster information storing section 240 as cluster information. It should be noted that the method of generating cluster maps will be described later in detail with reference to FIGS. 14 to 16B. Also, the method of generating cluster titles will be described later in detail with reference to FIG. 4. It should be noted that the cluster information generating section 170 represents an example of a mark generating section described in the claims.

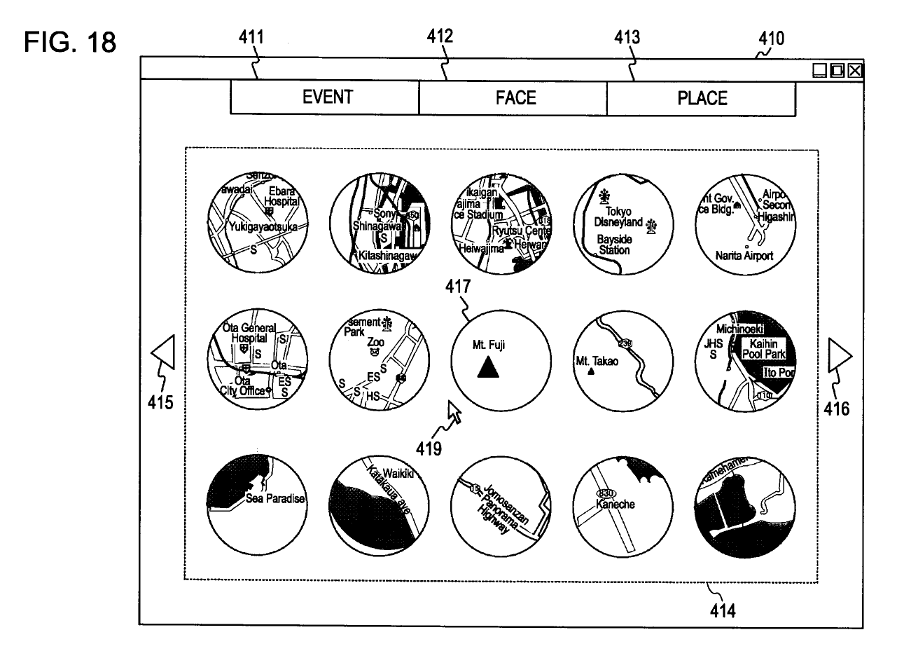

The display control section 180 displays various kinds of image on the display section 181 in accordance with an operational input accepted by the operation accepting section 200. For example, in accordance with an operational input accepted by the operation accepting section 200, the display control section 180 displays on the display section 181 cluster information (for example, a listing of cluster maps) stored in the cluster information storing section 240. Also, in accordance with an operational input accepted by the operation accepting section 200, the display control section 180 displays contents stored in the content storing section 210 on the display section 181. These examples of display will be described later in detail with reference to FIGS. 18 to 27B and the like.

The display section 181 is a display section that displays various kinds of image on the basis of control of the display control section 180.

The condition setting section 190 sets various kinds of condition in accordance with an operational input accepted by the operation accepting section 200, and outputs information related to the set condition to individual sections. That is, the condition setting section 190 outputs information related to the set condition to the event cluster generating section 130, the face cluster generating section 140, the hierarchy determining section 150, and the tree restructuring section 160.

The operation accepting section 200 is an operation accepting section that accepts an operational input from the user, and outputs information on an operation corresponding to the accepted operational input to the attribute information acquiring section 110, the display control section 180, and the condition setting section 190.

### [Example of Image File Configuration]

FIGS. 2A and 2B are diagrams showing an example of the file structure of an image file stored in the content storing section 210 according to the first embodiment of the present invention. The example shown in FIGS. 2A and 2B schematically illustrates the file structure of a still image file recorded in the DCF (Design rule for Camera File system) standard. The DCF is a file system standard for realizing mutual use of images between devices such as a digital still camera and a printer via a recording medium. Also, the DCF defines the file naming method and folder configuration in the case of recording onto a recording medium on the basis of Exif (Exchangeable image file format). The Exif is a standard for adding image data and camera information into an image file, and defines a format (file format) for recording an image file. FIG. 2A shows an example of the configuration of an image file 211, and FIG. 2B shows an example of the configuration of attached information 212.

The image file 211 is a still image file recorded in the DCF standard. As shown in FIG. 2A, the image file 211 includes the attached information 212 and image information 215. The image information 215 is, for example, image data generated by an image capturing apparatus such as a digital still camera. This image data is image data that has been captured by the imaging capturing device of the image capturing apparatus, subjected to resolution conversion by a digital signal processing section, and compressed in the JPEG format.

As shown in FIG. 2B, the attached information 212 includes attribute information 213 and a maker note 214. The attribute information 213 is attribute information or the like related to the image file 211, and includes, for example, GPS information, date and time of shooting update, picture size, color space information, and maker name. The GPS information includes, for example, positional information such as latitude and longitude (for example, TAGID=1000001 to 100004).

The maker note 214 is generally an area in which data unique to the user is recorded, and is an extension area in which each maker can freely record information (TAGID=37500, MakerNote). It should be noted that date and time information such as time of shooting, positional information such as GPS information, or face information related to a face included in an image (for example, the position and size of the face) may be recorded in the maker note 214. While the first embodiment is directed to the case in which cluster information is generated by using positional information recorded in an image file, it is also possible to record positional information into a management file for managing contents, and generate cluster information by using this positional information.

### [Example of Information Stored in Address Information Storing Section]

FIG. 3 is a diagram schematically showing information stored in the address information storing section 230 according to the first embodiment of the present invention. The address information storing section 230 stores conversion information for converting positional information into addresses. Specifically, the address information storing section 230 stores Positional Information 231 and Address Information 232 in association with each other.

In the Positional Information 231, data for identifying each of locations corresponding to addresses stored in the Address Information 232 is stored. The example shown in FIG. 3 illustrates a case in which each of locations corresponding to addresses stored in the Address Information 232 is specified by a single position (latitude and longitude). It should be noted that the specific numeric values of latitude and longitude stored in the Positional Information 231 are not shown.

In the Address Information 232, data related to addresses assigned to cluster information generated by the cluster information generating section 170 is stored. As each address assigned to cluster information generated by the cluster information generating section 170, for example, a place name corresponding to administrative divisions, and a building name etc. can be used. The units of such administrative divisions can be, for example, countries, prefectures, and municipalities. It should be noted that in the first embodiment of the present invention, it is assumed that the prefecture, municipality, chome (district in Japanese)/banchi (block in Japanese), and building name etc. are divided into corresponding hierarchical levels, and data thus separated by hierarchical levels is stored in the Address Information 232. Thus, each piece of data divided into hierarchical levels can be used. An example of using each piece of data divided into hierarchical levels in this way will be described later in detail with reference to FIG. 4.

### [Example of Determination of Addresses Assigned to Clusters]

FIG. 4 is a diagram schematically showing a method of determining addresses assigned to cluster information generated by the cluster information generating section 170 according to the first embodiment of the present invention. This example is directed to a case in which on the basis of address information converted with respect to each content belonging to a target cluster, the address of the cluster is determined.

The cluster information generating section 170 acquires address information from the address information storing section 230 shown in FIG. 3, on the basis of the latitudes and longitudes of individual contents belonging to a cluster generated by the tree restructuring section 160. For example, the cluster information generating section 170 extracts, from among the latitudes and longitudes stored in the Positional Information 231 (shown in FIG. 3), latitudes and longitudes that are the same as those of individual contents belonging to a cluster, for each of the contents. Then, the cluster information generating section 170 acquires address information stored in the Address Information 232 (shown in FIG. 3) in association with the extracted latitudes and longitudes, as address information of individual contents. It should be noted that for a content with no matching latitudes and longitudes stored in the Positional Information 231, a latitude and a longitude that are closest to the latitude and longitude of the content are extracted, and address information can be acquired by using the extracted latitude and longitude.

Subsequently, on the basis of the address information acquired with respect to the individual contents belonging to the target cluster, the cluster information generating section 170 determines an address to be assigned to the cluster. It should be noted that as the address information used for this determination, for example, all the pieces of address information acquired with respect to the individual contents belonging to the cluster can be used. However, it is also possible to use only a predetermined number of pieces of address information selected in accordance with a preset rule (for example, randomly selecting a predetermined number of pieces of address information) from among all the pieces of acquired address information. Also, if another cluster (child node) belongs to a level below a target cluster (parent node), only address information acquired with respect to a content corresponding to the center position (or in its close proximity) of the other cluster (child node) may be used.

As described above, address information acquired from the address information storing section 230 can be divided into hierarchical levels such as Prefecture 251, Municipality 252, Chome/Banchi 253, and Building Name etc. 254 for use, for example. Accordingly, in the first embodiment of the present invention, each piece of address information acquired with respect to each of contents belonging to a target cluster is divided into hierarchical levels, and an address to be assigned to the group is determined on the basis of frequencies calculated at each level. That is, frequencies of individual pieces of address information are calculated at each level, and of the calculated frequencies, the most frequent value is calculated at each level. Then, if the calculated most frequent value accounts for a fixed percentage (ADDRESS_ADOPT_RATE) or more within the entire level, it is determined to use the address information corresponding to the most frequent value. This fixed percentage can be set as, for example, 70%. This fixed percentage may be changed by a user operation to suit the user's preferences. If it is determined to use address information at a given level, then an address determination process is performed similarly with respect to levels below that level. On the other hand, if the calculated most frequent value accounts for less than the fixed percentage within the entire level, it is determined not to use the address information corresponding to the most frequent value. If it is determined not to use address information corresponding to the most frequent value in this way, the address determination process with respect to levels below that level is discontinued. That is, if it is determined not to use address information corresponding to the most frequent value, the address determination process is discontinued because there is supposedly a strong possibility that a determination not to use address information corresponding to the most frequent value will be similarly made with respect to levels below that level. For example, if it is determined not to use address information at the level of the Prefecture 251, it is supposed that a determination not to use address information will be similarly made with respect to levels (the Municipality 252, the Chome/Banchi 253, and the Building Name etc. 254) below that level.

For example, with respect to the first level (the Prefecture 251), the prefecture representing the most frequent value is identified from among 34 pieces of address information. In the example shown in FIG. 4, the prefecture representing the most frequent value is “Tokyo-prefecture” bounded by thick dotted lines 255. Since there are 34 pieces of the address information “Tokyo-prefecture” representing the most frequent value out of 34 pieces of address information, its percentage at the entire level is 100%. In this way, since the percentage (100%) of “Tokyo-prefecture” representing the most frequent value at the entire level of the Prefecture 251 is equal to or more than a fixed percentage (70%), it is determined to use “Tokyo-prefecture” as address information.

Subsequently, with respect to the level (the Municipality 252) below the Prefecture 251, the municipality representing the most frequent value is identified from among 34 pieces of address information. In the example shown in FIG. 4, the municipality representing the most frequent value is “Shinagawa-ward” bounded by thick dotted lines 256. Since there are 34 pieces of the address information “Shinagawa-ward” representing the most frequent value out of 34 pieces of address information, its percentage at the entire level is 100%. In this way, since the percentage (100%) of “Shinagawa-ward” representing the most frequent value at the entire level of the Municipality 252 is equal to or more than a fixed percentage (70%), it is determined to use “Shinagawa-ward” as address information.

Subsequently, with respect to the level (the Chome/Banchi 253) below the Municipality 252, the chome/banchi representing the most frequent value is identified from among 34 pieces of address information. In the example shown in FIG. 4, the chome/banchi representing the most frequent value is “Osaki 1-chome” bounded by thick dotted lines 257. Since there are 30 pieces of the address information “Osaki 1-chome” representing the most frequent value out of 34 pieces of address information, its percentage at the entire level is approximately 88%. In this way, since the percentage (approximately 88%) of “Osaki 1-chome” representing the most frequent value at the entire level of the Chome/Banchi 253 is equal to or more than a fixed percentage (70%), it is determined to use “Osaki 1-chome” as address information.

Subsequently, with respect to the level (the Building Name etc. 254) below the Chome/Banchi 253, the building name etc. representing the most frequent value is identified from among 34 pieces of address information. In the example shown in FIG. 4, the building name etc. representing the most frequent value is “◯◯ City Osaki WT” bounded by thick dotted lines 258. However, since there are 10 pieces of the address information “◯◯City Osaki WT” representing the most frequent value out of 34 pieces of address information, its percentage at the entire level is approximately 29%. In this way, since the percentage (approximately 29%) of “◯◯ City Osaki WT” representing the most frequent value at the entire level of the Building Name etc. 254 is less than a fixed percentage (70%), it is determined not to use “◯◯ City Osaki WT” as address information. When it is determined not to use address information in this way, even if there is another level that exists below the level of the Building Name etc. 254, processing with respect to the lower level is discontinued.

As described above, “Tokyo-prefecture Shinagawa-ward Osaki 1-chome” is determined as the place name assigned to the target group.

By determining a place name assigned to each group in this way, for example, “Tokyo-prefecture” is determined as the place name for a group including image files (so-called photographs) shot throughout the Tokyo-prefecture. Also, for example, even in the case of a group including image files captured throughout the Tokyo-prefecture, if the group includes many images shot mostly throughout the Shinagawa-ward, a place name such as “Tokyo-prefecture Shinagawa-ward” is determined for the group.

Since in many cases the person who has shot the images knows the place name, there are supposedly cases where it is redundant to write the place name starting with the prefecture name. For this reason, address display may be simplified in such a way that if a place name includes only a prefecture name, the place name is displayed as it is, and if a place name continues down to the municipality name and so on, the place name may be displayed with the prefecture name omitted.

If, for example, the above-described address determination method is used with respect to a cluster including image files shot throughout a plurality of prefectures (for example, Tokyo-prefecture and Saitama-prefecture), cases can also be supposed where an address is not determined. In such cases, for example, with respect to the first level (Prefecture), the prefecture representing the most frequent value and the prefecture representing the second most frequent value are identified from among a plurality of pieces of address information. Then, it is judged whether or not the percentages of these two prefectures are equal to or more than a fixed percentage, and the prefecture part of address information may be determined on the basis of this judgment result. The same applies to the case of determining an address with respect to three or more prefectures. Also, each of these place name determination methods may be set by a user operation. Also, if a plurality of prefectures (for example, Tokyo-prefecture, Chiba-prefecture, and Saitama-prefecture) are determined as address information, for example, the top two prefectures ranked in order of highest frequency may be displayed. For example, the display may be in the manner of “Tokyo-prefecture, Chiba-prefecture, and Others”.

While this example is directed to the case in which an address in Japan is assigned as a place name to be assigned to a group, the same applies to the case where an address in a foreign country is assigned as a place name to be assigned to a group. An address in a foreign country often differs from an address in Japan in the order in which the address is written but is the same in that the address is made up of a plurality of hierarchical levels. Therefore, a place name can be determined by the same method as the address determination method described above.

While the first embodiment of the present invention is directed to the case in which address information is stored in the information processing apparatus 100 in advance, and an address assigned to a cluster is determined on the basis of this address information, an address assigned to a cluster may be determined by using address information stored in an external apparatus.

### [Example of Information Stored in Cluster Information Storing Section]

FIG. 5 is a diagram schematically showing information stored in the cluster information storing section 240 according to the first embodiment of the present invention. The cluster information storing section 240 stores cluster information related to clusters generated by the cluster information generating section 170. Specifically, the cluster information storing section 240 stores Cluster Identification Information 241, Cluster Position Information 242, Cluster Size 243, and Content List 244. In addition, the cluster information storing section 240 stores Parent Cluster Identification Information 245, Child Cluster Identification Information 246, Cluster Map 247, and Cluster Title 248. These pieces of information are stored in association with each other.

The Cluster Identification Information 241 stores identification information for identifying each cluster. For example, identification information “#2001”, identification information “#2002”, and so on are stored in order of generation by the cluster information generating section 170.

The Cluster Position Information 242 stores positional information related to each cluster. As the positional information, for example, the latitude and longitude of the center position of a circle corresponding to each cluster is stored.

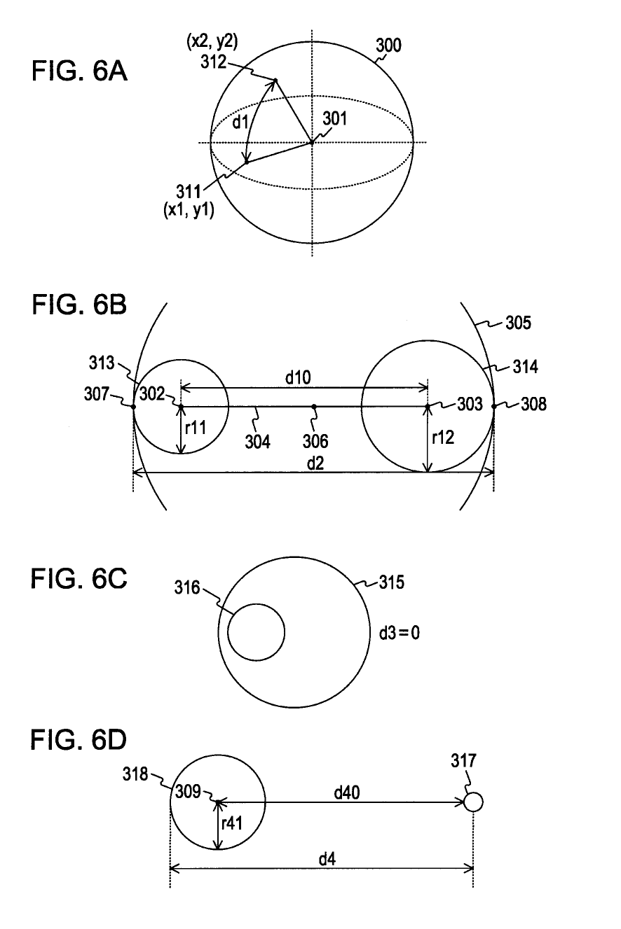

The Cluster Size 243 stores a size related to each cluster. As this size, for example, the value of the radius of a circle corresponding to each cluster is stored. Here, if, for example, the great-circle distance is used as the distance between two points as shown in FIG. 6A, the unit of the value of the radius of a circle is set as [radian]. If, for example, the Euclidean distance is used as the distance between two points, the unit of the value of the radius of a circle is set as [m].

The Content List 244 stores information (for example, content addresses and the like) for acquiring contents belong to each cluster. It should be noted that in FIG. 5, “#1011”, “#1015”, and so on are schematically shown as the Content List 244.

The Parent Cluster Identification Information 245 stores identification information for identifying another cluster (parent cluster) to which each cluster belongs. It should be noted that since there is normally a single parent cluster, the Parent Cluster Identification Information 245 stores identification information for a single parent cluster.

The Child Cluster Identification Information 246 stores identification information for identifying other clusters (child clusters) that belong to each cluster. That is, all the pieces of identification information for one or a plurality of clusters belonging to each cluster and existing at levels below the cluster are stored. It should be noted that since there are normally a plurality of child clusters, the Child Cluster Identification Information 246 stores identification information for each of a plurality of child clusters.

The Cluster Map 247 stores the image data of a thumbnail image representing each cluster. This thumbnail image is, for example, a map image formed by a map included in a circle corresponding to each cluster. The thumbnail image is generated by the cluster information generating section 170. In FIG. 5, the thumbnail image representing a cluster is schematically indicated by a void circle. The method of generating this thumbnail image will be described later in detail with reference to FIGS. 14 to 16B.

The Cluster Title 248 stores a title assigned to each cluster. For example, an address “Tokyo-prefecture Shinagawa-ward Osaki 1-chome” determined by the cluster information generating section 170 as shown in FIG. 4 is stored.

It should be noted that depending on the content or application, cluster information may include, in addition to the data shown in FIG. 5, the metadata of contents belonging to a cluster themselves (for example, event IDs shown in FIGS. 10 to 12B), statistical information thereof, and the like. To each of contents, a content ID and a cluster ID to which the corresponding content belongs are attached as metadata. When attaching a cluster ID as the metadata of each content, although the suitable method is to embed the cluster ID in the content itself by using a file area such as Exif, it is also possible to separately manage only the metadata of the content.

### [Example of Cluster Generation]

Next, a clustering method for clustering (hierarchical clustering) a plurality of contents will be described in detail with reference to the drawings.

Clustering refers to grouping (classifying) together a plurality of pieces of data within a short distance from each other in a data set. It should be noted that in the first embodiment of the present invention, contents (for example, image contents such as still image files) are used as data. The distance between contents refers to the distance between the positions (such as geographical positions, positions along the temporal axis, or positions along the axis representing the similarity between faces) of two points corresponding to contents. A cluster is a unit in which contents are grouped together by clustering. Through an operation such as linking or splitting of such clusters, it finally becomes possible to handle grouped contents. It should be noted that the first embodiment of the present invention is directed to a case in which such grouping is performed by using binary tree structured data as described below.

### [Example of Calculation of Distances Between Contents, Clusters, etc.]

FIGS. 6A to 6D are diagrams showing an example of distances in the case when a tree having a binary tree structure is generated by the tree generating section 120 according to the first embodiment of the present invention. FIG. 6A shows an example of a content-to-content distance identified by two contents. FIGS. 6B and 6C each show an example of a cluster-to-cluster distance identified by two clusters. FIG. 6D shows an example of a content-to-cluster distance identified by a single content and a single cluster.

FIG. 6A schematically shows an example in which contents 311 and 312 are placed at their respective generated positions on Earth 300. Also, the latitude and longitude of the content 311 are x1 and y1, respectively, and the latitude and longitude of the content 312 are x2 and y2, respectively. The first embodiment of the present invention is directed to a case in which the great-circle distance is used as the distance between two points. When the Earth 300 is taken as a sphere, this great-circle distance is the angle between two points as seen from a center 301 of the sphere which is measured as a distance. The distance d1 [radian] between the contents 311 and 312 shown in FIG. 6A can be found by using the following equation:

d1=arccos(sin(x1)sin(x2)+cos(x1)cos(x2)cos(y1−y2))

where arccos(x)=cos⁻¹(x).

In the case where clustering is performed with respect to such localized contents that all the target contents can be approximated to exist on a plane, for example, the Euclidean distance may be used as the distance between two points. Also, for example, the Manhattan distance may be used as the distance between two points.

FIGS. 6B and 6C show an example in which clusters 313 to 316 generated by the tree generating section 120 are placed on a two-dimensional plane on the basis of the generated positions of contents included in the respective clusters. Here, for example, the area of a cluster to which a plurality of contents belong can be represented as an area having the shape of a circle identified by the positions of all of the contents belonging to the cluster. The cluster has, as attribute information, the center position (center point) and radius of the circle.

The first embodiment of the present invention is directed to a case in which, as a cluster-to-cluster distance identified by two clusters, the distance between the farthest edges of two circles corresponding to the two clusters is used. Specifically, as shown in FIG. 6B, as the distance d2 between the clusters 313 and 314, the distance between the farthest edges of the two circles corresponding to the clusters 313 and 314 is used. For example, suppose that the radius of the circle corresponding to the cluster 313 is a radius r11, and the radius of the circle corresponding to the cluster 314 is a radius r12. Also, suppose that the distance indicated by a straight line 304 connecting between a center position 302 of the circle corresponding to the cluster 313 and a center position 303 of the circle corresponding to the cluster 314 is a distance d10. In this case, the distance d2 between the clusters 313 and 314 can be found by the following equation.

d2=d10+r11+r12

Here, for example, the area of a cluster made up of two contents can be represented as the area of a circle including the two contents and in which the two contents are inscribed. The center position of the cluster made up of the two contents can be represented as the middle position on a straight line connecting between the positions of the two contents. The radius of the cluster can be represented as half of the straight line connecting between the positions of the two contents.

Also, for example, the area of a cluster 305 made up of the two clusters 313 and 314 shown in FIG. 6B can be represented as the area of a circle which includes the clusters 313 and 314 and in which the respective circles of the clusters 313 and 314 are inscribed. It should be noted that FIG. 6B only shows a part of the circle corresponding to the cluster 305. Also, an example of clusters each made up of two clusters is shown in FIG. 8 (for example, a cluster 330 made up of clusters 327 and 328 shown in FIG. 8). Also, a center position 306 of the cluster 305 is the middle position on a straight line connecting between positions 307 and 308 where the respective circles of the clusters 313 and 314 are inscribed in the circle corresponding to the cluster 305. It should be noted that the center position 306 of the cluster 305 lies on a straight line connecting between the respective center positions 302 and 303 of the clusters 313 and 314.

If, as shown in FIG. 6C, one of the two circles corresponding to the clusters 315 and 316 is completely included in the other, the distance between the clusters is regarded as 0. Also, the cluster made up of the two clusters 315 and 316 shown in FIG. 6C can be regarded as the same as the cluster 315. That is, the center position and radius of the cluster made up of the two clusters 315 and 316 can be regarded as the same as those of the cluster 315.

FIG. 6D shows an example in which a content 317 and a cluster 318 generated by the tree generating section 120 are placed on the basis of the positions of contents included in these. Here, a content can be also considered as a cluster corresponding to a circle whose radius is 0. Accordingly, for example, as shown in FIG. 6D, the distance d4 between the content 317 and the cluster 318 can be also calculated in a manner similar to the cluster-to-cluster distance described above. For example, suppose that the radius of a circle corresponding to the cluster 318 is a radius r41, and the distance indicated by a straight line connecting between the center position of the circle corresponding to the cluster 318 and the position of the content 317 is a distance d40. In this case, the distance d4 between the content 317 and the cluster 318 can be found by the following equation.

d4=d40+r41

### [Example of Contents]

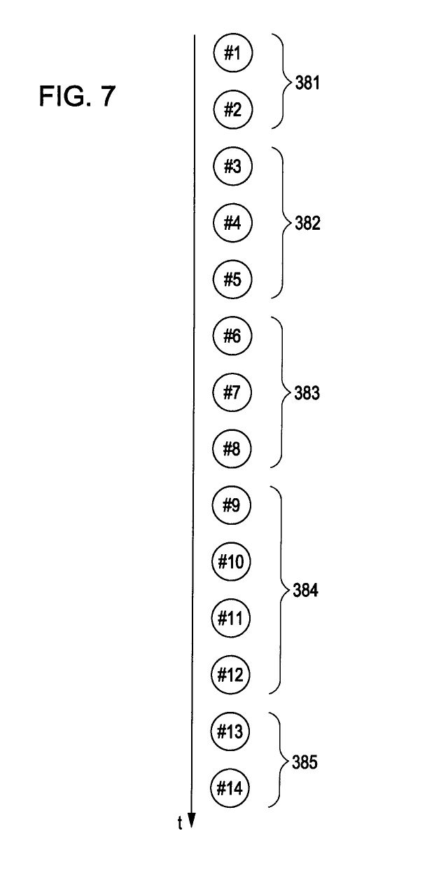

FIG. 7 is a diagram schematically showing contents stored in the content storing section 210 according to the first embodiment of the present invention. Contents #1 to #14 shown in FIG. 7 are, for example, still image files recorded with an image capturing apparatus. It should be noted that in FIG. 7, for the ease of explanation, only the corresponding symbols (#1 to #14) are depicted inside the respective circles representing the contents #1 to #14. Also, in FIG. 7, the contents #1 to #14 are depicted as being arranged in time series on the basis of date and time information (shooting time) recorded in association with each of the contents #1 to #14. It should be noted that while the vertical axis represents the temporal axis, this temporal axis is only a schematic representation, and does not accurately represent the time intervals between individual contents.

For example, the contents #1 and #2 are generated during a wedding ceremony 381 attended by Goro Koda (the user of the information processing apparatus 100), and the contents #3 to #5 are generated during a 2007 Sports Day 382 in which a Goro Koda's child participated. Also, the contents #6 to #8 are generated during a ◯◯ trip 383 done by Goro Koda, and the contents #9 to #12 are generated during a 2008 Sports Day 384 in which the Goro Koda's child participated. Further, the contents #13 and #14 are generated during a ΔΔ trip 385 done by Goro Koda.

### [Example of Binary Tree Generation Based on Positional Information]

FIG. 8 is a diagram schematically showing how the contents #1 to #14 are clustered by the tree generating section 120 on the basis of positional information according to the first embodiment of the present invention. FIG. 8 shows a case in which the contents #1 to #14 stored in the content storing section 210 are virtually placed on a plane on the basis of their positional information. It should be noted that the contents #1 to #14 are the same as those shown in FIG. 7. Also, in FIG. 8, for the ease of explanation, the distances between individual contents and between individual clusters are depicted as being relatively short.

In the first embodiment of the present invention, clustering performed by the tree generating section 120 generates binary tree structured data with each content as a leaf. Each node in this binary tree structured data corresponds to a cluster.

First, the tree generating section 120 calculates distances between individual contents on the basis of positional information. On the basis of the calculation results, the tree generating section 120 extracts two contents with the smallest inter-content distance, and generates a new node having these two contents as its child elements. Subsequently, the tree generating section 120 calculates distances between the generated new node and the other individual contents on the basis of positional information. Then, on the basis of the calculation results, and the results of calculation of the distances between individual contents described above, the tree generating section 120 extracts a pair of two elements with the smallest distance, and generates a new node having this pair of two elements as its child elements. Here, the pair of two elements to be extracted is one of a pair of a node and a content, a pair of two contents, and a pair of two nodes.

Subsequently, the tree generating section 120 repetitively performs the new node generation process in the same manner until the number of nodes to be extracted becomes 1. Thus, binary tree structured data with respect to the contents #1 to #14 is generated. For example, as shown in FIG. 8, clusters 321 to 326 are each generated as a pair of two contents. Also, clusters 328 and 329 are each generated as a pair of a node and a content. Also, clusters 327, 330, 331, 332, and 333 are each generated as a pair of two nodes. It should be noted that the cluster 333 is a cluster corresponding to the root node to which the contents #1 to #14 belong, and the cluster 333 is not shown in FIG. 8.

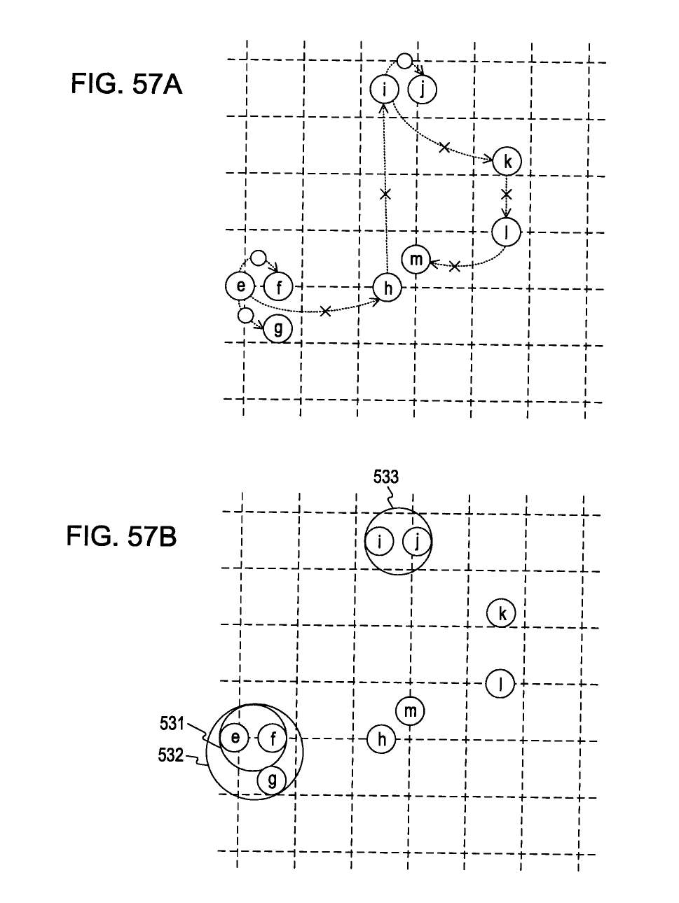

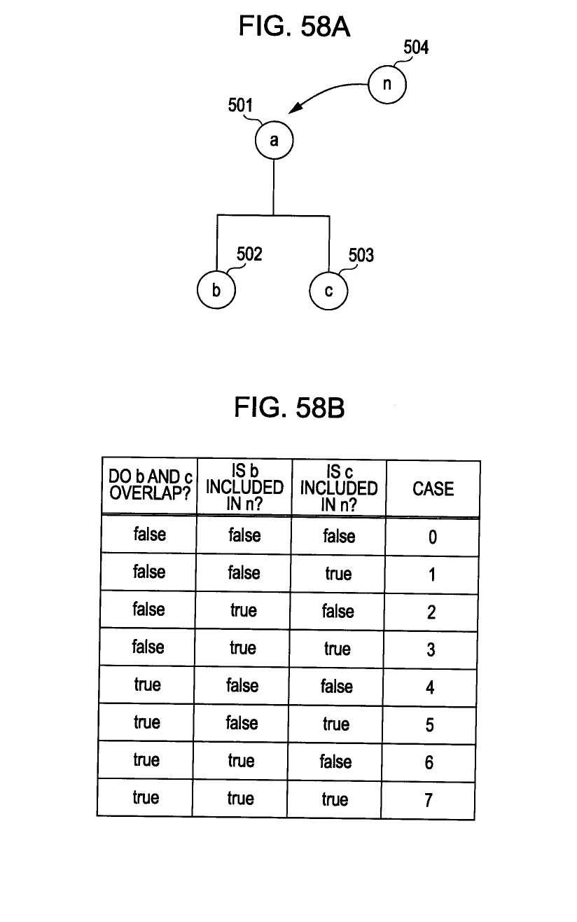

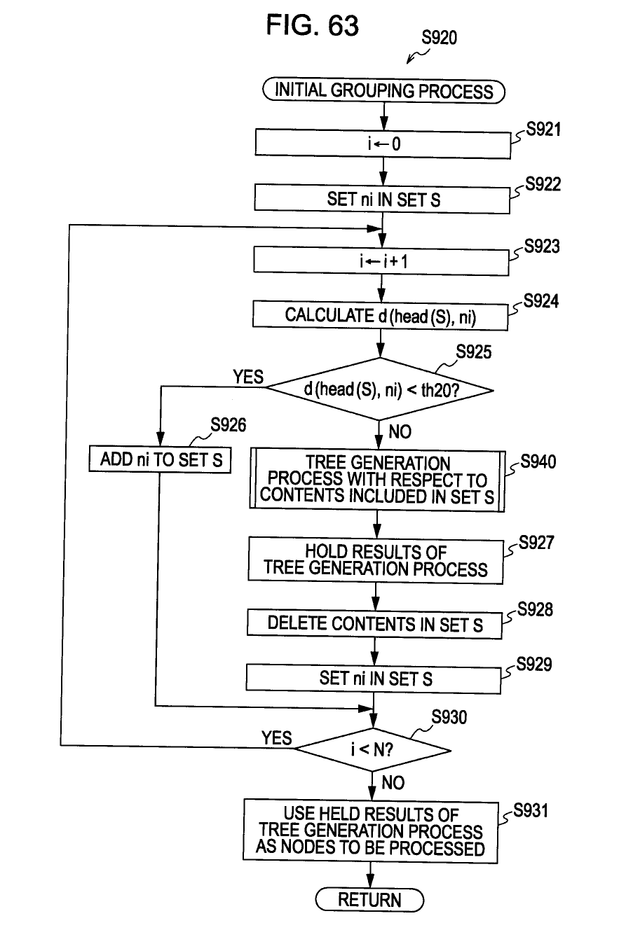

The above example is directed to the case in which distances between individual contents are calculated, and binary tree structured data is generated while keeping on extracting a pair with the smallest distance. However, when shooting photographs or moving images, for example, in many cases shooting is performed successively within a predetermined range. For example, when shooting photographs at a destination visited on a trip, in many cases group photographs or landscape photographs are shot in the same region. For this reason, for example, an initial grouping process may be performed to group together those contents which are shot within a short distance from each other in advance. By performing an initial grouping process in this way, the number of nodes to be processed can be reduced, thereby enabling a faster clustering process. This initial grouping process will be described later in detail with reference to FIGS. 57A and 57B and FIG. 63. Also, a modification (sequential clustering) of the tree generation process will be described later in detail with reference to FIGS. 58A to 62, and FIGS. 64 to 66.

FIG. 9 is a conceptual clustering tree diagram of a binary tree structure representing binary tree structured data generated with respect to the contents #1 to #14 by the tree generating section 120 according to the first embodiment of the present invention. When, as shown in FIG. 8, the contents #1 to #14 are clustered to generate the clusters 321 to 333, binary tree structured data corresponding to the generated clusters 321 to 333 is generated. It should be noted that in this binary tree, each content corresponds to a leaf, and each cluster corresponds to a node. Thus, in the clustering tree diagram shown in FIG. 9, leaves corresponding to the contents #1 to #14 are denoted by the same symbols as those of the corresponding contents, and nodes corresponding to the clusters 321 to 333 are denoted by the same symbols as those of the corresponding clusters. It should be noted that while the contents #1 to #14 independently constitute clusters, the cluster numbers of these clusters are not particularly shown in FIG. 9.

For example, the contents #1 and #2 are generated in a wedding ceremony hall 386 (corresponding to the wedding ceremony 381 shown in FIG. 7) Goro Koda went to. The contents #3 to #5, and #9 to #12 are generated in an elementary school 387 (corresponding to the 2007 Sports Day 382 and the 2008 Sports Day 384 shown in FIG. 7) a Goro Koda's child goes to. Also, the contents #13 and #14 are generated at a ΔΔ trip destination 388 (corresponding to the AA trip 385 shown in FIG. 7) Goro Koda visited. Also, the contents #6 to #8 are generated at a ◯◯ trip destination 389 (corresponding to the ◯◯ trip 383 shown in FIG. 7) Goro Koda visited.

### [Example of Event Clustering Based on Date and Time Information]

The above example is directed to the case in which binary tree structured data is generated on the basis of positional information. Next, a description will be given of event clustering performed on the basis of date and time information. This event clustering generates binary tree structured data on the basis of date and time information (see, for example, Japanese Unexamined Patent Application Publication No. 2007-94762). Also, event clusters generated by this event clustering are used to generate event IDs used to extract desired nodes by the user from among nodes in binary tree structured data generated on the basis of positional information.

FIG. 10 is a conceptual clustering tree diagram of a binary tree structure representing binary tree structured data generated on the basis of data and time information by the event cluster generating section 130 according to the first embodiment of the present invention. This example illustrates a case in which binary tree structured data is generated with respect to the contents #1 to #14 shown in FIG. 8.

In the first embodiment of the present invention, separately from the binary tree structured data generated on the basis of positional information (shown in FIG. 9), the event cluster generating section 130 generates binary tree structured data on the basis of date and time information related to contents outputted from the attribute information acquiring section 110. This binary tree structured data can be generated by the same method as that used in the above-described clustering based on positional information, except in that as the distance between contents, a distance (time interval) along the temporal axis is used instead of a geographical distance. It should be noted that in the example according to the first embodiment of the present invention, as the distance between nodes when generating event clusters, the distance between the nearest edges of two segments along the temporal axis corresponding to two nodes is used. For example, of the two nodes to be compared, the time interval between the rear end position of a segment corresponding to the node located earlier along the temporal axis and the front end position of a segment corresponding to the node located later along the temporal axis is taken as the distance between the two nodes.

Now, the method of generating binary tree structured data on the basis of date and time information will be specifically described. The event cluster generating section 130 calculates time intervals between individual contents on the basis of date and time information. On the basis of the calculation results, the event cluster generating section 130 extracts two contents that make the inter-content time interval smallest, and generates a new node having these two contents as its child elements. Subsequently, the event cluster generating section 130 calculates time intervals between the generated new node and the other individual contents on the basis of date and time information. Then, on the basis of this calculation results, and the results of calculation of the time intervals between individual contents described above, the event cluster generating section 130 extracts a pair of two elements with the smallest time interval, and generates a new node having this pair of two elements as its child elements. Here, the pair of two elements to be extracted is one of a pair of a node and a content, a pair of two contents, and a pair of two nodes.

Subsequently, the event cluster generating section 130 repetitively performs the new node generation process in the same manner until the number of nodes to be extracted becomes 1. Thus, binary tree structured data with respect to the contents #1 to #14 is generated. For example, as shown in FIG. 10, clusters 341 to 346 are each generated as a pair of two contents. Also, clusters 347 and 348 are each generated as a pair of a node and a content. Also, clusters 349 to 353 are each generated as a pair of two nodes. It should be noted that the cluster 353 is a cluster corresponding to the root node to which the contents #1 to #14 belong.

It should be noted that the leaves in the binary tree shown in FIG. 10 correspond to the respective contents #1 to #14 shown in FIG. 7, and are denoted by the same symbols as those shown in FIG. 7. Also, td₁ to td₁₄ are values each indicating the time interval between adjacent contents along the temporal axis. That is, tdₙ is a value indicating the time interval between adjacent contents #n and #(n+1) (the n-th time interval along the temporal axis) in the binary tree shown in FIG. 10.

After the binary tree structured data corresponding to the binary tree shown in FIG. 10 is generated, the event cluster generating section 130 performs clustering based on a grouping condition with respect to the binary tree.

First, the event cluster generating section 130 calculates the standard deviation of the time intervals between individual contents, with respect to each of nodes in the binary tree generated on the basis of date and time information. Specifically, by taking one node in the binary tree generated by the event cluster generating section 130 as a focus node, the standard deviation sd of time intervals between the times of shooting associated with all of individual contents belonging to this focus node is calculated by using equation (1) below.

$$sd = \sqrt{\frac{{\sum }_{i = 1}^{N} {( {td}_{n} - \overline{td} )}^{2}}{N}} \qquad ( 1 )$$

Here, N denotes the number of time intervals between the times of shooting of contents, and N=(the number of contents belonging to the focus node)−1. Also, td with “ ” attached denotes the mean value of the time intervals tdₙ (1≦n≦N) between contents belonging to the focus node.

Subsequently, with respect to two child nodes whose parent node is the focus node, the deviation of the time interval between these two nodes (the absolute value of the difference between the time interval between the child nodes and the mean of the time intervals between the times of shooting) is calculated. Specifically, the deviation dev of the time interval between the two nodes is calculated by using equation (2) below.

dev=|td_{c}− t̅d̅| (2)

Here, td_{c} is a value indicating the time interval between the two child nodes whose parent node is the focus node. Specifically, the time interval td_{c} is the time interval between the time of shooting of the last content of contents belonging to the child node of the two child nodes which is located earlier along the temporal axis, and the time of shooting of the first content of contents belonging to the child node located later along the temporal axis.

Subsequently, the event cluster generating section 130 calculates the value of the ratio between the deviation dev calculated using equation (2), and the standard deviation sd calculated using equation (1), as a splitting parameter th1 for the focus node. Specifically, the splitting parameter th1 as the value of the ratio between the deviation dev and the standard deviation sd is calculated by using equation (3) below.

th1=dev/sd (3)

The splitting parameter th1 calculated by using equation (3) in this way is a parameter that serves as a criterion for determining whether or not to split the two child nodes whose parent node is the focus node from each other as belonging to different clusters. That is, the event cluster generating section 130 compares the splitting parameter th1 with a threshold th2 that is set as a grouping condition, and judges whether or not the splitting parameter th1 exceeds the threshold th2. Then, if the splitting parameter th1 exceeds the threshold th2, the event cluster generating section 130 splits the two child nodes whose parent node is the focus node, as child nodes belonging to different clusters. On the other hand, if the splitting parameter th1 does not exceed the threshold th2, the event cluster generating section 130 judges the two child nodes whose parent node is the focus node as belonging to the same cluster. It should be noted that the threshold th2 is set by the condition setting section 190 in accordance with a user operation, and is held by the event cluster generating section 130. In the following, a description will be given of a specific example of event clustering, by using the binary tree structured data shown in FIG. 10.

For example, of the nodes constituting the binary tree structured data shown in FIG. 10, the node corresponding to the cluster 350 (hereinafter, referred to as focus node 350) is taken as a focus node. First, with respect to the focus node 350 in the binary tree generated on the basis of date and time information, the event cluster generating section 130 calculates the deviations of the time intervals between individual contents. Then, the standard deviation sd of the time intervals between the times of shooting associated with the respective contents #1 to #5 belonging to the focus node 350 is calculated by using equation (1) below. Specifically, the standard deviation sd is calculated by the following equation.

$$sd = \sqrt{\frac{{( {td}_{1} - \overline{td} )}^{2} + {( {td}_{2} - \overline{td} )}^{2} + {( {td}_{3} - \overline{td} )}^{2} + {( {td}_{4} - \overline{td} )}^{2}}{4}}$$

Here, N=4 since the number of time intervals between the times of shooting of the contents #1 to #5 belonging to the focus node 350 is 4. Also, the mean value (td attached with “ ”) of the time intervals tdₙ (1≦n≦N) between the contents belonging to the focus node 350 is found by the following equation.

$$\overline{td} = \frac{{td}_{1} + {td}_{2} + {td}_{3} + {td}_{4}}{4}$$

Subsequently, with respect to the two child nodes 341 and 347 whose parent node is the focus node 350, the event cluster generating section 130 calculates the deviation dev of the time interval between the two nodes by using equation (2). Specifically, the deviation dv is calculated by the following equation.

dev=|td₃− t̅d̅|

Here, the last content belonging to the child node 341 located earlier along the temporal axis is the content #2, and the first content belonging to the child node 347 located later along the temporal axis is the content #3. Therefore, the time interval td_{c} between the two child nodes 341 and 347 whose parent node is the focus node 350 is the time interval td₃.

Subsequently, by using equation (3), the event cluster generating section 130 calculates the value (the splitting parameter th1 for the focus node 350) of the ratio between the deviation dev calculated using equation (2), and the standard deviation sd calculated using equation (1). The splitting parameter th1 calculated in this way is held by the event cluster generating section 130 as the splitting parameter th1 for the focus node 350. Also, the event cluster generating section 130 similarly calculates the splitting parameter th1 with respect to each of the other nodes in the binary tree structured data.

Subsequently, the event cluster generating section 130 compares the splitting parameter th1 calculated with respect to each of nodes in the binary tree structured data, with the threshold th2, thereby sequentially judging whether or not to split two child nodes belonging to each node. Then, with respect to a node for which the splitting parameter th1 exceeds the threshold th2, the event cluster generating section 130 splits two child nodes having this node as their parent node from each other as belonging to different clusters. On the other hand, with respect to a node for which the splitting parameter th1 does not exceed the threshold th2, the event cluster generating section 130 judges two child nodes having this node as their parent node as belonging to the same cluster.

That is, if the value of a calculated splitting parameter is equal to or smaller than the threshold, individual contents belonging to the node with respect to which the splitting parameter has been calculated are regarded as nodes belonging to a single cluster. That is, the node with respect to which the splitting parameter has been calculated serves as a boundary. Therefore, for example, the larger the threshold, the less likely each node becomes a boundary, so the granularity of clusters in the binary tree as a whole becomes coarser. On the other hand, if the value of a calculated splitting parameter is larger than the threshold, two child nodes belonging to the node with respect to which the splitting parameter has been calculated are classified into different clusters. That is, a boundary is set between the two child nodes belonging to the node with respect to which the splitting parameter has been calculated. Therefore, for example, the smaller the threshold, the more likely each node becomes the boundary between clusters, so the granularity of clusters in the binary tree as a whole becomes finer.

In this way, with respect to each node in the binary tree structured data, the event cluster generating section 130 sequentially judges whether or not to split two child nodes belonging to each node, and generates clusters based on date and time information on the basis of the judgment results. For example, it is determined to split two child nodes belonging to each of the respective nodes corresponding to the clusters 350 to 353. That is, respective event clusters (clusters based on date and time information) corresponding to the wedding ceremony 381, the 2007 Sports Day 382, the ◯◯trip 383, the 2008 Sports Day 384, and the ΔΔ trip 385 are generated.

Here, each of the clusters generated by the event cluster generating section 130 is referred to as event. Also, letting the number of such events be M, event IDs (id1 to idM) are assigned to the respective events. Then, the event cluster generating section 130 associates the generated event clusters and the event IDs assigned to these event clusters with each other, and outputs the event clusters and the event IDs to the hierarchy determining section 150. In FIG. 10, event IDs assigned to individual events are shown inside the brackets below the names indicating the respective events. The frequencies of individual events are calculated with the event IDs assigned in this way taken as classes. An example of this calculation is shown in FIGS. 11A to 11F.

### [Example of Histogram Generation]

FIGS. 11A to 11F are diagrams each showing an example of a histogram generated by the hierarchy determining section 150 according to the first embodiment of the present invention. FIGS. 11A to 11F show histograms generated with respect to respective nodes in the binary tree structured data (shown in FIG. 9) based on positional information, by using the binary tree structured data based on date and time information (shown in FIG. 10). Specifically, FIG. 11A shows a histogram generated with respect to the node 327 shown in FIG. 9, and FIG. 11B shows a histogram generated with respect to the node 328 shown in FIG. 9. Also, FIG. 11C shows a histogram generated with respect to the node 329 shown in FIG. 9, and FIG. 11D shows a histogram generated with respect to the node 330 shown in FIG. 9. Further, FIG. 11E shows a histogram generated with respect to the node 331 shown in FIG. 9, and FIG. 11F shows a histogram generated with respect to the node 332 shown in FIG. 9. In each of the histograms shown in FIGS. 11A to 11F, the horizontal axis is an axis indicating event IDs, and the vertical axis is an axis indicating the frequencies of contents.

In this example, as the classes in a frequency distribution, individual events (event IDs) of event clusters generated by the event cluster generating section 130 are defined. Then, the hierarchy determining section 150 calculates the number of contents with respect to each of event IDs, for each of nodes in the binary tree structured data generated by the tree generating section 120. For example, contents belonging to the node 327 in the binary tree structured data based on positional information shown in FIG. 9 are the contents #3, #4, #9, and #10. As shown in FIG. 10, the event ID assigned to each of the contents #3 and #4 is “id2”, and the event ID assigned to each of the contents #9 and #10 is “id4”. Thus, for the node 327 in the binary tree structured data based on positional information shown in FIG. 9, the number of contents with respect to the event ID “id2” is 2, and the number of contents with respect to the event ID “id4” is 2. Also, the number of contents with respect to each of the other event IDs “id1”, “id3”, and “id5” is 0.

Then, the hierarchy determining section 150 calculates the frequency distribution of contents with the cluster IDs generated by the event cluster generating section 130 taken as classes, with respect to each of nodes in the binary tree structured data generated by the tree generating section 120. For example, as shown in FIG. 11A, the hierarchy determining section 150 calculates the frequency distribution of individual contents with the cluster IDs generated by the event cluster generating section 130 taken as classes, with respect to the node 327 in the binary tree structured data generated by the tree generating section 120.

The frequency distribution of individual contents calculated in this way can be expressed by an M-th order vector like H1=(v1, v2, . . . , vM). That is, this M-th order vector is generated with respect to each of nodes in the binary tree structured data generated by the tree generating section 120. For example, the histogram generated with respect to the node 327 shown in FIG. 11A can be expressed as H11=(0, 2, 0, 2, 0).

A linking process of nodes is performed on the basis of the frequency distribution calculated with respect to each of nodes in the binary tree structured data generated by the tree generating section 120 in this way. This linking process will be described later in detail with reference to FIGS. 12A and 12B.

It should be noted that while histograms can be similarly generated for the nodes 321 to 326, and 333 shown in FIG. 9 as well, the histograms with respect to the nodes 321 to 326 and 333 are not shown in FIGS. 11A to 11F.

### [Example of Cluster Extraction Using Event Clusters]

FIGS. 12A and 12B are diagrams each showing an example of comparison of histograms generated by the hierarchy determining section 150 according to the first embodiment of the present invention. FIG. 12A shows an example of comparison of histograms in the case when there is high relevance between two child nodes belonging to a parent node. Also, FIG. 12B shows an example of comparison of histograms in the case when there is low relevance between two child nodes belonging to a parent node.

As shown in FIGS. 11A to 11F, frequency distributions are calculated with respect to individual nodes in the binary tree structured data generated by the tree generating section 120, and histograms are generated. Each of the histograms generated in this way represents the characteristics of contents belonging to the node with respect to which the histogram is generated.

For example, the contents #3 to #5, and #9 to #12 belonging to the nodes 327, 328, and 330 shown in FIG. 9 are contents generated in the elementary school 387 shown in FIG. 9. Therefore, the respective histograms generated with respect to the nodes 327, 328, and 330 shown in FIGS. 11A, 11B, and 11D are similar to each other. Specifically, the frequencies of the class “id2” and class “id4” are high, whereas the frequencies of the other classes “id1”, “id3”, and “id5” are 0.

In this way, by comparison between histograms generated with respect to individual nodes in the binary tree structured data generated by the tree generating section 120, the degree of relevance between two nodes to be compared can be determined. This determination process is performed by comparing between two child nodes belonging to a single parent node.

For example, as shown in FIG. 12A, if classes with relatively high frequencies are substantially the same, and classes with relatively low frequencies are also substantially the same between two child nodes, the relevance between these two child nodes is considered to be high. In this case, the hierarchy determining section 150 links these two nodes together.

Also, for example, as shown in FIG. 12B, if classes with relatively high frequencies are completely different, and classes with relatively low frequencies are also completely different between two child nodes, the relevance between these two child nodes is considered to be low. In this case, without linking these two child nodes together, the hierarchy determining section 150 performs a judgment process with respect to two child nodes having each of these child nodes as their parent node.

Specifically, the hierarchy determining section 150 calculates a linkage score S with respect to each of nodes in the binary tree structured data generated by the tree generating section 120. This linkage score S is calculated by using, for example, an M-th order vector generated with respect to each of two child nodes belonging to a target node (parent node) for which to calculate the linkage score S.

For example, the hierarchy determining section 150 normalizes the inner product between an M-th order vector H_{L}, which is calculated with respect to one of the two child nodes belonging to a parent node as a calculation target, and an M-th order vector H_{R} calculated with respect to the other child node, by the vector size. Then, the hierarchy determining section 150 calculates the normalized value (that is, the cosine between the vectors) as the linkage score S. That is, the linkage score is calculated by using equation (4) below.

S=(H_{L}·H_{R})/|H_{L}∥H_{R}| (4)

At this time, the value of the cosine between the vectors is −1≦x≦1. Also, the M-th order vector H_{L} and the M-th order vector H_{R} for which to calculate the linkage score S are both vectors including only non-negative values. Therefore, the value of the linkage score S is 0≦S≦1. Also, the linkage score S of a leaf is defined as 1.0.

On the basis of the linkage score S calculated in this way, the degree of relevance between two child nodes belonging to a parent node as a calculation target can be determined. For example, if the linkage score S of the parent node as a calculation target is relatively small, the relevance between two child nodes belonging to the parent node can be judged to be low. On the other hand, if the linkage score S of the parent node as a calculation target is relatively large, the relevance between two child nodes belonging to the parent node can be judged to be high.

Specifically, the hierarchy determining section 150 calculates the linkage score S with respect to each of nodes in binary tree structured data generated by the tree generating section 120. Then, the hierarchy determining section 150 compares the calculated linkage score S with a linkage threshold (Linkage_Threshold) th3, and performs a node linking process on the basis of this calculation result. In this case, the hierarchy determining section 150 sequentially performs calculation and comparison processes of the linkage score S from the root node in the binary tree structured data generated by the tree generating section 120 toward the lower levels. Then, if the calculated linkage score S is larger than the linkage threshold th3, the hierarchy determining section 150 determines the corresponding node as an extraction node. On the other hand, if the calculated linkage score S is not larger than the linkage threshold th3, the hierarchy determining section 150 does not determine the corresponding node as an extraction node but repeats the same linking process with respect to each of two child nodes belonging to that node. These linking processes are repeated until there is no more node whose linkage score S is equal to the linkage threshold th3 or smaller, or until the node (content) at the bottom level is reached. It should be noted that the linkage threshold th3 is set by the condition setting section 190 in accordance with a user operation, and held by the hierarchy determining section 150. As the linkage threshold th3, for example, 0.25 can be used.

By performing linking processes in this way, for example, the nodes 321, 325, 329, and 330 shown in FIG. 9 are determined as extraction nodes.

Subsequently, the hierarchy determining section 150 generates a root node whose child elements (child nodes) are the extraction nodes determined by the linkage score calculation and comparison processes, thereby generating a tree. An example of a tree generated in this way is shown in FIG. 13A. This tree is a tree including the root node, clusters, and contents. Then, the hierarchy determining section 150 outputs the generated tree to the tree restructuring section 160. By correcting the binary tree generated by the tree generating section 120 in this way, clusters with high event-based linkage score can be linked together. Also, on the basis of the tree generated by the hierarchy determining section 150, a listing of marks (for example, cluster maps) representing individual clusters (groups) can be displayed. As a result, grouping can be performed in an appropriate manner in accordance with the user's preferences, and a listing of the corresponding groups can be displayed.

The above-described example is directed to the case in which, as the method of calculating the linkage score S, the cosine between vectors related to two child nodes belonging to a parent node as a calculation target is calculated. However, for example, it is also possible to calculate the Euclidean distance between vectors related to two child nodes belonging to a parent node as a calculation target, and use this Euclidean distance as the linkage score S. In the case where the Euclidean distance is used as the linkage score S in this way, if the value of the linkage score S is relatively large, for example, the relevance between two child nodes belonging to the parent node as a calculation target is judged to be high. On the other hand, if the value of the linkage score S is relatively small, for example, the relevance between the two child nodes belonging to the parent node as a calculation target is judged to be low. Also, a similarity may be calculated by using another similarity calculation method (for example, a method using the sum of histogram differences in individual classes) that can calculate the similarity between two frequency distributions to be compared (degree of how similar the two frequency distributions are), and this similarity may be used as the linkage score.

Extraction nodes determined by the hierarchy determining section 150 are determined on the basis of event clustering based on date and time information. Thus, by adjusting the parameter for clustering based on date and time, the granularity of extraction nodes can be adjusted. For example, if the granularity of event clusters is set relatively small, relatively small nodes are determined as extraction nodes.

### [Example of Tree Restructuring]

By linking two clusters (nodes) together through the linking process described above, contents belonging to a plurality of clusters of high mutual event-based relevance can be classified into the same cluster. However, when displaying a listing of marks (for example, cluster maps) representing individual clusters, it is supposed that unless the number of cluster maps is appropriate, the number of pages will become large, making it difficult to view the cluster maps. For this reason, for example, it is preferable to set an upper limit for the number of clusters, and perform a further linking process if the number of clusters generated by the hierarchy determining section 150 exceeds this upper limit. This upper limit may be set in accordance with the size of the display screen on the display section 181, or user's preferences.

Also, for example, a case can be supposed where the precision of positional information (for example, GPS information) acquired at the time of generation of a content is poor, and such positional information is associated with the content in that state. In such a case, if the distance between two adjacent clusters is very short, then there will not be much point in clearly separating those clusters from each other. Also, even when the relevance between two adjacent clusters is low, if these clusters are within a very short distance from each other, then in some cases it will be more convenient for the user to regard the two clusters as the same cluster. For example, if clusters (two adjacent clusters) corresponding to a region far from the region where the user lives are within a moderate distance (for example, 100 m) from each other, in some cases it will be more convenient for the user to regard these two clusters as the same cluster. For example, even if hot spring trips to two hot spring areas (◯◯ hot spring and AA hot spring) separated by a moderate distance (for example, 500 m) are taken on different dates, it will be better in some cases to regard those two clusters as the same cluster so that the user can view them as a single hot spring trip cluster.

Accordingly, after the linking process by the hierarchy determining section 150 is finished, the tree restructuring section 160 restructures the tree generated by the hierarchy determining section 150, on the basis of a specified constraint.

As this constraint, a minimum cluster size (MINIMUM_LOCATION_DISTANCE) or a tree's child element count (MAXIMUM_CHILD_NUM) can be specified. This constraint is set by the condition setting section 190 in accordance with a user operation, and held by the tree restructuring section 160.

Here, when a minimum cluster size is set as the constraint, it is possible to generate a tree in which the diameter of each cluster is larger than the minimum cluster size. For example, if a node whose diameter is equal to or smaller than the minimum cluster size exists among nodes in the tree generated by the hierarchy determining section 150, the node and another node located at the shortest distance to the node are linked together to generate a new node. In this way, for example, in cases when the accuracy of positional information associated with each content is poor, or when there is no much point in clearly separating two adjacent clusters from each other, these clusters can be linked together as the same cluster. Also, for example, if the ΔΔ trip destination 388 and the ◯◯ trip destination 389 are both narrow regions and located very close to each other, by linking the respective corresponding nodes 325 and 329 together as the same cluster, easy-to-view cluster information can be provided to the user.

When a child element count is specified as the constraint, it is possible to generate a tree whose number of nodes is equal to or less than the child element count. Each of these examples of tree restructuring is shown is FIGS. 13A and 13B.

FIGS. 13A and 13B are diagrams schematically showing the flow of a tree restructuring process by the tree restructuring section 160 according to the first embodiment of the present invention. FIG. 13A shows a tree made up of extraction nodes determined by the hierarchy determining section 150 in the clustering tree diagram having the binary tree structured shown in FIG. 9. It should be noted that since the method of generating this tree is the same as the method described above, description thereof is omitted here.

FIG. 13B shows a tree made up of nodes generated by a tree restructuring process by the tree restructuring section 160. This example illustrates a case in which 3 is specified as a tree's child element count (MAXIMUM_CHILD_NUM).

If, for example, the number of nodes determined by the hierarchy determining section 150 is larger than the child element count that is a specified constraint, the tree restructuring section 160 extracts a pair of nodes with the smallest distance from among those nodes, and merges this pair. If the number of nodes after this merging is larger than the child element count as a specified constraint, the tree restructuring section 160 extracts a pair of nodes with the smallest distance from among the nodes obtained after the merging, and merges this pair. These merging processes are repeated until the number of child nodes belonging to the root node becomes equal to or less than the child element count.

For example, as shown in FIG. 13A, the number of nodes determined by the hierarchy determining section 150, namely the nodes 321, 325, 329, and 330, is larger than the child element count (3) as a specified constraint. Therefore, the tree restructuring section 160 extracts a pair of nodes with the smallest distance from among the nodes 321, 325, 329, and 330, and merges this pair. In this case, as shown in FIG. 8, the nodes 325 and 329 are the pair with the smallest distance. Thus, the tree restructuring section 160 extracts the pair of the nodes 325 and 329, and merges the nodes 325 and 329. As the nodes 325 and 329 are merged in this way, the number of nodes after this merging becomes equal to the child element count (3) as a specified constraint. Thus, the merging process ends. FIG. 13B shows a tree in the case when the number of nodes is set equal to the child element count (3) as a specified constraint in this way.

As shown in FIG. 13B, by the tree restructuring section 160, the number of nodes is set equal to the number of child elements (3) as a specified constraint, and nodes 355, 356, and 357 are determined. It should be noted that the node 355 corresponds to the wedding ceremony hall 386, the node 356 corresponds to the elementary school 387, and the node 357 corresponds to each of the ΔΔ trip destination 388 and the ◯◯ trip destination 389. Also, the node 355 corresponds to the node 321 shown in FIG. 9, the node 356 corresponds to the node 330 shown in FIG. 9, and the node 357 corresponds to the node 331 shown in FIG. 9. Here, since the contents belonging to the node 357 are generated at the ΔΔ trip destination 388 or the ◯◯ trip destination 389, it is possible to consider these contents as having low mutual relevance. However, as described above, even when nodes have low mutual relevance as events, if the nodes are located close to each other, there is a possibility that it is better to group such nodes together for the ease of viewing by the user. For example, if the ΔΔ trip destination 388 and the ◯◯ trip destination 389 are within close proximity of each other in the ★★ prefecture, the respective corresponding nodes 325 and 329 are linked together as a single trip cluster for the ★★ prefecture, thereby making it possible to provide easy-to-view cluster information to the user.

By performing these tree restructuring processes, grouping can be performed in an appropriate manner in accordance with the user's preferences. It should be noted that the first embodiment of the present invention is directed to the case in which positional information (first attribute information) and date and time information (second attribute information) are used as two different pieces of attribute information. However, among the pieces of attribute information associated with contents, other pieces of attribute information that can identify the relationship between contents may be used as the first attribute information and the second attribute information. For example, the first embodiment of the present invention can be applied to a case in which, with respect to song contents, attribute information corresponding to coordinates in the xy-coordinate system with the mood of each song taken along the x-axis and the tempo of each song taken along the y-axis is used as the first attribute information, and attribute information related to the writer of each song is used as the second attribute information. In this case, for example, binary tree structured data with respect to a plurality of songs is generated on the basis of distances on the xy-coordinates, and the songs are grouped by their characteristics on the basis of attribute information related to the writers of the songs (for example, age, sex, nationality, and the number of songs written). Then, on the basis of the binary tree structured data based on the first attribute information, and the song groups based on the second attribute information, a plurality of groups are determined with respect to the songs. It should be noted that the above example is directed to the case in which a plurality of groups are set by classifying individual contents. In the following, a description will be given of a case in which marks (for example, cluster maps) representing the set groups are generated.

### [Method of Generating Maps Corresponding to Clusters]

As described above, for clusters generated by the three stages of clustering process, for example, marks representing individual clusters are displayed on the display section 181, thereby making it possible to select a desired cluster from a plurality of clusters. Here, as images representing individual clusters, for example, maps corresponding to individual clusters can be used. For example, on the basis of positional information associated with each of contents belonging to a cluster, an area corresponding to the cluster can be identified, and a map covering this identified area can be used as a map (cluster map) corresponding to the cluster.

However, the size of a cluster generated through the three stages of clustering process is based on the positions of contents belonging to each cluster. Thus, as for the size of each cluster, there is no relevance whatsoever between clusters. Therefore, the size of an area (for example, a circle) specified by such a cluster varies from cluster to cluster.

Here, suppose that, when using a map as a mark representing each cluster, for example, a map at a specific scale is used. In this case, the position corresponding to each cluster can be grasped from a map corresponding to each cluster. However, it is supposed that by changing the scale of a map representing each cluster in accordance with the size of a circle corresponding to each cluster, the shooting area or the like of each of contents belonging to each cluster can be also easily grasped by the user. Accordingly, in the first embodiment of the present invention, a case is illustrated in which the scale of a map stored in association with each cluster is changed in accordance with the size of a circle corresponding to each cluster. In the following, with reference to the drawings, a detailed description will be given of the method of generating a map associated with each of clusters generated by the tree restructuring section 160.

FIG. 14 is a diagram showing a correspondence table used for generating map information by the cluster information generating section 170 according to the first embodiment of the present invention. This correspondence table is held by the cluster information generating section 170.

The correspondence table shown in FIG. 14 is a table showing the correspondence between the diameter (Cluster Diameter 171) of a circle corresponding to each of clusters generated by the tree restructuring section 160, and Map Scale 172.

The Cluster Diameter 171 is a value indicating the range of the size of each cluster generated by the tree restructuring section 160. The size of a cluster is identified by the diameter of a circle corresponding to the cluster.

The Map Scale 172 is a map scale that is to be stored in association with each cluster generated by the tree restructuring section 160. It should be noted that in this example, a plurality of segments are set in advance for the Cluster Diameter 171, and these segments and a plurality of scales corresponding to these segments are prepared in advance. However, it is also possible, for example, to sequentially calculate a map scale corresponding to a cluster diameter, and use this calculated map scale.

When generating a map corresponding to a cluster generated by the tree restructuring section 160, the cluster information generating section 170 uses the correspondence table shown in FIG. 14 to identify a map scale to be assigned to the cluster from the size of the cluster. For example, if the diameter of a circle corresponding to a cluster generated by the tree restructuring section 160 is 3.5 km, this corresponds to “2 km to 4 km” of the Cluster Diameter 171 in the correspondence table shown in FIG. 14. Thus, “1/200000” is identified as the map scale to be assigned to the cluster.

Subsequently, with respect to the cluster for which the map scale has been identified, the cluster information generating section 170 identifies the center position of the cluster, and extracts from the map information storing section 220 a map covering a predetermined area from the center position (a map of the identified scale). Then, the cluster information generating section 170 records the extracted map as a thumbnail in association with the cluster to the cluster information storing section 240 (the Cluster Map 247 shown in FIG. 5).

It is also possible to set a circle corresponding to the radius of a cluster from the center position of the cluster as an extraction range, extract a map covering this extraction range from a map of a predetermined scale, and magnify or shrink the extracted map in accordance with the size of the cluster to thereby generate a cluster map. In this way, in the same manner as in the above-described case, a thumbnail image of a cluster map according to the size of the corresponding cluster can be generated.

Now, consider a case where the size of a cluster generated by the tree restructuring section 160 is small. If the size of a cluster is small as in this case, when a map is extracted by using the map extraction method described above, a map covering a relatively small area is generated. In the case of such a map covering a relatively small area, a case can be supposed where no landmark (for example, a public facility or a park) is present in the map. In such a case, for example, there is a possibility that when a map is displayed as a thumbnail image, although the details of the map can be grasped, it is hard to easily grasp what region the map is showing. Accordingly, when creating the correspondence table shown in FIG. 14, it is preferable to set a lower limit value for the cluster size. That is, if the size of a cluster is smaller than the lower limit value, a map with a size equal to the lower limit value is used. In this case, although a map with the size equal to the lower limit value may be used as it is as a thumbnail image for display, for example, the contour of a circle corresponding to the area of the cluster may be drawn on the extracted map. In this way, by using a map covering a relatively large area, the region corresponding to the map can be easily grasped, and the area of the cluster can be also easily grasped.

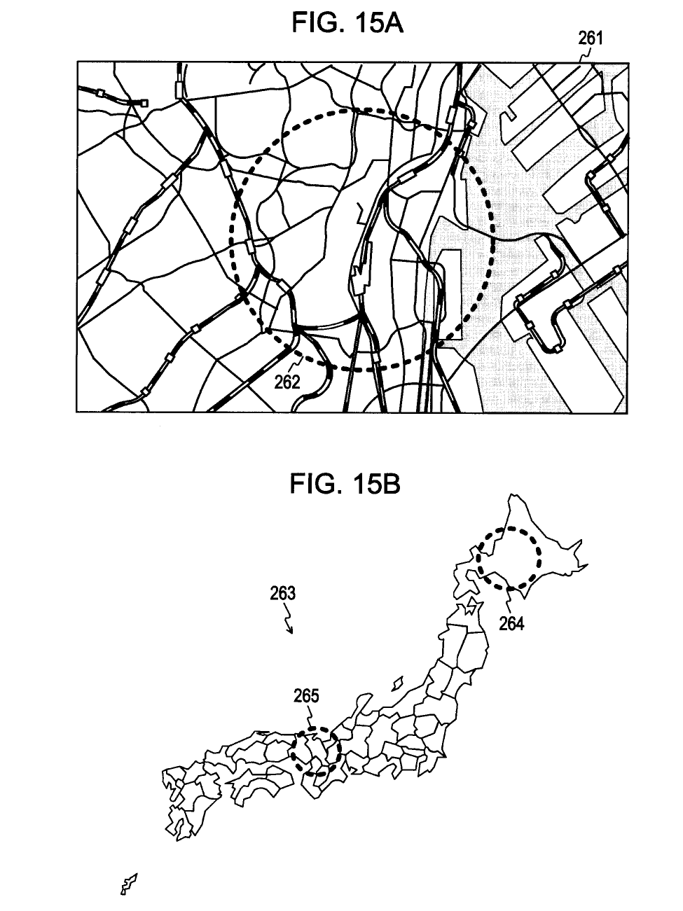

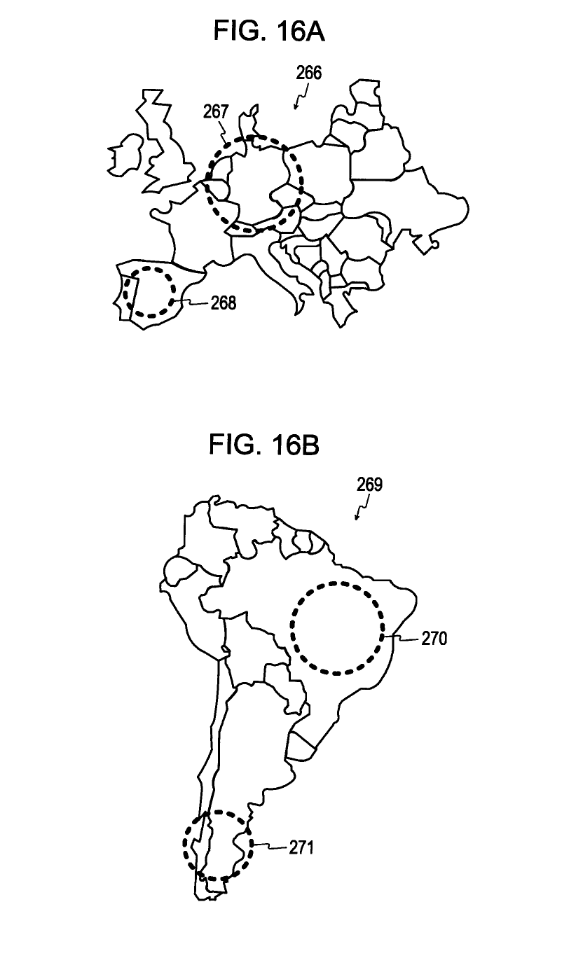

FIGS. 15A and 15B and FIGS. 16A and 16B are diagrams each showing an example of a map generated by the cluster information generating section 170 according to the first embodiment of the present invention. It should be noted that in FIGS. 15A and 15B and FIGS. 16A and 16B, an extraction area of the map is indicated by a thick dotted circle.

FIG. 15A shows an extraction area 262 at which a cluster map is extracted from a map 261 of the vicinity of the Shinagawa station. The cluster corresponding to the extraction area 262 is a cluster made up of contents generated in the vicinity of the Shinagawa station.

FIG. 15B shows extraction areas 264 and 265 at which cluster maps are extracted from a map 263 of the Japanese archipelago. The cluster corresponding to the extraction area 264 is a cluster made up of contents generated in Hokkaido (for example, Hokkaido trip). Also, the cluster corresponding to the extraction area 265 is a cluster made up of contents generated in the Kansai region (for example, Kansai trip).

FIG. 16A shows extraction areas 267 and 268 at which cluster maps are extracted from a map 266 of the Europe region. The cluster corresponding to the extraction area 267 is a cluster made up of contents generated in the vicinity of Germany (for example, Germany trip). Also, the cluster corresponding to the extraction area 268 is a cluster made up of contents generated in the vicinity of Spain (for example, Spain/Portugal trip).

FIG. 16B shows extraction areas 270 and 271 at which cluster maps are extracted from a map 269 of the South America region. The cluster corresponding to the extraction area 270 is a cluster made up of contents generated within Brazil (for example, Brazil business trip). Also, the cluster corresponding to the extraction area 271 is a cluster made up of contents generated in the vicinity of Argentine/Chile (for example, Argentine/Chile trip).

As shown in FIGS. 15A and 15B and FIGS. 16A and 16B, with respect to each cluster generated by the tree restructuring section 160, a thumbnail image (cluster map) to be stored in association with this cluster is generated. Also, as shown in FIG. 4, with respect to each cluster generated by the tree restructuring section 160, a cluster title (address) to be stored in association with this cluster is determined.

Then, the cluster information generating section 170 records the thumbnail image (cluster map) generated in this way into the cluster information storing section 240 in association with the corresponding cluster (the Cluster Map 247 shown in FIG. 5). Also, the cluster information generating section 170 records the cluster title (address) generated in this way into the cluster information storing section 240 in association with the corresponding cluster (the Cluster Title 248 shown in FIG. 5). Also, the cluster information generating section 170 records individual pieces of cluster information related to a cluster generated by the tree restructuring section 160 into the cluster information storing section 240 in association with the corresponding cluster (the Cluster Position Information 242, the Cluster Size 243, and so on shown in FIG. 5).

It should be noted that in the case where map information stored in the map information storing section 220 is the map information of a vector map, and the positions of landmarks or the like can be detected on the basis of the map information, the position of the area that has been cut out or the scale may be adjusted so that the landmarks or the like are included. For example, even if no landmark is included in the extraction area from which to extract a cluster map, if a landmark exists in the vicinity of the extraction area, the position of the extraction area or the scale of the map from which to extract the extraction area is changed so that the landmark is included. Also, the size of the extraction area may be changed. In the case where the information processing apparatus 100 can access a database in which the positions of landmarks or the like are stored, likewise, the position of the area that has been cut out or the scale may be adjusted so that the landmarks or the like are included. With landmarks or the like included in the map cut out in this way, it is possible to create a thumbnail image which makes it easy for the user to grasp the region corresponding to the map, as compared with a map inclusive of only roads.

### [Example of Display Screen Transition]

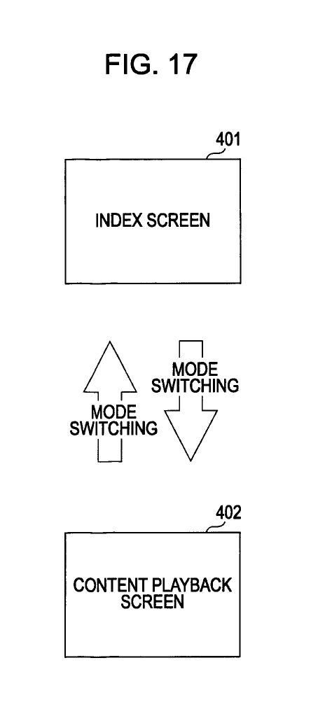

FIG. 17 is a diagram showing an example of transition of the display screen of the display section 181 which is performed by the display control section 180 according to the first embodiment of the present invention. The first embodiment of the present invention is directed to the case of displaying an index screen and a content playback screen.

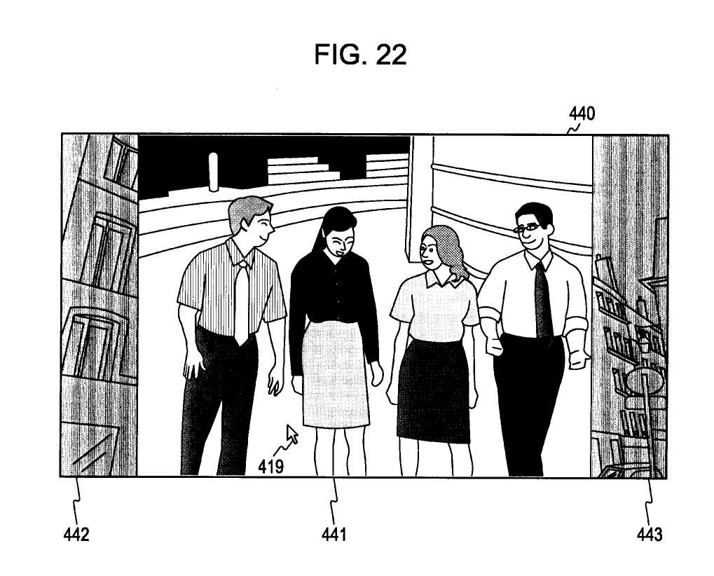

For example, when an operational input for activating a content playback application is accepted by the operation accepting section 200 in the information processing apparatus 100, the display control section 180 displays an index screen 401 on the display section 181. The index screen 401 is a display screen that displays a listing of clusters from which to select a desired cluster. Examples of display of the index screen 401 are shown in FIGS. 18 to 21. Also, when an operational input for determining a desired cluster is accepted by the operation accepting section 200 on the index screen 401 displayed on the display section 181, the display control section 180 displays a content playback screen 402 on the display section 181. The content playback screen 402 is a display screen that displays contents belonging to the cluster on which a determining operation has been made. Examples of display of the content playback screen 402 are shown in FIGS. 22 to 27B.

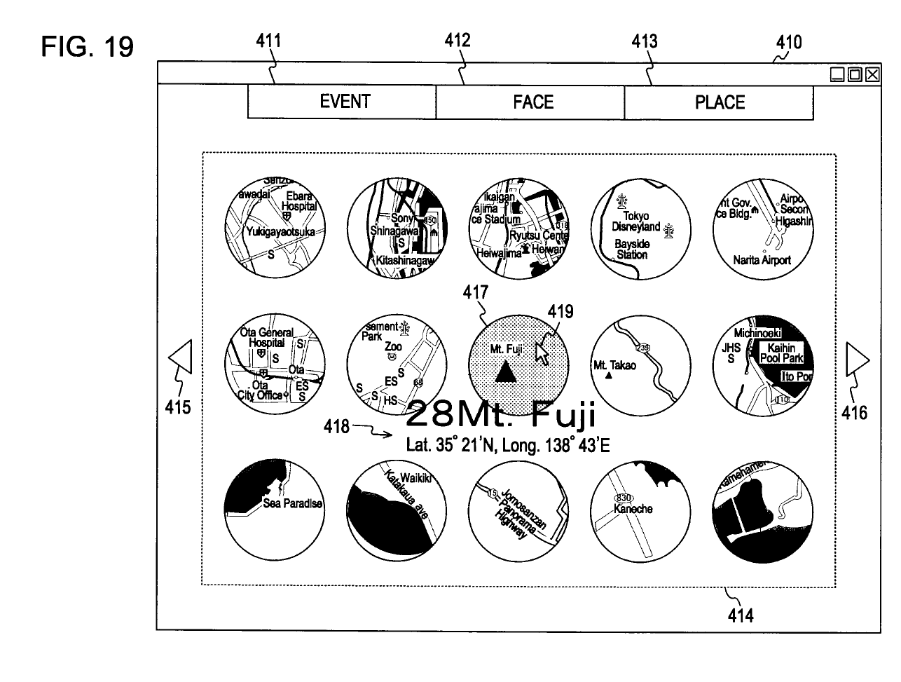

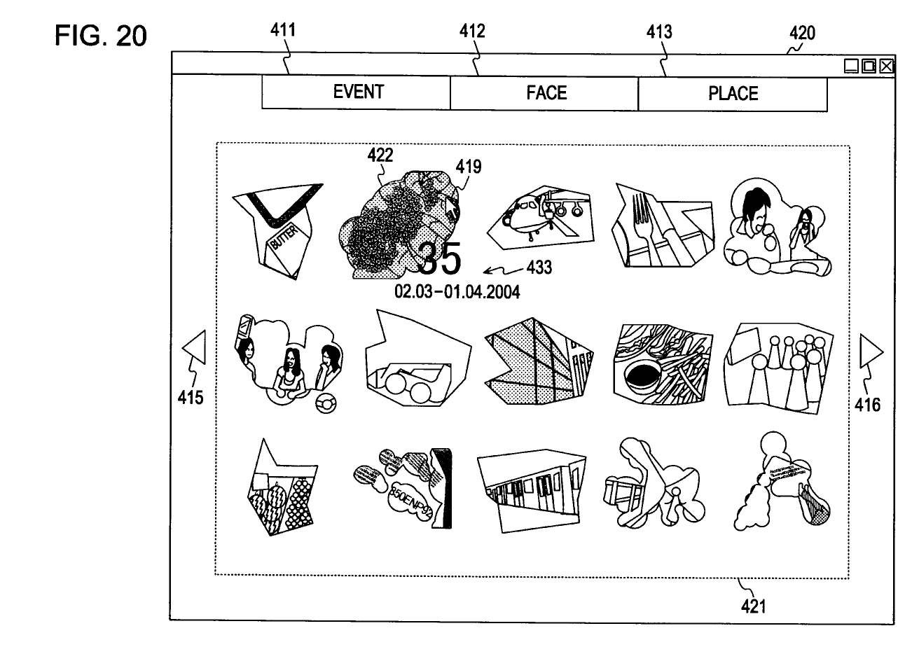

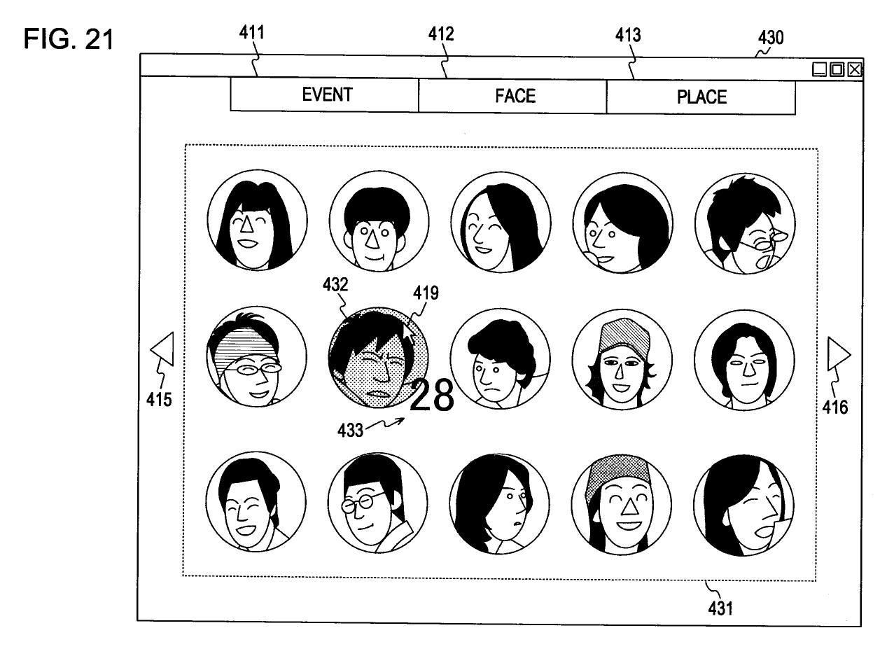

FIGS. 18 to 21 are diagrams each showing an example of display of an index screen displayed by the display control section 180 according to the first embodiment of the present invention. FIGS. 18 and 19 each show an example of display of an index screen that displays cluster maps as index images. FIG. 20 shows an example of display of an index screen that displays index images generated on the basis of date and time information, and FIG. 21 shows an example of display of an index screen that displays index images generated on the basis of face information. It should be noted that a cursor (mouse pointer) 419 that moves with the movement of a mouse (not shown) is displayed on the screen displayed on the display section 181. The cursor 419 is a mouse pointer used to point to an object of instruction or operation on the screen displayed on the display section 181.

On an index screen 410 shown in FIG. 18, there are provided an “EVENT” tab 411, a “FACE” tab 412, a “PLACE” tab 413, a cluster map display area 414, and left and right buttons 415 and 416.

The “EVENT” tab 411, the “FACE” tab 412, and the “PLACE” tab 413 are tabs for displaying another index screen. For example, when the “FACE” tab 412 is depressed using the cursor 419 by a user operation, an index screen 420 shown in FIG. 20 is displayed. Also, when the “PLACE” tab 413 is depressed using the cursor 419 by a user operation, an index screen 430 shown in FIG. 21 is displayed. Also, when the “EVENT” tab 411 is depressed using the cursor 419 by a user operation on the index screen 420 shown in FIG. 20 or the index screen 430 shown in FIG. 21, the index screen 410 shown in FIG. 18 is displayed.

In the cluster map display area 414, a listing of marks (cluster maps) representing clusters generated by the tree restructuring section 160 and stored in the cluster information storing section 240 is displayed. For example, as shown in FIG. 18, cluster maps of the same size are displayed in a 3×5 matrix fashion, for example.

The left and right buttons 415 and 416 are operating buttons that are displayed when there are cluster maps other than the cluster maps being displayed in the cluster map display area 414. For example, when the left button 415 or the right button 416 is depressed, in accordance with this depressing operation, the cluster maps being displayed in the cluster map display area 414 are moved to the left or right, thereby making it possible to display other cluster maps.

Here, a description will be given of a case in which a mouse-over is performed on a desired cluster map by a user operation on the index screen 410 shown in FIG. 18. A mouse-over refers to a visual effect that performs display control such as changing the color of a desired image when a cursor is placed over the image.

For example, when the mouse is placed over a cluster map 417 by a user operation on the index screen 410 shown in FIG. 18, as shown in FIG. 19, the color of the cluster map 417 is changed, and pieces of information 418 related to the cluster map 417 are displayed. For example, the entire cluster map 417 is changed to a conspicuous color (for example, grey) and displayed. As the pieces of information 418 related to the cluster map 417, for example, the number of contents “28” belonging to a cluster corresponding to the cluster map 417, and the cluster title “Mt. Fuji” of the cluster are displayed. Also, as the pieces of information 418 related to the cluster map 417, for example, information on the latitude and longitude of the center position of the cluster corresponding to the cluster map 417, “Lat. 35°21′N, Long. 138°43′E”, is displayed.

As the pieces of information 418 related to the cluster map 417, information indicating the size of the cluster may be also displayed together. For example, the diameter of a circle corresponding to the cluster can be displayed as “◯◯ km”. Also, for example, in order to allow the user to intuitively grasp whether the size of a circle corresponding to a cluster is large or small, display of icons or color can be made to differ depending on whether the size is large or not. For example, when comparing an urban area and a rural area with each other, it is supposed that while buildings, roads, and the like are densely packed in the urban area, in the rural area, there are relatively many mountains, farms, and the like, and there are relatively few buildings, roads, and the like. For this reason, the amount of information in a map often differs between the urban area and the rural area. Due to this difference in the amount of information in a map, it is supposed that when cluster maps of the urban area and rural area are displayed simultaneously, the user feels a difference in the perceived sense of scale between the urban area and the rural area. Accordingly, for example, by displaying these cluster maps in different manners depending on whether the size of a circle corresponding to a cluster is large or small, it is possible to prevent a difference in the perceived sense of scale between the urban area and the rural area, and intuitively grasp whether the size of a circle corresponding to a cluster is large or small. Also, as the pieces of information 418 related to the cluster map 417, other pieces of information such as the time range of the corresponding contents may be displayed.

On the index screen 420 shown in FIG. 20, there are provided the “EVENT” tab 411, the “FACE” tab 412, the “PLACE” tab 413, the left and right buttons 415 and 416, and an event cluster image display area 421.

On the index screen 430 shown in FIG. 21, there are provided the “EVENT” tab 411, the “FACE” tab 412, the “PLACE” tab 413, the left and right buttons 415 and 416, and a face cluster image display area 421. It should be noted that since the “EVENT” tab 411, the “FACE” tab 412, the “PLACE” tab 413, and the left and right buttons 415 and 416 shown in FIGS. 20 and 21 are the same as those shown in FIGS. 18 and 19, these are denoted by the same reference numerals, and their description is omitted.

In the event cluster image display area 421 shown in FIG. 20, images representing event clusters generated by the event cluster generating section 130 and stored in the cluster information storing section 240 are displayed. As each of these images representing event clusters, for example, a thumbnail image of a single representative image extracted from among the contents belonging to each event cluster can be used. Also, a thumbnail image obtained by applying predetermined image processing (for example, image processing for shaping the boundary of each image area into an aesthetically pleasing geometrical contour as shown in FIG. 20) to the representative image can be used. Such thumbnail images are displayed, for example, in a 3×5 matrix fashion in the same manner as in FIG. 18.

Also, for example, when the mouse is placed over a thumbnail image 422 by a user operation on the index screen 420 shown in FIG. 20, the color of the thumbnail image 422 changes, and pieces of information 423 related to the thumbnail image 422 are displayed. As the pieces of information 423 related to the thumbnail image 422, for example, the number of contents “35” belonging to a cluster corresponding to the thumbnail image 422, and the time range “02.03-01.04.2004” of the contents belonging to the cluster are displayed. Also, as the pieces of information 423 related to the thumbnail image 422, other pieces of information such as a title may be displayed as well.

In the face cluster image display area 431 shown in FIG. 21, images representing face clusters generated by the face cluster generating section 140 and stored in the cluster information storing section 240 are displayed. As such an image representing a face cluster, for example, a thumbnail image of each of faces included in contents belonging to the face cluster can be used. For example, as such a thumbnail image of a face, faces included in the contents belonging to the face cluster are extracted, the best-shot face is selected from among these extracted faces, and the thumbnail image of this selected face can be used. Such thumbnail images are displayed, for example, in a 3×5 matrix fashion in the same manner as in FIG. 18.

Also, for example, when the mouse is placed over a thumbnail image 432 by a user operation on the index screen 430 shown in FIG. 21, the color of the thumbnail image 432 changes, and pieces of information 433 related to the thumbnail image 432 are displayed. As the pieces of information 433 related to the thumbnail image 432, for example, the number of contents “28” belonging to a cluster corresponding to the thumbnail image 432 is displayed. Also, as the pieces of information 433 related to the thumbnail image 432, for example, other pieces of information such as the name of the person corresponding to the face may be displayed as well.

When a desired cluster is determined by a user operation on the index screen shown in each of FIGS. 18 to 21, the display control section 180 displays a content playback screen on the display section 181.

FIGS. 22 to 26 are diagrams each showing an example of display of a content playback screen displayed by the display control section 180 according to the first embodiment of the present invention.

FIG. 22 shows a content playback screen 440 that automatically displays contents belonging to a cluster determined by a user operation in slide show. The content playback screen 440 is provided with a content display area 441, a preceding content display area 442, and a succeeding content display area 443. Contents are sequentially displayed on the content playback screen 440 on the basis of a predetermined rule (for example, in time series).

The content display area 441 is an area for displaying a content in the central portion of the content playback screen 440. The preceding content display area 442 is an area for displaying a content positioned before the content being displayed in the content display area 441. The succeeding content display area 443 is an area for displaying a content positioned after the content being displayed in the content display area 441. That is, in the content display area 441, the preceding content display area 442, and the succeeding content display area 443, successive contents are displayed while being arranged side by side in accordance with a predetermined rule. Also, when no user operation is made for a predetermined period of time (for example, three seconds) in the state with the content playback screen 440 displayed on the display section 181, the content displayed in the succeeding content display area 443 is displayed in the content display area 441. That is, the contents displayed in the content display area 441, the preceding content display area 442, and the succeeding content display area 443 are displayed while being made to slide over one another.

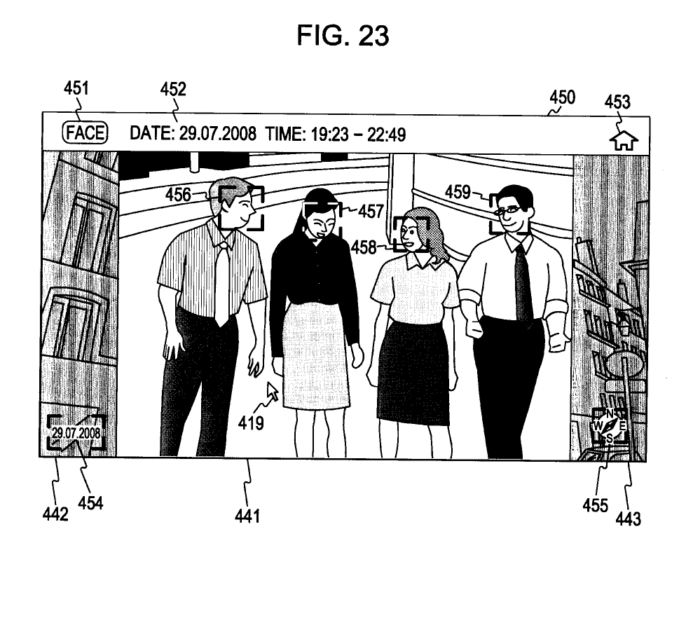

When a user operation (for example, a mouse operation) is made in the state with the content playback screen 440 displayed on the display section 181, a content playback screen 450 shown in FIG. 23 is displayed.

On the content playback screen 450, display mode information 451, content information 452, an index screen transition button 453, a date and time cluster transition button 454, and a position cluster transition button 455 are displayed. That is, various kinds of operation assistance information are displayed on the content playback screen 440 shown in FIG. 22.

The display mode information 451 is information indicating the current display mode. For example, when “FACE” is displayed as the display mode information 451 as shown in FIG. 23, this indicates that the current display mode is the display mode for face clusters. Also, for example, when “LOCATION” is displayed as the display mode information 451, this indicates that the current display mode is the display mode for position cluster. Also, for example, when “EVENT” is displayed as the display mode information 451, this indicates that the current display mode is the display mode for date and time cluster.

The content information 452 is information related to the content being displayed in the content display area 441. In the content information 452, as information related to a content, for example, the time of generation of the content, the time range of the contents of a cluster to which the content belongs, and the like are displayed.

The index screen transition button 453 is a button that is depressed when transitioning to an index screen. For example, as shown in FIG. 23, a house-shaped icon can be used as the index screen transition button 453. When the index screen transition button 453 is depressed, the index screen for a cluster corresponding to the display mode displayed in the display mode information 451 is displayed. For example, in the case where the content playback screen 450 shown in FIG. 23 is displayed, when the index screen transition button 453 is depressed, the index screen 420 shown in FIG. 21 is displayed.

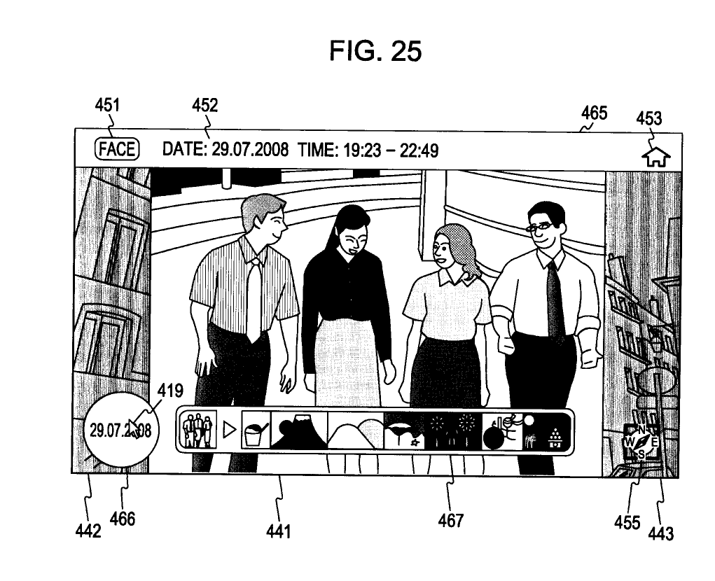

The date and time cluster transition button 454 is a button that is depressed when transitioning to the content playback screen for date and time cluster. In the date and time cluster transition button 454, the time range of a date and time cluster to which the content displayed in the content display area 441 belongs is displayed inside a rectangular box indicated by broken lines. It should be noted that in the date and time cluster transition button 454, other pieces of information related to the date and time cluster to which the content displayed in the content display area 441 belongs may be displayed as well. Also, an example of display when the mouse is placed over the date and time cluster transition button 454 is shown in FIG. 25.

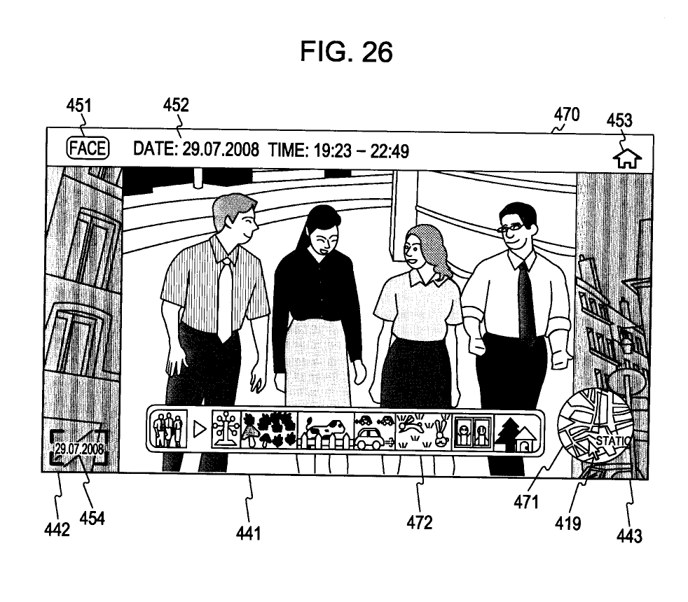

The position cluster transition button 455 is a button that is depressed when transitioning to the content playback screen for position cluster. In the position cluster transition button 455, an icon representing a compass depicted in graphic form is displayed inside a rectangular box indicated by broken lines. It should be noted that in the position cluster transition button 455, information related to a position cluster to which the content displayed in the content display area 441 belongs may be displayed as well. It should be noted that an example of display when the mouse is placed over the position cluster transition button 455 is shown in FIG. 26.

When a person's face is included in the content displayed in the content display area 441, a face box (for example, a rectangular box indicated by broken lines) is attached to the face and displayed. This face box is used as a button that is depressed when transitioning to the content playback screen for face cluster. For example, since the faces of four persons are included in the content displayed in the content display area 441 shown in FIG. 23, face boxes 456 to 459 are attached to the respective faces. It should be noted that as the method of detecting a face included in a content, for example, a face detection method based on matching between a template in which face brightness distribution information is recorded, and a content image (see, for example, Japanese Unexamined Patent Application Publication No. 2004-133637) can be used. Also, it is possible to use a face detection method based on a skin color portion included in a content image, or the features of a human face. Such face detection may be performed every time a content is displayed, or may be performed in advance as part of content attribute information and this content attribute information may be used.

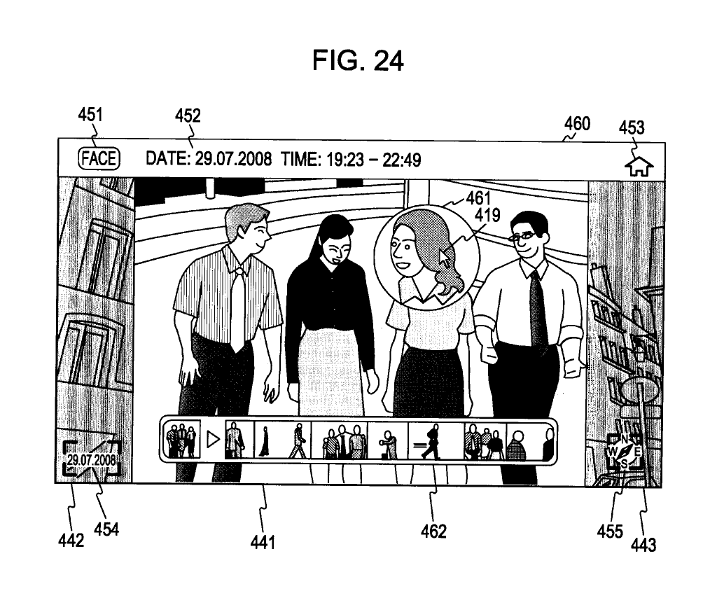

An example of display when the mouse is placed over the face portion included in the face box 458 on the content playback screen 450 shown in FIG. 23 is shown in FIG. 24.

FIG. 24 shows a content playback screen 460 that is displayed when the mouse is placed over the face portion included in the face box 458 on the content playback screen 450 shown in FIG. 23. As shown in FIG. 24, when the mouse is placed over the face portion included in the face box 458 on the content playback screen 450, an image 461 of the vicinity of the face included in the face box 458 is displayed in magnified form. Also, a content listing display area 462 is displayed on the image of the content displayed in the content display area 441. The content listing display area 462 is an area where a listing of contents included in the face cluster to which the content displayed in the content display area 441 belongs is displayed. For example, the thumbnail image of the content being displayed in the content display area 441 is displayed at the left end portion of the content listing display area 462, and the thumbnail images of the other contents included in the same face cluster are displayed while being arranged side by side in the left-right direction on the basis of a predetermined rule. If the number of contents included in the same cluster is large, the contents may be scroll-displayed by a user operation.

Also, for example, as shown in FIG. 24, in the state with the mouse placed over the face portion included in the face box 458 on the content playback screen 460, when a determining operation (for example, a click operation with the mouse) is made on the face, the screen transitions to the content playback screen for face cluster. On this content playback screen, contents included in the face cluster to which the face on which the determining operation has been made belongs are automatically displayed in slide show as shown in FIG. 22, for example.

FIG. 25 shows a content playback screen 465 that is displayed when the mouse is placed over the date and time cluster transition button 454 on the content playback screen 450 shown in FIG. 23. As shown in FIG. 25, when the mouse is placed over the date and time cluster transition button 454 on the content playback screen 450, date and time information (for example, the time range of the corresponding date and time cluster) 466 included in the date and time cluster transition button 454 is displayed in magnified form. Also, as in the case shown in FIG. 24, a content listing display area 467 is displayed on the image of the content being displayed in the content display area 441. The content listing display area 467 is an area where a listing of contents included in the date and time cluster to which the content displayed in the content display area 441 belongs is displayed. It should be noted that since the method of display in the content listing display area 467 is substantially the same as the example shown in FIG. 24, description thereof is omitted here.

Also, for example, as shown in FIG. 25, in the state with the mouse placed over the date and time information 466 on the content playback screen 465, when a determining operation (for example, a click operation with the mouse) is made on the date and time information 466, the screen transitions to the content playback screen for date and time cluster. On this content playback screen, contents included in the date and time cluster to which the content displayed in the content display area 441 at the time of the determining operation belongs are automatically displayed in slide show as shown in FIG. 22, for example.

FIG. 26 shows a content playback screen 470 that is displayed when the mouse is placed over the position cluster transition button 455 on the content playback screen 450 shown in FIG. 23. As shown in FIG. 26, when the mouse is placed over the position cluster transition button 455 on the content playback screen 450, a cluster map 471 corresponding to the position cluster to which the content displayed in the content display area 441 belongs is displayed in magnified form. Also, as in the case shown in FIG. 24, a content listing display area 472 is displayed on the image of the content displayed in the content display area 441. The content listing display area 472 is an area where a listing of contents included in the position cluster to which the content displayed in the content display area 441 belongs is displayed. It should be noted that since the method of display in the content listing display area 472 is substantially the same as the example shown in FIG. 24, description thereof is omitted here.

Also, for example, as shown in FIG. 26, in the state with the mouse placed over the cluster map 471 on the content playback screen 470, when a determining operation (for example, a click operation with the mouse) is made on the cluster map 471, the screen transitions to the content playback screen for position cluster. On this content playback screen, contents included in the position cluster to which the content displayed in the content display area 441 at the time of the determining operation belongs are automatically displayed in slide show as shown in FIG. 22, for example.

Each one of contents stored in the content storing section 210 belongs to any one cluster of each of position clusters, event clusters, and face clusters. That is, each one of contents belongs to any one cluster of positional clusters, belongs to any one cluster of event clusters, and belongs to any one cluster of face clusters. For this reason, with one of the contents stored in the content storing section 210 taken as a base point, display can be made to transition from a given cluster to another cluster.

For example, suppose a case in which a desired cluster map is selected on the index screen 420 shown in FIG. 18. In this case, contents belonging to a position cluster corresponding to the selected cluster map are sequentially displayed on the content playback screen 440 shown in FIG. 22, for example. A case can be supposed where among the contents displayed in this way, it is desired to see other contents related to a given person. For example, suppose a case in which among the persons displayed on the content playback screen 440 shown in FIG. 22, the user is to view other contents related to the second person from the right. In this case, by performing a user operation in the state in which the content playback screen 440 is displayed, as shown in FIG. 23, the content playback screen 450 provided with various pieces of operation assistance information is displayed. On the content playback screen 450 displayed, face boxes are attached to the faces of persons included in the content displayed in the content display area 441. Accordingly, to see other contents related to the second person from the right (the person attached with the face box 458), the face box 458 is selected and a determining operation is made. With this determining operation, contents included in the face cluster to which the face of the person attached with the face box 458 belongs are sequentially displayed on the content playback screen 440 shown in FIG. 22, for example.

Also, a case can be supposed where among contents belonging to a face cluster to which a desired face belongs, it is desired to see other contents generated at times close to the time of generation of a given content. In this case, by performing a user operation in the state in which the content playback screen 440 is displayed, as shown in FIG. 23, the content playback screen 450 provided with various pieces of operation assistance information is displayed. On the content playback screen 450, there is provided the date and time cluster transition button 454 for transitioning to the content playback screen for date and time cluster. Accordingly, to see other contents generated at times close to the time of generation of the content displayed in the content display area 441, the date and time cluster transition button 454 is selected and a determining operation is made. With this determining operation, contents included in the date and time cluster to which the content displayed in the content display area 441 belongs are sequentially displayed on the content playback screen 440 shown in FIG. 22, for example.

Also, a case can be supposed where among the contents belonging to a date and time cluster to which a content generated during a desired time period belongs, it is desired to see other contents generated at places close to the place of generation of a given content. In this case, by performing a user operation in the state in which the content playback screen 440 is displayed, as shown in FIG. 23, the content playback screen 450 provided with various pieces of operation assistance information is displayed. On the content playback screen 450, there is provided the position cluster transition button 455 for transitioning to the content playback screen for position cluster. Accordingly, to see other contents generated at places close to the place of generation of the content displayed in the content display area 441, the position cluster transition button 455 is selected and a determining operation is made. With this determining operation, contents included in the position cluster to which the content displayed in the content display area 441 belongs are sequentially displayed on the content playback screen 440 shown in FIG. 22, for example.

In this way, with one of the contents stored in the content storing section 210 taken as a base point, transition of display from a given cluster to another cluster can be easily performed, thereby making it possible to enhance interest during content playback. In addition, since content search can be performed quickly, and searching can be performed from a variety of perspectives, it is possible to enhance the fun of content playback.

The foregoing description is directed to the case in which cluster maps are displayed on an index screen or content playback screen. In this regard, a cluster map includes the generated positions of contents belonging to a cluster corresponding to the cluster map. Accordingly, on the cluster map to be displayed, generated-position marks (for example, inverted triangles) indicating the generated positions of contents belonging to a cluster corresponding to this cluster map may be displayed in a superimposed fashion. The generated-position marks may be superimposed when, for example, a cluster map is generated by the cluster information generating section 170, or may be superimposed when the display control section 180 displays a cluster map. When marks indicating the generated positions of contents are displayed while being superimposed on a cluster map in this way, in addition to an overview of the corresponding position cluster, the user can easily grasp the distribution of the locations of generation of contents included in the position cluster, and the like.

Also, for example, by using event IDs calculated at the time of event clustering, contents belonging to a position cluster can be classified by event within the position cluster to generate sub-clusters. For example, as for contents generated in an annual theme park event held every year on a huge site, the contents can be classified by year to generate sub-clusters. Accordingly, for example, each generated-position mark superimposed on a cluster map can be displayed in a different manner for each event ID (for example, in a different color). Also, a case can be supposed where there are many overlapping areas. In this case, for example, a circle corresponding to each sub-cluster may be displayed so as to be superimposed on a cluster map. Such a circle corresponding to a sub-cluster can be displayed in a different manner for each event ID, for example, like the generated-position mark. Thus, the distribution of the generated positions of contents generated in different years can be easily grasped.

Also, when displaying pieces of information related to the cluster being displayed, as sub-items related to the cluster map, for example, pieces of attribute information on a sub-cluster basis may be displayed. Such pieces of attribute information on a sub-cluster basis are, for example, the range of the times of generation of contents belonging to a sub-cluster (the start time and the end time), the number of the contents, and the center position and radius of a circle corresponding to the sub-cluster.

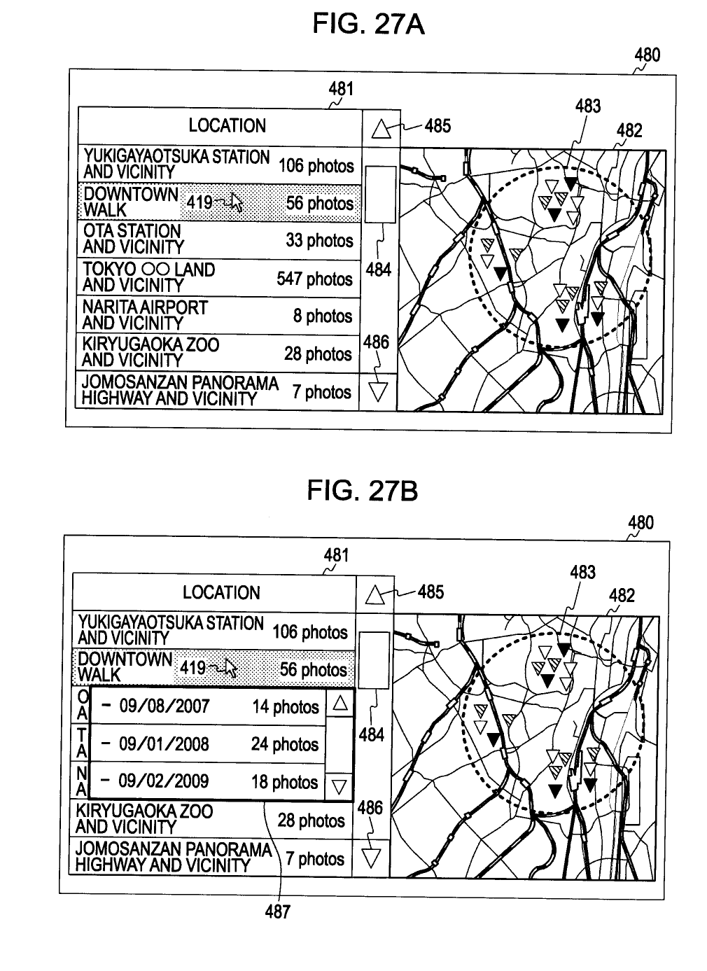

For example, as the pieces of information 418 related to the cluster map 417 displayed when the mouse is placed over the cluster map 417 by a user operation on the index screen 410 shown in FIG. 18, pieces of attribute information on a sub-cluster basis may be displayed. Also, an example of pieces of attribute information displayed on a sub-cluster basis in the case of displaying position clusters in list form is shown in FIG. 27B.

FIGS. 27A and 27B are diagrams each showing an example of display of a cluster map display screen displayed by the display control section 180 according to the first embodiment of the present invention. A cluster map display screen 480 shown in FIG. 27A is a modification of the index screen shown in each of FIGS. 18 and 19. The cluster map display screen 480 is provided with a list display area 481 and a map display area 482.

The list display area 481 is an area in which a listing of the cluster titles of position clusters is displayed. For example, by placing the mouse over a desired cluster title among the cluster titles displayed in the list display area 481, the desired cluster title can be selected. In FIG. 27A, the display area of the cluster title being selected, “Downtown Walk”, is shown in grey. It should be noted that a scroll bar 484, and up and down buttons 485 the 486 can be used to move up and down through the cluster titles displayed in the list display area 481 to thereby display another cluster title.

The map display area 482 is an area for displaying a cluster map corresponding to the cluster title being currently selected from among the listing of the position clusters displayed in the list display area 481. For example, a wide-area map including a cluster map corresponding to the cluster title “Downtown Walk” being selected is displayed, and within this wide-area map, a circle corresponding to the cluster map is displayed by a dotted circle 483. Also, on the wide-area map displayed in the map display area 482, generated-position marks having the shape of an inverted triangle are displayed in a superimposed manner. Each of the generated-position marks is displayed in a different manner for each event ID. For example, for every three event IDs, it is possible to use an inverted triangle with oblique lines drawn inside, an inverted triangle that is painted black inside, and an inverted triangle that is painted white inside. This makes it possible to easily grasp the distribution of generated positions of contents corresponding to different events. While this example is directed to the case in which a wide-area map including a cluster map corresponding to the cluster title being selected is displayed in the map display area 482, it is also possible to display a cluster map corresponding to the cluster title being selected. Also, it is also possible to display a wide-area map of a certain size (for example, a map of the entire Tokyo-prefecture), and display all the position clusters included within this wide-area map.

FIG. 27B shows a sub-cluster attribute information display area 487 that is displayed when a predetermined operation (for example, a mouse-over performed for a predetermined period of time or more) is made on the cluster title “Downtown Walk” being displayed in the list display area 481 shown in FIG. 27A.

The sub-cluster attribute information display area 487 is an area in which, when a predetermined operation is made on the cluster title being displayed in the list display area 481, pieces of attribute information on a sub-cluster basis corresponding to the cluster title are displayed. For example, when a predetermined operation is made on the cluster title “Downtown Walk” being displayed in the list display area 481, pieces of attribute information on a sub-cluster basis corresponding to the cluster title “Downtown Walk” are displayed in the sub-cluster attribute information display area 487. As the pieces of attribute information on a sub-cluster basis, for example, the date and time of contents belonging to a sub-cluster, and the number of the contents are displayed. The example shown in FIG. 27B illustrates a case in which, as the pieces of attribute information on a sub-cluster basis corresponding to the cluster title “Downtown Walk”, pieces of attribute information corresponding to three sub-clusters are displayed. Also, for example, among the pieces of attribute information displayed in the sub-cluster attribute information display area 487, for the piece of attribute information that has been selected, the generated-position mark of the corresponding sub-cluster displayed in the map display area 482 may be changed so as to be displayed in a different manner of display. It should be noted that a scroll bar, and up and down buttons can be used to move up and down through the pieces of attribute information displayed in the sub-cluster attribute information display area 487 to thereby display another piece of attribute information.

For example, when a desired cluster title is selected from among the cluster titles displayed in the list display area 481, contents belonging to a position cluster corresponding to the selected cluster title are sequentially displayed on a content playback screen.

### [Example of Operation of Information Processing Apparatus]

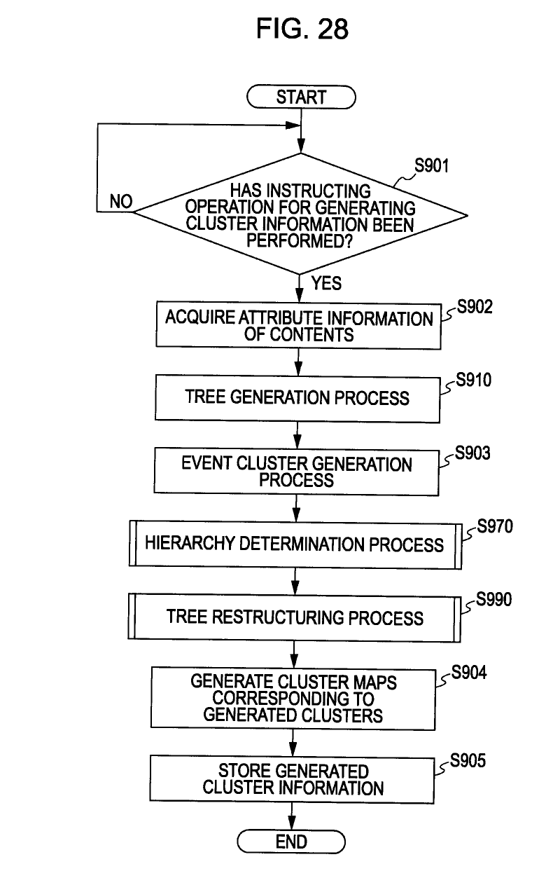

FIG. 28 is a flowchart showing an example of the procedure of a content information generation process by the information processing apparatus 100 according to the first embodiment of the present invention.

First, it is judged whether or not an instructing operation for generating content information has been performed (step S901). If an instruction operation for generating content information has not been performed, monitoring is continuously performed until an instructing operation for generating content information is performed. If an instruction operation for generating content information has been performed (step S901), the attribute information acquiring section 110 acquires attribute information associated with contents stored in the content storing section 210 (step S902).

Subsequently, the tree generating section 120 performs a tree generation process of generating binary tree structured data on the basis of the acquired attribute information (positional information) (step S910). Subsequently, the event cluster generating section 130 generates binary tree structured data on the basis of the acquired attribute information (date and time information), and generates event clusters (clusters based on date and time information) on the basis of this binary tree structured data (step S903).

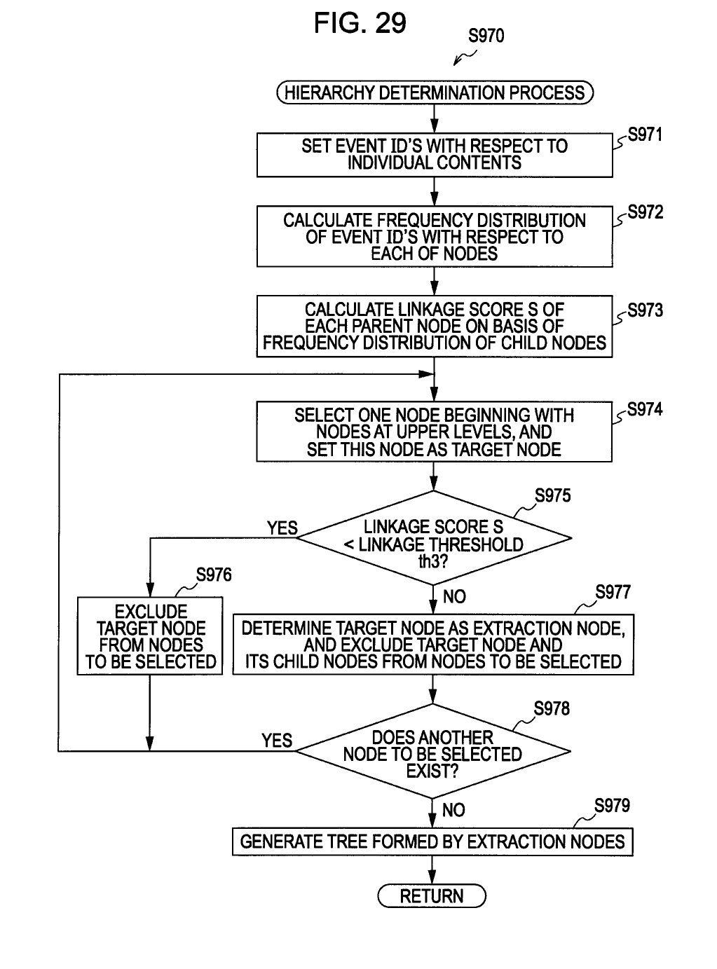

Subsequently, the hierarchy determining section 150 performs a hierarchy determination process of linking and correcting nodes in the binary tree structured data generated by the tree generating section (step S970). This hierarchy determination process will be described later in detail with reference to FIG. 29.

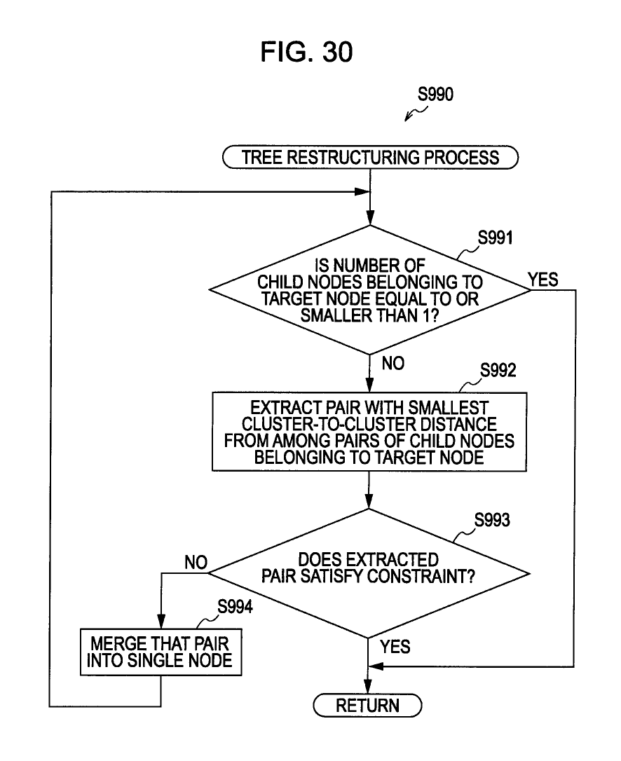

Subsequently, the tree restructuring section 160 performs a tree restructuring process of restructuring the tree generated by the hierarchy determining section 150 to generate clusters (step S990). This tree restructuring process will be described later in detail with reference to FIG. 30.

Subsequently, on the basis of information related to the clusters generated by the tree restructuring section 160, the cluster information generating section 170 generates individual pieces of attribute information related to the clusters (for example, cluster maps and cluster titles) (step S904). Subsequently, the cluster information generating section 170 records information (cluster information) related to the clusters generated by the tree restructuring section 160, and the individual pieces of attribute information related to these clusters, into the cluster information storing section 240 (step S905).

FIG. 29 is a flowchart showing an example of the hierarchy determination process (the procedure in step S970 shown in FIG. 28) of the procedure of the content information generation process by the information processing apparatus 100 according to the first embodiment of the present invention.

First, individual events (event IDs) of the event clusters generated by the event cluster generating section 130 are set (step S971). Subsequently, the hierarchy determining section 150 calculates the frequency distribution of individual contents with the cluster IDs generated by the event cluster generating section 130 taken as classes, with respect to each of nodes in the binary tree structured data generated by the tree generating section 120 (step S972).

Subsequently, the hierarchy determining section 150 calculates a linkage score S with respect to each of the nodes in the binary tree structured data generated by the tree generating section 120 (step S973). This linkage score S is calculated by using, for example, an M-th order vector generated with respect to each of two child nodes belonging to a target node (parent node) for which to calculate the linkage score S.

Subsequently, the hierarchy determining section 150 selects one node from among the nodes in the binary tree structured data generated by the tree generating section 120, and sets this node as a target node (step S974). For example, with each of the nodes in the binary tree structured data generated by the tree generating section 120 as a node to be selected, each node is sequentially selected, beginning with the nodes at upper levels.

Subsequently, the hierarchy determining section 150 compares the calculated linkage score S with the linkage threshold th3, and judges whether or not S<th3 (step S975). If S<th3 (step S975), the corresponding target node is excluded from the nodes to be selected (step S976), and the process returns to step S974. On the other hand, if S≧th3 (step S975), the hierarchy determining section 150 determines the corresponding target node as an extraction node, and excludes the target node and child nodes belonging to this target node from the nodes to be selected (step S977). That is, for the target node determined as an extraction node, since its child nodes are linked together, no comparison process is performed with respect to other lower-level nodes belonging to the extraction node.

Subsequently, it is judged whether or not another node to be selected exists among the nodes in the binary tree structured data generated by the tree generating section 120 (step S978). If there is another node to be selected (step S978), the process returns to step S974, in which one node is selected from the nodes to be selected, and set as a target node. On the other hand, if there is no another node to be selected (step S978), the hierarchy determining section 150 generates a tree with each of determined extraction nodes as a child element (child node) (step S979).

FIG. 30 is a flowchart showing an example of the tree restructuring process (the procedure in step S990 shown in FIG. 28) of the procedure of the content information generation process by the information processing apparatus 100 according to the first embodiment of the present invention.

First, with the root node of the tree generated by the hierarchy determining section 150 as a target node, the tree restructuring section 160 judges whether or not the number of child nodes belonging to this target node is equal to or smaller than 1 (step S991). If the number of child nodes belonging to the target node is equal to or smaller than 1 (step S991), the operation of the tree restructuring process is ended. On the other hand, if the number of child nodes belonging to the target node is equal to or larger than 2 (step S991), the tree restructuring section 160 extracts a pair with the smallest distance from among the child nodes belonging to the target node (step S992).

Subsequently, it is judged whether or not the extracted pair satisfies a specified constraint (step S993). If the extracted pair does not satisfy the specified constraint, the tree restructuring section 160 merges the pair into a single node (step S994). On the other hand, if the extracted pair satisfies the specified constraint (step S993), the operation of the tree restructuring process is ended. While this example is directed to a tree restructuring process with respect to a one-level tree, the same can be applied to the case of performing a tree restructuring process with respect to a multi-level tree (for example, a tree with a binary tree structure). When performing a tree restructuring process with respect to a multi-level tree, if it is determined that the extracted pair satisfies a specified constraint (step S993), each of the nodes of the extracted pair is set as a new target node. Then, with respect to the newly set target node, the above-mentioned tree restructuring process (steps S991 to S994) is repeated.

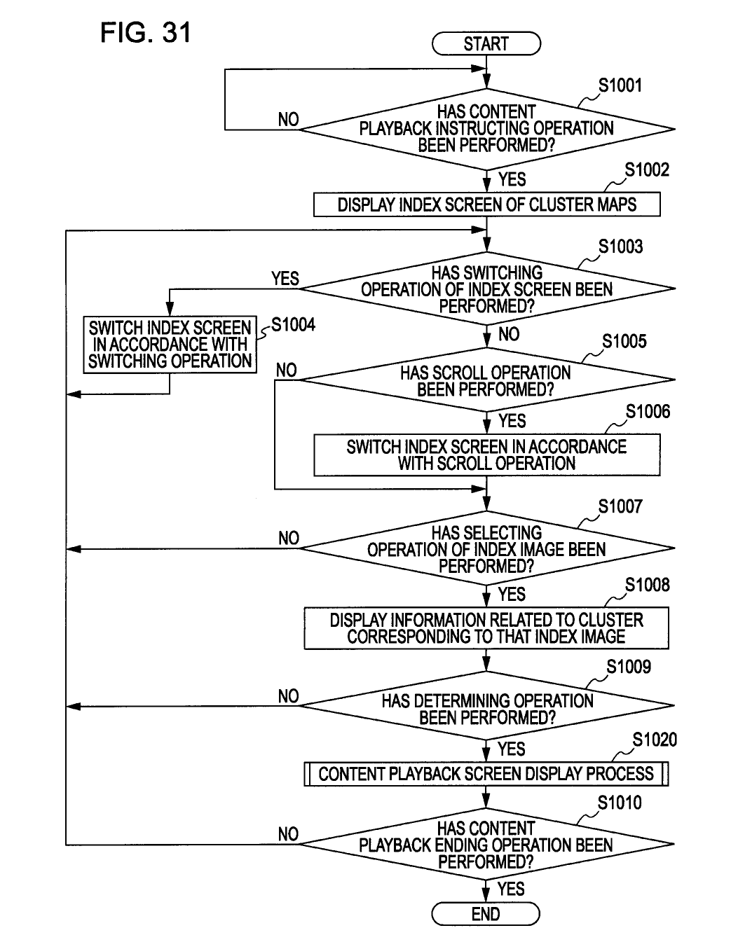

FIG. 31 is a flowchart showing an example of the procedure of a content playback process by the information processing apparatus 100 according to the first embodiment of the present invention.

First, it is judged whether or not a content playback instructing operation for instructing content playback has been performed (step S1001). If a content playback instructing operation has not been performed, monitoring is continuously performed until a content playback instructing operation is performed. If a content playback instructing operation has been performed (step S1001), an index screen that displays a listing of cluster maps is displayed (step S1002). Subsequently, it is judged whether or not a switching operation of the index screen has been performed (step S1003). If a switching operation of the index screen has been performed (step S1003), the index screen is switched in accordance with the switching operation (step S1004), and the process returns to step S1003.

If a switching operation of the index screen has not been performed (step S1003), it is judged whether or not a scroll operation has been performed (step S1005). If a scroll operation has been performed (step S1005), display of the index screen is switched in accordance with the scroll operation (step S1006). If a scroll operation has not been performed (step S1005), the process proceeds to step S1007.

If display of the index screen has been switched in accordance with the scroll operation (step S1006), it is judge whether or not a selecting operation (for example, a mouse-over) of selecting any one of index images has been performed (step S1007). If the selecting operation has been performed (step S1007), pieces of information related to a cluster corresponding to the index image on which the selecting operation has been performed are displayed (step S1008). If the selecting operation has not been performed (step S1007), the process returns to step S1003.

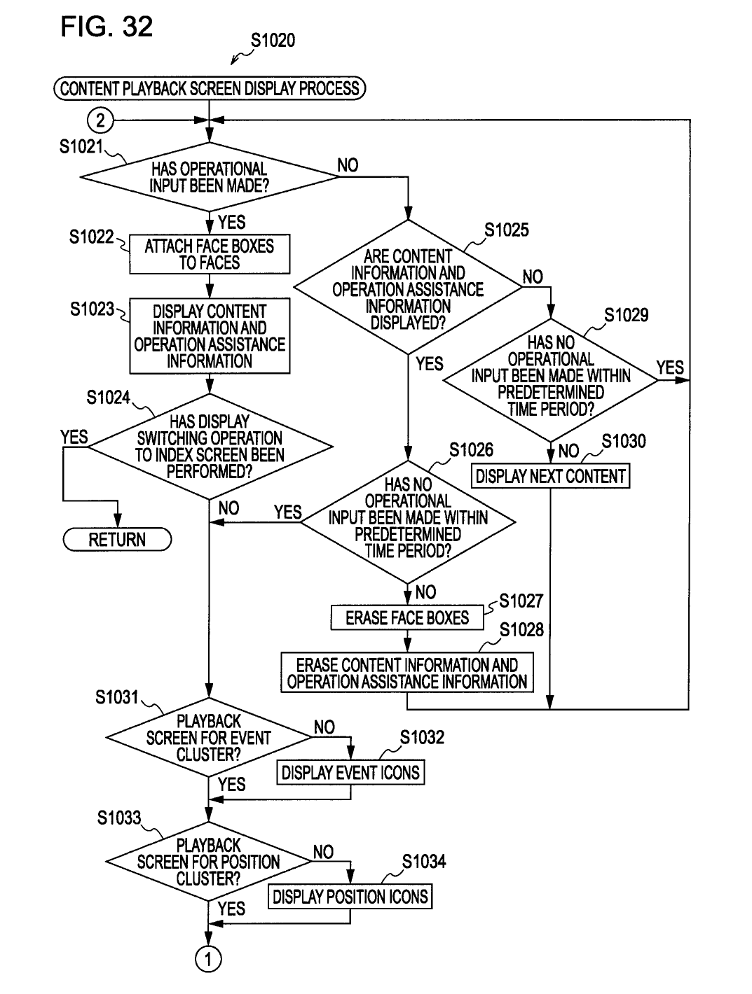

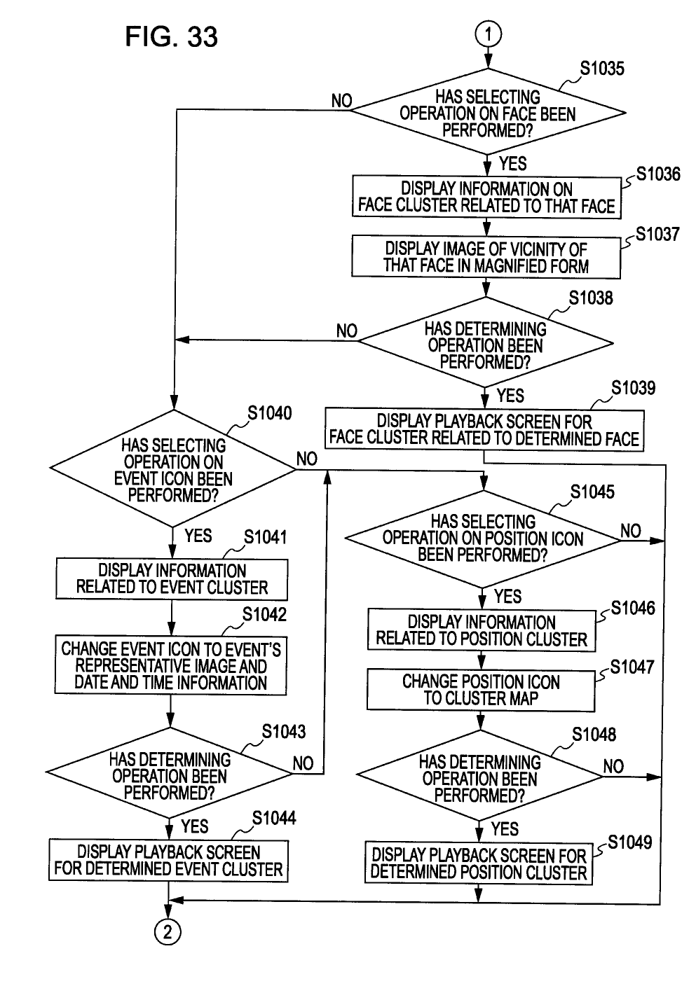

Subsequently, it is judged whether or not a determining operation has been performed on the index image on which the selecting operation has been performed (step S1009). If the determining operation has been performed (step S1009), a content playback screen display process is performed (step S1020). This content playback screen display process will be described later in detail with reference to FIGS. 32 and 33. If the determining operation has not been performed (step S1009), the process returns to step S1003.

Subsequently, after the content playback screen display process is performed (step S1020), it is judged whether or not a content playback ending operation for instructing the end of content playback has been performed (step S1010). If the content playback ending operation has not been performed, the process returns to step S1003. On the other hand, if the content playback ending operation has been performed (step S1010), the operation of the content playback process is ended.

FIGS. 32 and 33 are each a flowchart showing an example of the content playback screen display process (the procedure in step S1020 shown in FIG. 31) of the procedure of the content playback process by the information processing apparatus 100 according to the first embodiment of the present invention.

First, it is judged whether or not an operational input (for example, a mouse operation) has been made (step S1021). If an operational input has been made (step S1021), face boxes are attached to faces included in the content displayed on the content playback screen (step S1022), and content information and operation assistance information are displayed (step S1023). It should be noted that no face box is displayed if there is no face included in the content displayed on the content playback screen.

Subsequently, it is determined whether or not a display switching operation to an index screen has been performed (step S1024). If the display switching operation to an index screen has been performed (step S1024), the operation of the content playback screen display process is ended. If the display switching operation to an index screen has not been performed (step S1024), the process proceeds to step S1031.

Also, if an operational input has not been made (step S1021), it is judged whether or not content information and operation assistance information are displayed (step S1025). If content information and operation assistance information are displayed (step S1025), it is judged whether or not no operational input has been made within a predetermined period of time (step S1026), and if an operational input has been made within a predetermined period of time, the process proceeds to step S1031. On the other hand, if no operational input has been made within a predetermined period of time (step S1026), the displayed face boxes are erased (step S1027), the displayed content information and operation assistance information are erased (step S1028), and the process returns to step S1021.

Also, if content information and operation assistance information are not displayed (step S1025), it is judged whether or not no operational input has been made within a predetermined period of time (step S1029). If no operational input has been made within a predetermined period of time (step S1029), the next content is displayed (step S1030). That is, a slide display is performed. On the other hand, if an operational input has been made within a predetermined period of time (step S1029), the process returns to step S1021.

Subsequently, it is judged whether or not a content playback screen for event cluster is displayed (step S1031), and if the content playback screen of event cluster is not displayed, event icons are displayed (step S1032). Also, it is judged whether or not a content playback screen for position cluster is displayed (step S1033), and if the content playback screen for position cluster is not displayed, position icons are displayed (step S1034).

Subsequently, it is judged whether or not a selecting operation (for example, a mouse-over) on a face has been performed (step S1035). If the selecting operation on a face has not been performed, the process proceeds to step S1040. On the other hand, if the selecting operation on a face has been performed (step S1035), information related to a face cluster related to the face on which the selecting operation has been performed (for example, a listing of the thumbnail images of contents belonging to the face cluster) is displayed (step S1036). Subsequently, the image of the vicinity of the face on which the selecting operation has been performed is displayed in magnified form (step S1037). Subsequently, it is judged whether or not a determining operation (for example, a mouse click operation) on the face has been performed (step S1038). If the determining operation has not been performed, the process proceeds to step S1040. On the other hand, if the determining operation on the face has been performed (step S1038), a content playback screen for the face cluster to which the face on which the determining operation has been performed belongs is displayed (step S1039).

Subsequently, it is judged whether or not a selecting operation (for example, a mouse-over) on an event icon has been performed (step S1040). If the selecting operation on an event icon has not been performed, the process proceeds to step S1045. On the other hand, if the selecting operation on an event icon has been performed (step S1040), information related to an event cluster to which the content being currently displayed belongs is displayed (step S1041). As this information related to the event cluster, for example, a listing of the thumbnail images of contents belonging to the event cluster is displayed. Subsequently, the manner of display of the event icon is changed (step S1042). For example, information related to the event cluster to which the content being currently displayed belongs (for example, the representative image and date and time information of the event cluster) is displayed. Subsequently, it is judged whether or not a determining operation (for example, a mouse click operation) on the event icon has been performed (step S1043). If the determining operation has not been performed, the process proceeds to step S1045. On the other hand, if the determining operation on the event icon has been performed (step S1043), a content playback screen for the event cluster to which the content being currently displayed belongs is displayed (step S1044).

Subsequently, it is judged whether or not a selecting operation (for example, a mouse-over) on a position icon has been performed (step S1045). If the selecting operation on a position icon has not been performed, the process returns to step S1021. On the other hand, if the selecting operation on a position icon has been performed (step S1045), information related to a position cluster to which the content being currently displayed belongs (for example, a listing of the thumbnail images of contents belonging to the position cluster) is displayed (step S1046). Subsequently, the manner of display of the position icon is changed (step S1047). For example, information related to the position cluster to which the content being currently displayed belongs (for example, the cluster map of the position cluster) is displayed. Subsequently, it is judged whether or not a determining operation (for example, a mouse click operation) on the position icon has been performed (step S1048). If the determining operation has not been performed, the process returns to step S1021. On the other hand, if the determining operation on the position icon has been performed (step S1048), a content playback screen for the position cluster to which the content being currently displayed belongs is displayed (step S1049), and the process returns to step S1021.

### 2. Second Embodiment

The first embodiment of the present invention is directed to the case of displaying a listing of cluster maps or the case of displaying cluster maps together with contents. In this regard, for example, in the case when a listing of cluster maps having the same size is displayed in a matrix fashion, there is a fear that it may not be possible to intuitively grasp the geographical correspondence between the cluster maps. Also, for example, in the case when cluster maps are displayed so as to be placed at their corresponding positions on a map, there is a fear that not all the cluster maps can be displayed unless a map of an area corresponding to the cluster maps is displayed. Accordingly, for example, it is conceivable to display a world map so that it is possible to get a bird's eye view of the entire world. Although all cluster maps can be displayed when a world map is displayed in this way, in a region where cluster maps are concentrated, there is a fear that the cluster maps overlap each other, and thus it is not possible to display some cluster maps. Accordingly, in a second embodiment of the present invention, by taking the geographical correspondence between cluster maps into consideration, the cluster maps are displayed while being placed in such a way that the geographical correspondence between the cluster maps can be grasped intuitively.

### [Example of Configuration of Information Processing Apparatus]

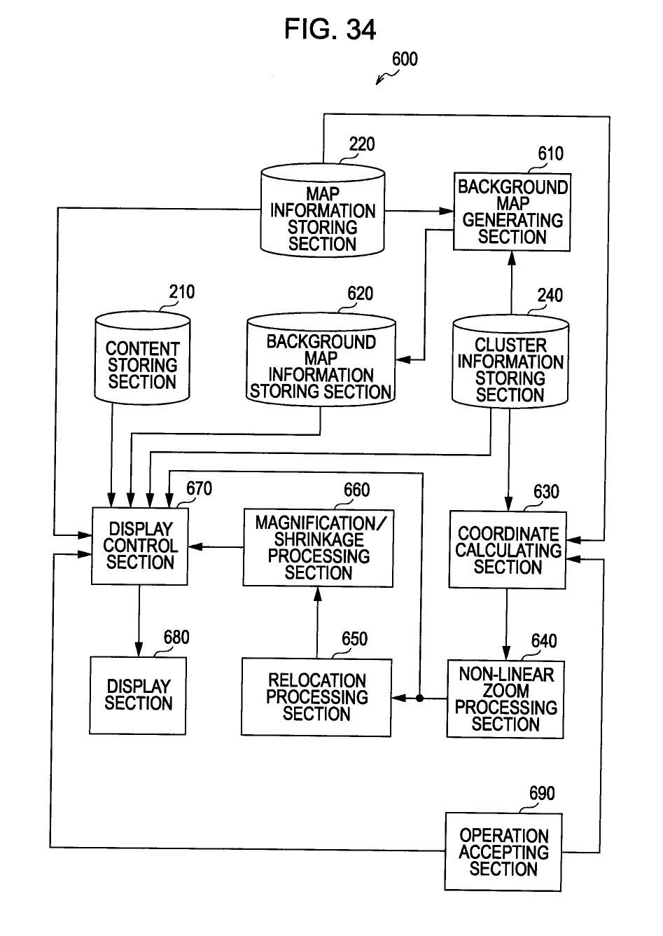

FIG. 34 is a block diagram showing an example of the functional configuration of an information processing apparatus 600 according to the second embodiment of the present invention. The information processing apparatus 600 includes the content storing section 210, the map information storing section 220, and the cluster information storing section 240. In addition, the information processing apparatus 600 includes a background map generating section 610, a background map information storing section 620, a coordinate calculating section 630, a non-linear zoom processing section 640, a relocation processing section 650, a magnification/shrinkage processing section 660, a display control section 670, and a display section 680. The information processing apparatus 600 can be realized by, for example, an information processing apparatus such as a personal computer capable of managing contents such as image files recorded by an image capturing apparatus such as a digital still camera. It should be noted that since the content storing section 210, the map information storing section 220, and the cluster information storing section 240 are substantially the same as those described above in the first embodiment of the present invention, these components are denoted by the same reference numerals, and their description is omitted. Also, it is assumed that cluster information generated by the cluster information generating section 170 shown in FIG. 1 is stored in the cluster information string section 240.

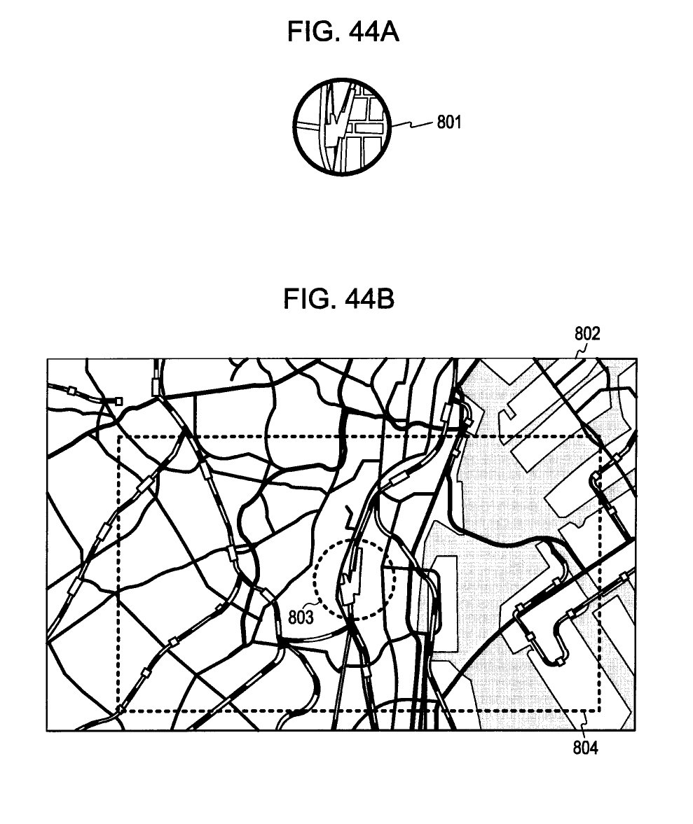

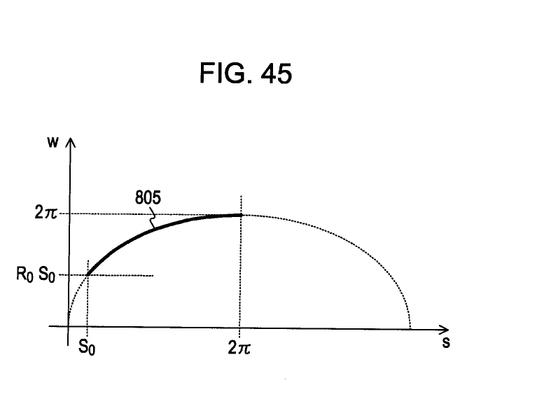

The background map generating section 610 generates a background map (cluster wide-area map) corresponding to each cluster on the basis of cluster information stored in the cluster information storing section 240, and stores the generated background map into the background map information storing section 620 in association with each cluster. Specifically, on the basis of the cluster information stored in the cluster information storing section 240, the background map generating section 610 acquires map information from the map information storing section 220, and generates a background map corresponding to the cluster information on the basis of this acquired map information. It should be noted that the method of generating a background map will be described later in detail with reference to FIGS. 44 and 45.

The background map information storing section 620 stores the background map generated by the background map generating section 610 in associated with each cluster, and supplies the stored background map to the display control section 670.

The coordinate calculating section 630 calculates the coordinates of the center positions of cluster maps on a display screen in accordance with an alteration input accepted by an operation accepting section 690, on the basis of cluster information stored in the cluster information storing section 240. Then, the coordinate calculating section 630 outputs the calculated coordinates to the non-linear zoom processing section 640.

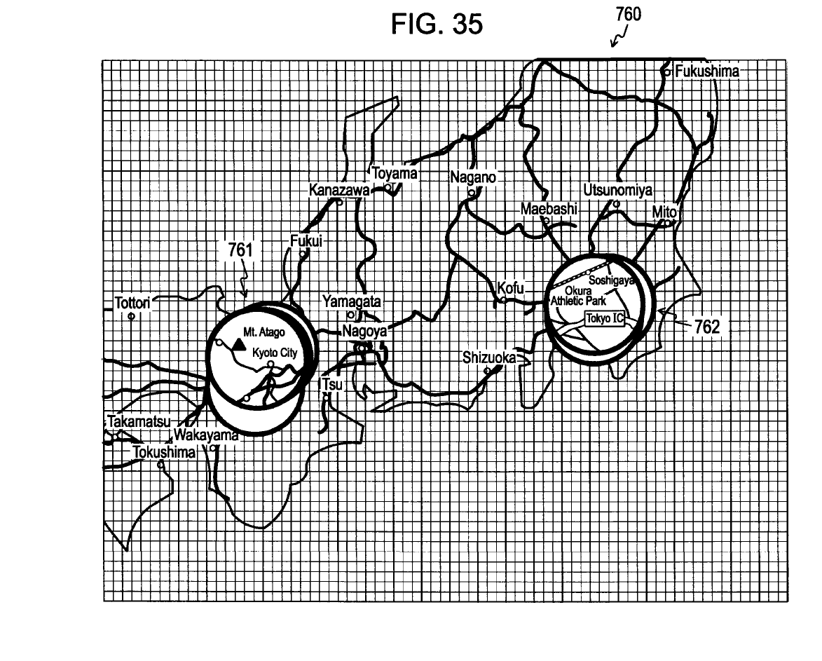

The non-linear zoom processing section 640 performs coordinate transformation on the coordinates outputted from the coordinate calculating section 630 (the coordinates of the center positions of cluster maps on the display screen) by a non-linear zoom process, and outputs the transformed coordinates to the relocation processing section 650 or the display control section 670. This non-linear zoom process is a process which performs coordinate transformation so that the coordinates of the center positions of cluster maps associated with a highly concentrated region are scattered apart from each other. This non-linear zoom process will be described later in detail with reference to FIGS. 35 to 40. It should be noted that the non-linear zoom processing section 640 is an example of each of a transformed-coordinate calculating section and a coordinate setting section described in the claims.

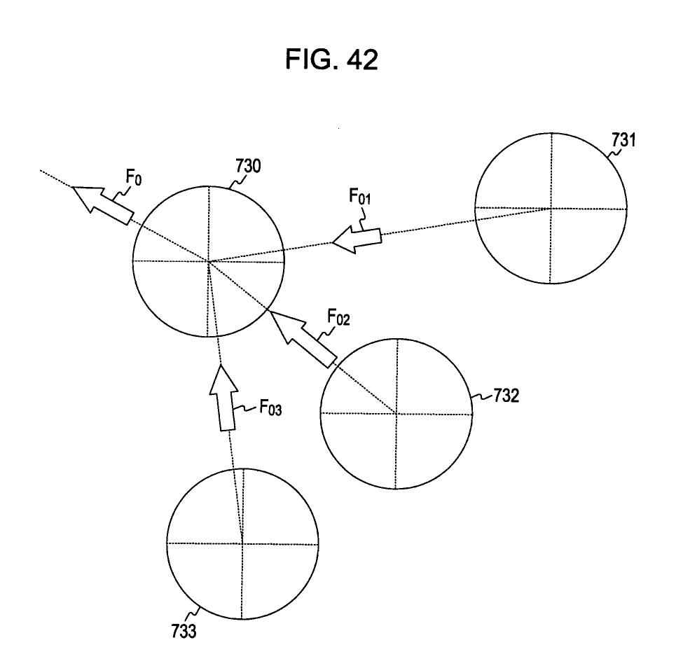

The relocation processing section 650 performs coordinate transformation by a force-directed relocation process on the coordinates outputted from the non-linear zoom processing section 640, on the basis of the distances between individual coordinates, the size of the display screen on the display section 680, and the number of cluster maps to be displayed. Then, the relocation processing section 650 outputs the transformed coordinates to the magnification/shrinkage processing section 660. This force-directed relocation process will be described later in detail with reference to FIG. 42. It should be noted that the relocation processing section 650 is an example of a second transformed-coordinate calculating section described in the claims.

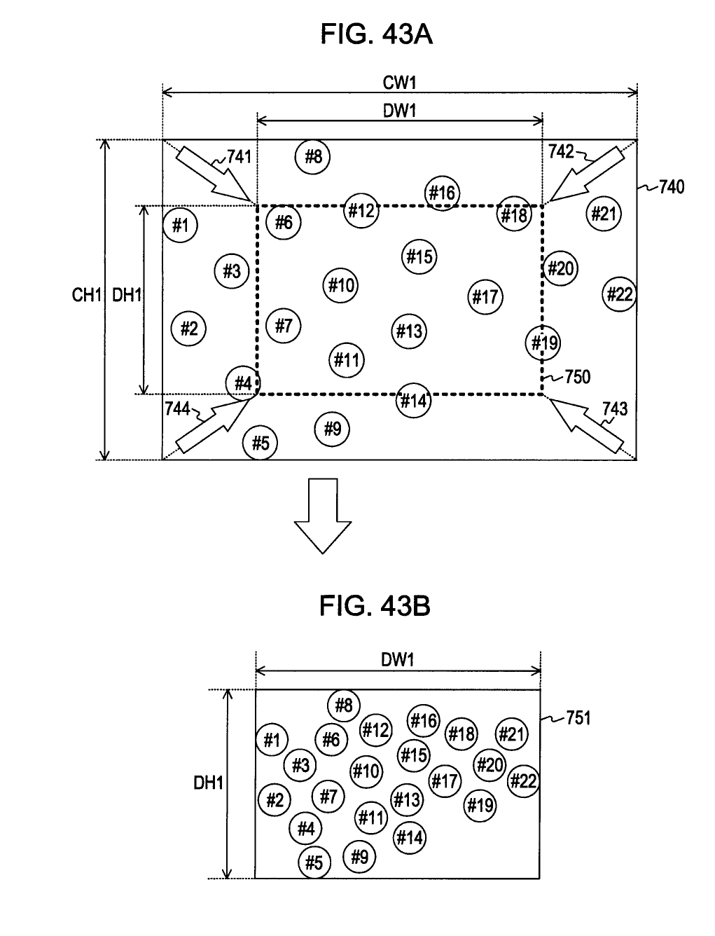

The magnification/shrinkage processing section 660 performs coordinate transformation by magnification or shrinking, on the coordinates outputted from the relocation processing section 650, on the basis of the size of an area subject to coordinate transformation by the relocation process, and the size of the display screen on the display section 680. Then, the magnification/shrinkage processing section 660 outputs the transformed coordinates to the display control section 670. This magnification/shrinkage process will be described later in detail with reference to FIGS. 43A and 43B.

Each of the coordinate transformations by the non-linear zoom processing section 640, the relocation processing section 650, and the magnification/shrinkage processing section 660 is a coordinate transformation with respect to the center positions of cluster maps. Therefore, in these coordinate transformations, the cluster maps themselves do not undergo deformation (for example, magnification/shrinkage of their circular shape, or deformation from a circle to an ellipse).

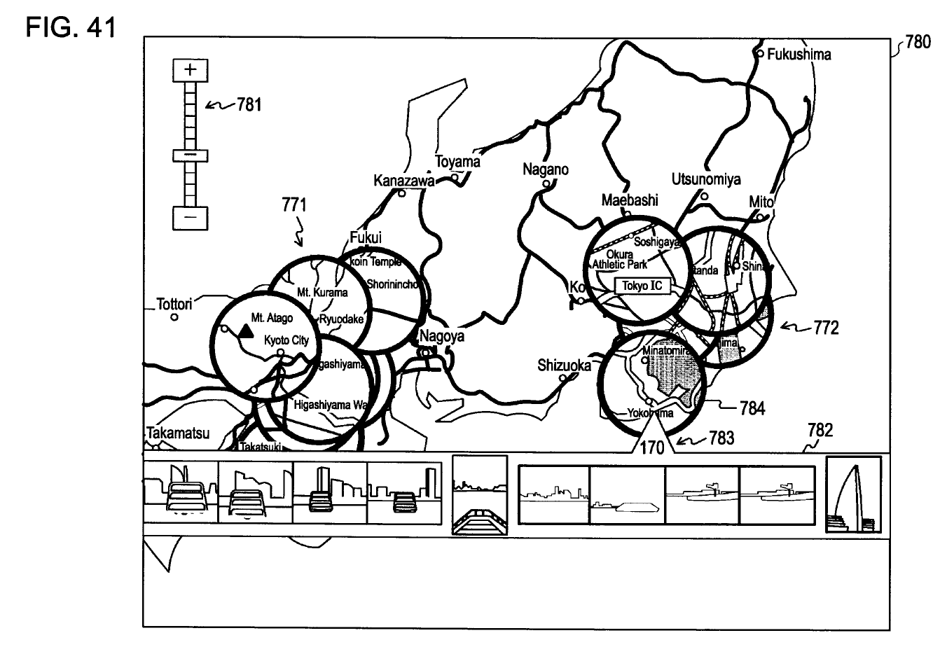

The display control section 670 displays various kinds of image on the display section 680 in accordance with an operational input accepted by the operation accepting section 690. For example, in accordance with an operational input accepted by the operation accepting section 690, the display control section 670 displays on the display section 680 cluster information (for example, a listing of cluster maps) stored in the cluster information storing section 240. When a predetermined user operation is performed in the state with a listing of cluster maps displayed on the display section 680, the display control section 670 displays a background map (cluster wide-area map) stored in the background map information storing section 620 on the display section 680. Also, in accordance with an operational input accepted by the operation accepting section 690, the display control section 670 displays contents stored in the content storing section 210 on the display section 680. These examples of display will be described later in detail with reference to FIGS. 41, 46 to 48B, and 50.

The display section 680 is a display section that displays various kinds of image on the basis of control by the display control section 670.

The operation accepting section 690 is an operation accepting section that accepts an operational input from the user, and outputs information on an operation corresponding to the accepted operational input to the coordinate calculating section 630 and the display control section 670.

[Example of Display in which Cluster Maps are Superimposed on Generated Positions of Contents]

FIG. 35 is a diagram schematically showing a case in which cluster maps to be coordinate-transformed by the non-linear zoom processing section 640 are placed on coordinates according to the second embodiment of the present invention. FIG. 35 illustrates a case in which, with a map 760 being a map at a scale allowing regions including Tokyo and Kyoto to be displayed on the display section 680, cluster maps stored in the cluster information storing section 240 are displayed at corresponding positions in the map 760. Also, in this example, a case is supposed where contents are generated by the user intensively in the neighborhood of Tokyo and in the neighborhood of Kyoto, and a plurality of clusters are generated for these contents. It should be noted that coordinates (grid-like points (points where two dotted lines intersect)) in the map 760 are schematically indicated by grad-like straight lines in the map 760. It should be noted that for the ease of explanation, these coordinates are depicted in a simplified fashion with a relatively large interval between the coordinates. The same also applies to grid-like straight lines in each of the drawings described below. When clusters are generated in this way, clusters whose center positions are located within relatively narrow ranges in Tokyo and Kyoto are generated. In this case, it is supposed that for example, as shown in FIG. 35, when displaying cluster maps at the corresponding positions in the map 760, the generated cluster maps are displayed in an overlaid manner. Specifically, in FIG. 35, there are shown a cluster map group 761 indicating a set of cluster maps related to contents generated in Kyoto, and a cluster map group 762 indicating a set of cluster maps related to contents generated in Tokyo.

In the case when the scale of the background map is set relatively large in this way, it is supposed that the cluster maps overlap each other, making it difficult to grasp individual cluster maps in regions where the cluster maps are densely concentrated. Accordingly, for example, it is also conceivable to display individual cluster maps in a smaller size. However, it is necessary for cluster maps to be somewhat large for the user to recognize these cluster maps. That is, if cluster maps are reduced in size, it is supposed that the cluster maps become hard to see, making it difficult to grasp the details of the cluster maps.

Accordingly, the second embodiment of the present invention is directed to optimal placement of individual cluster maps on a map which makes it possible to avoid overlapping of cluster maps in regions where the cluster maps are densely concentrated, without changing the size of the cluster maps. When placing the cluster maps in this way, the placement is performed in accordance with the following placement criteria (1) to (3).

(1) For cluster maps overlapping each other on the background map, their center positions are to be spaced apart by some interval.

(2) The positional relationship between cluster maps is to be maintained. This positional relationship includes, for example, the distances between the cluster maps, and their orientations.

(3) When cluster maps overlap each other, the order (precedence) in which individual cluster maps are overlaid at the upper side are determined in accordance with a predetermined condition.

As the predetermined condition mentioned in (3) above, for example, it is possible to adopt such a condition that the larger the number of contents belonging to a cluster, the higher the precedence. That is, the cluster map of the cluster to which the largest number of contents belong is assigned the first precedence. Also, as the predetermined condition, for example, it is possible to use a condition such as the relative size of a cluster, the relative number of events (the number of times of visit) corresponding to contents belonging to a cluster, or the frequency of the number of times a cluster is browsed. Such a predetermined condition can be set by a user operation. Thus, cluster maps with higher precedence can be overlaid at the upper side, and it is possible to prevent part of the cluster maps with higher precedence from being hidden, and quickly grasp their details.

In this regard, a cluster map is a map related to a location where contents belonging to the corresponding cluster are generated. Therefore, even when latitudes and longitudes on a background map do not completely match latitudes and longitudes on cluster maps, it is possible to grasp the geographical relationship between individual cluster maps. As described above, although it is not necessary to match latitudes and longitudes on a background map with latitudes and longitudes on cluster maps, if the cluster maps are spaced too far apart, it may become no longer possible to recognize where on the background map the cluster maps correspond to in the first place. Accordingly, it is important to minimize overlaps while still allowing the geographical correspondence to be recognized.

Here, the second embodiment of the present invention is directed to a case in which in order to satisfy the criteria (1) and (2) mentioned above, on a map with a scale specified by a user operation, the coordinates of the center positions of cluster maps associated with a highly concentrated region are transformed. For example, in the related art, there exists a fisheye coordinate transformation method for displaying coordinates within a predetermined area around a focus area in magnified view in the manner of a fisheye lens. For example, a fisheye coordinate transformation method (“Graphical Fisheye Views of Graphs”, Manojit Sarkar and Marc H. Brown, Mar. 17, 1992) has been proposed. The second embodiment of the present invention is directed to a case in which this fisheye coordinate transformation method is applied to a scattering technique for a concentrated region. Specifically, a description will be given of a case in which the placement positions of individual cluster maps on a map which satisfy the criteria (1) and (2) mentioned above are determined by a non-linear zoom process to which the fisheye coordinate transformation method is applied.

For example, suppose a case in which when marks (for example, cluster maps) having a predetermined surface area are displayed in an overlaid manner within a background image (for example, a background map), the fisheye coordinate transformation method alone is applied independently with respect to each such mark. In this case, the background map covering a predetermined range around a focus area of the mark (for example, the center position of the mark) is magnified. However, since the entire mark also undergoes coordinate transformation simultaneously with this magnification, areas close to the focus area of the mark are magnified, whereas areas far from the focus area are shrunk. In this way, when the fisheye coordinate transformation method alone is applied independently, the background image covering a predetermined range around the focus area is magnified, and also the entire mark undergoes coordinate transformation, with the result that the mark itself is distorted. In contrast, in the second embodiment of the present invention, coordinate transformation is performed only with respect to the focus area of a mark (for example, the center position of the mark), thereby making it possible to appropriately scatter individual marks in accordance with distances from the focus area, without deforming (magnifying/shrinking) the background image and the marks.

### [Example of Display Transition by Fisheye Coordinate Transformation]

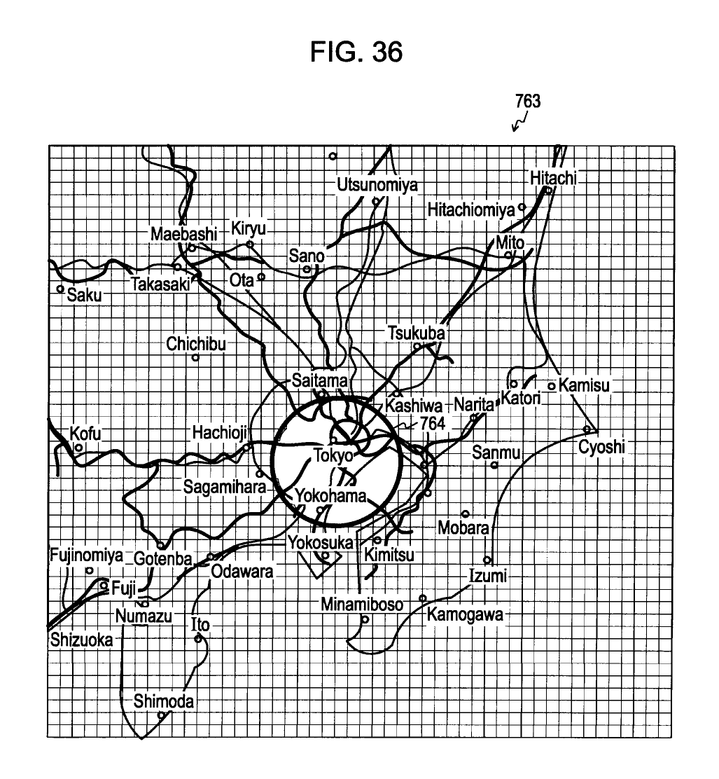

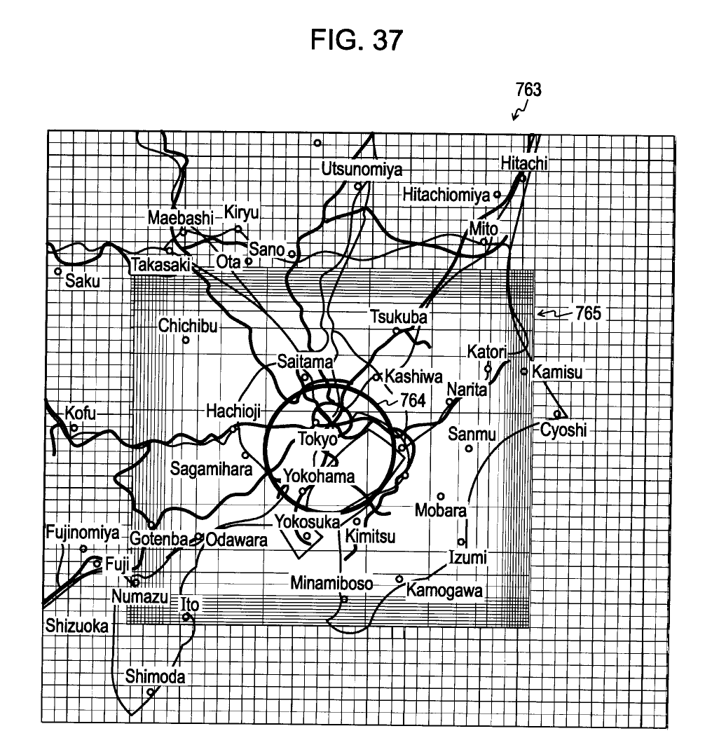

FIGS. 36 and 37 are diagrams each schematically showing the relationship between a background map and a cluster map displayed on the display section 680 according to the second embodiment of the present invention. This example schematically illustrates the relationship between a background map and a cluster map in the case when the cluster map is displayed in an overlaid manner at its corresponding position on the background map.

FIG. 36 shows a case in which a circle 764 representing the size of a cluster map is overlaid on a map 763 of the Kanto region centered about Tokyo. This cluster map is a map corresponding to a cluster to which a plurality of contents generated in the neighborhood of Tokyo belong.

FIG. 37 shows a case in which by applying the fisheye coordinate transformation method described above, coordinates are distorted with the center of the cluster map 764 as a focus, with respect to points arranged in a grid shown in FIG. 36. That is, a case is illustrated in which with the center position of the cluster map 764 as a focus, coordinates around the center position of the cluster map 764 (coordinates within a transformation target area 765 indicated by a rectangle) are distorted.

This fisheye coordinate transformation method is a coordinate transformation method which performs coordinate transformation in such a way that the rate of distortion of coordinates becomes greater with increasing proximity to the focus. Also, the coordinates of the cluster map 764 itself do not change because the center position of the cluster map 764 is taken as the focus. In the following, a description will be given in detail of a non-linear zoom process which performs coordinate transformation through application of this fisheye coordinate transformation method.

### [Example of Non-Linear Zoom Process]

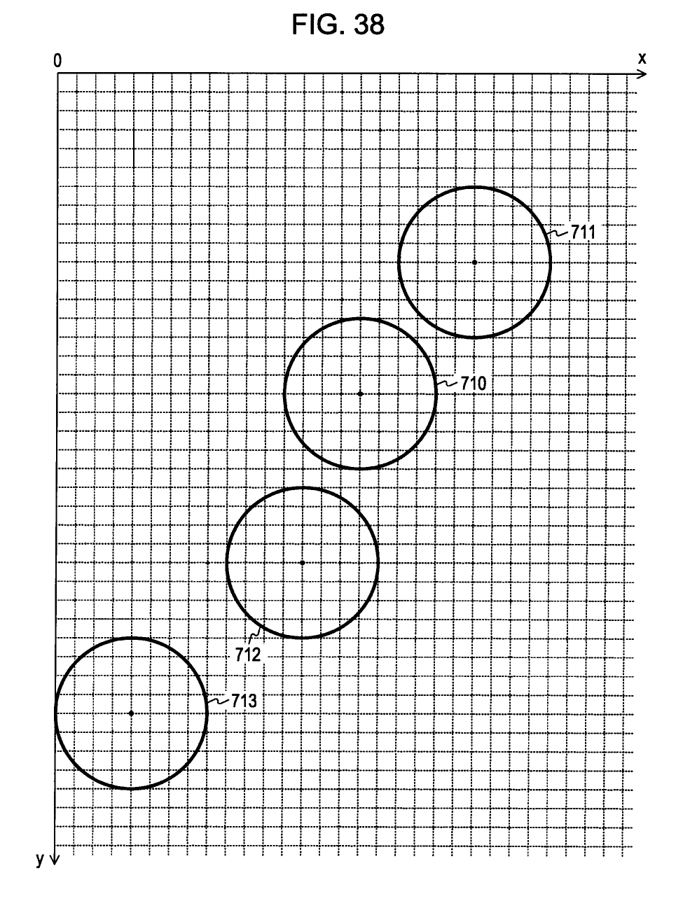

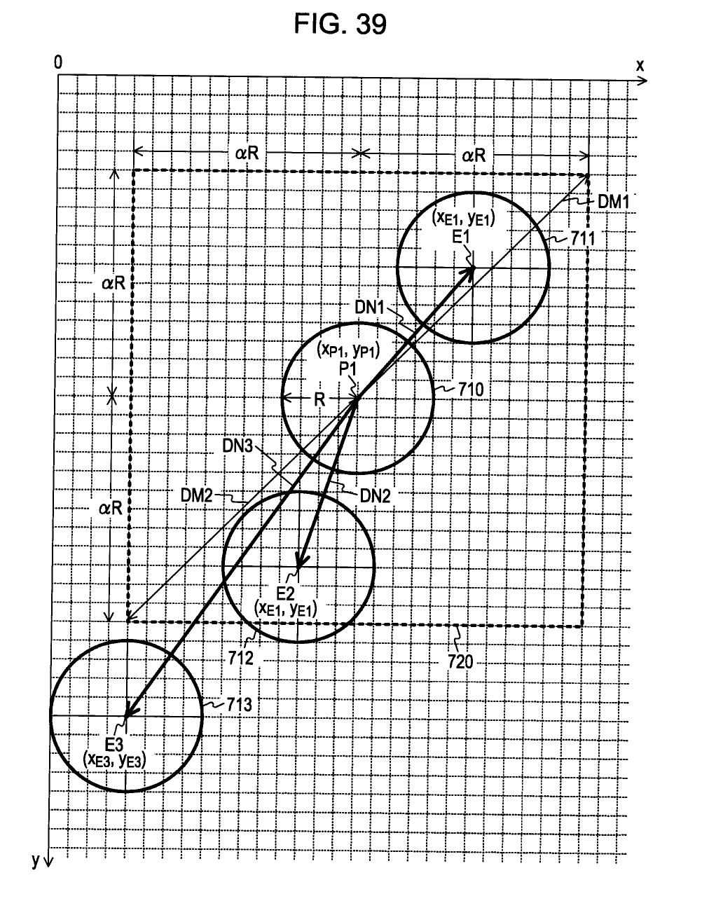

FIG. 38 is a diagram schematically showing a case in which cluster maps subject to a non-linear zoom process by the non-linear zoom processing section 640 are placed on coordinates according to the second embodiment of the present invention. In the example shown in FIG. 38, the upper left corner on the background map to be displayed on the display section 680 is taken as an origin, the horizontal direction is taken along the x-axis, and the vertical direction is taken along the y-axis. It should be noted that for the ease of explanation, grid-like points (points where two dotted lines intersect) on the xy coordinates each indicate a coordinate transformation by a non-linear zoom process in a simplified manner. Also, this example will be described while supposing that the center positions of cluster maps 711 to 714 are placed at the grid-like points. It should be noted that in FIGS. 38 and 39, as the cluster maps 711 to 714, only circles corresponding to these cluster maps are schematically shown.

FIG. 39 is a diagram schematically showing a coordinate transformation process by the non-linear zoom processing section 640 according to the second embodiment of the present invention. In the example shown in FIG. 39, arrows and the like indicating a transformation target area and the relationship between cluster maps are added to the xy coordinates shown in FIG. 38. Also, the example shown in FIG. 39 illustrates a coordinate transformation method for each cluster map in the case where the center position of the cluster map 710 is taken as a focus P1(x_{P1}, y_{P1}), and an area within a predetermined range from this focus is taken as a transformation target area 720.

Here, the transformation target area 720 is a square whose center is located at the focus and which has a side equal to 2α times the radius r of each cluster map. For example, α can be set as α=3. Also, let a parameter d be a parameter that determines the extent to which the transformation target area 720 is stretched. For example, the larger the value of the parameter d, the greater the degree of stretching. For example, the parameter d can be set as d=1.5.

Here, let the vector from the focus P1 to a point as a transformation target (transformation target point) Ei(x_{Ei}, y_{Ei}) be DNi(x_{DNi}, y_{DNi}). Also, let the vector determined in accordance with the position of the transformation target point Ei(x_{Ei}, y_{Ei}) (vector from the focus P1 to the boundary of the transformation target area 720) be DMi(x_{DMi}, y_{DMi}). Here, in FIG. 39, if the transformation target point Ei is located to the upper right with reference to the focus P1, a vector pointing toward the upper right vertex of the boundary of the transformation target area 720 from the focus P1 is taken as DMi (for example, DM1 shown in FIG. 39). Also, if the transformation target point Ei is located to the lower right with reference to the focus P1, a vector pointing toward the lower right vertex of the boundary of the transformation target area 720 from the focus P1 is taken as DMi. Further, if the transformation target point Ei is located to the upper left with reference to the focus P1, a vector pointing toward the upper left vertex of the boundary of the transformation target area 720 from the focus P1 is taken as DMi. Also, if the transformation target point Ei is located to the lower left with reference to the focus P1, a vector pointing toward the lower left vertex of the boundary of the transformation target area 720 from the focus P1 is taken as DMi (for example, DM2 shown in FIG. 39). It should be noted that in the example shown in FIG. 39, the cluster maps 711 to 713 are targets for which to compute transformed coordinates with respect to the focus P1.

Here, g(x)=(d+1)x/(dx+1). In this equation, x denotes a variable. In this case, coordinates PE(x_{PE}, y_{PE}) obtained after applying coordinate transformation using the fisheye coordinate transformation method to the transformation target point Ei with respect to the focus P1 can be found by equation (11) below.

PE(x_{PE},y_{PE})=(g(x_{DNi}/x_{DMi})x_{DMi}+x_{P1},g(y_{DNi}/y_{DMi})y_{DMi}+y_{P1}) (11)

In this way, by using the fisheye coordinate transformation method described above, the coordinates of the points arranged in a grid as shown in FIG. 36 can be distorted as shown in FIG. 37 with the cluster map 764 taken as the center.

In the case where a plurality of cluster maps exist in the transformation target area as shown in FIGS. 38 and 39, a transformation based on each of these cluster maps affects the other cluster maps. That is, coordinate transformations based on a plurality of cluster maps affect each other.

For this reason, in the second embodiment of the present invention, in the case when the center coordinates of a given cluster map are taken as a focus, the coordinates obtained after coordinate transformations of the other cluster maps that exist in the transformation target area with respect to this focus are calculated for each of cluster maps. Then, by using the coordinates calculated for each of cluster maps, the coordinates of each individual cluster map are calculated anew.

Specifically, the non-linear zoom processing section 640 selects a cluster map i (0≦i≦N−1: N is the number of cluster maps). Then, with the center coordinates of the cluster map i taken as a focus, the non-linear zoom processing section 640 calculates coordinates PEij with respect to another cluster map j (i≠j, and 0≦j≦N−1: N is the number of cluster maps) by using equation (11). Here, as for the coordinates PEij, only the coordinates PEij for another cluster map j that exists in the transformation target area with respect to the focus (the center coordinates of the cluster map i) are calculated. That is, the coordinates PEij for the cluster map j that does not exist within the transformation target area are not calculated. In this way, the coordinates PEij are sequentially calculated by using equation (11) with respect to N cluster maps.

Subsequently, when calculation of the coordinates PEij with respect to the N cluster maps is finished, the non-linear zoom processing section 640 calculates the mean of the individual coordinates PEij, as transformed coordinates with respect to the cluster map i. Specifically, the non-linear zoom processing section 640 calculates the mean value of the individual coordinates PEij (i≠j, and 0≦j≦N−1: N is the number of cluster maps). Then, the non-linear zoom processing section 640 sets the calculated mean value as the transformed coordinates of the cluster map i.

For example, in the example shown in FIG. 39, the cluster map 710 is selected as the cluster map i (i=0). Then, with the center coordinates of the cluster map 710 taken as a focus, the respective coordinates PE01 and PE02 of the cluster maps 711 and 712 (j=1 to 3) with respect to the cluster map 710 are calculated by using equation (11). It should be noted that since the center coordinates of the cluster map 713 do not exist within the transformation target area 720, its coordinates PE03 are not calculated. Likewise, the cluster map 711 is selected as the cluster map i (i=0). Then, with the center coordinates of the cluster map 711 taken as a focus, the coordinates PE10 of the cluster map 710 (j=0, 2, 3) with respect to the cluster map 711 are calculated by using equation (11). It should be noted that since the center coordinates of the cluster maps 712 and 713 do not exist within the transformation target area with respect to the focus (the center coordinates of the cluster map 711), their coordinates PE12 and PE13 are not calculated. Thereafter, likewise, the cluster maps 712 and then 713 are each sequentially selected as the cluster map i (i=2, 3), and with the center coordinates of the selected cluster map taken as a focus, the respective coordinates PEij of the other cluster maps with respect to the selected cluster map are calculated.

Subsequently, by using the respective coordinates PEij calculated with respect to the four cluster maps, the non-linear zoom processing section 640 calculates the mean of transformed coordinates with respect to the cluster map i (i=1 to 3). For example, in the case of the cluster map 710 (i=0), the non-linear zoom processing section 640 calculates the mean value of the coordinates PE10 and PE20. That is, the mean value TM1 of the coordinates PE10 and PE20 is calculated by the following equation.

TM1=(PE10+PE20)/2

As described above, transformed coordinates PEij are calculated only for cluster maps whose center coordinates exist within the transformation target area with respect to a cluster map selected as a focus. Therefore, the denominator on the right side of this equation is the number of cluster maps for which the transformed coordinates PEij have been calculated. That is, coordinates PE30 are not calculated with respect to the cluster map 710 (i=0). Therefore, when calculating the mean value TM1 of the coordinates PE10 and PE20, not “3” but “2” is used as the denominator on the right side of the corresponding equation. Then, the non-linear zoom processing section 640 sets the calculated mean value as the transformed center coordinates of the cluster map 710.

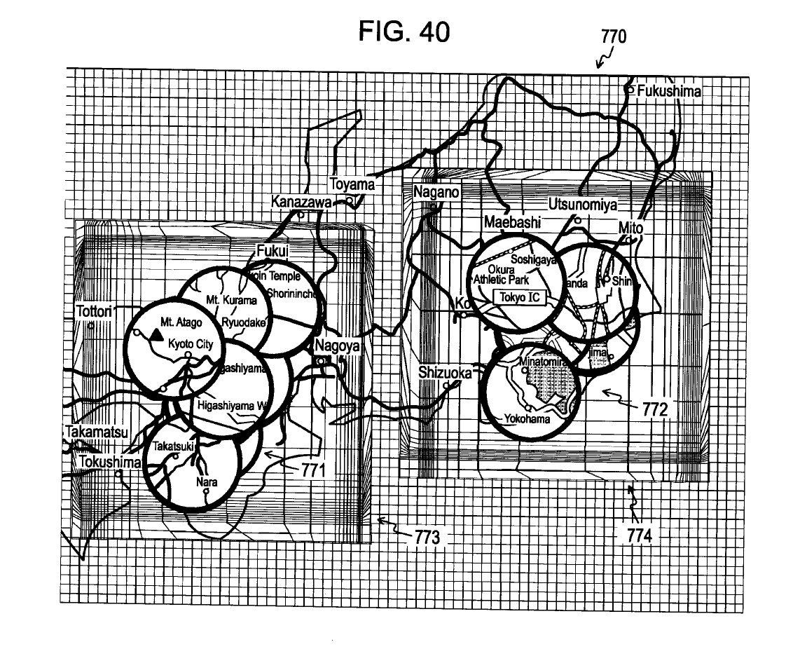

In this way, cluster maps can be placed on the basis of the calculated center coordinates of the cluster maps. FIG. 40 shows an example of the placement of cluster maps after coordinate transformation.

FIG. 40 is a diagram schematically showing a case in which cluster maps that have been coordinate-transformed by the non-linear zoom processing section 640 are placed on coordinates according to the second embodiment of the present invention. The example shown in FIG. 40 illustrates a case in which cluster maps obtained by performing coordinate transformation with respect to the example shown in FIG. 35 are placed. That is, the individual cluster maps belonging to the cluster map groups 761 and 762 shown in FIG. 35 can be placed in such a way that these cluster maps are scattered apart from each other, thereby forming new cluster map groups 771 and 772. Inside near-rectangles 773 and 774, grid-like straight lines after coordinate transformation obtained when coordinates are distorted by a non-linear zoom process are shown in a simplified fashion.

In the case when, for example, as shown in FIG. 35, cluster maps generated on the basis of contents generated intensively in the neighborhood of Tokyo are placed at positions on a map corresponding to their center positions, there is a possibility that the cluster maps placed in the neighborhood of Tokyo are displayed in an overlaid manner. The same is conceivable for contents generated intensively in the neighborhood of Kyoto. When cluster maps are displayed in an overlaid manner in this way, although the cluster maps overlaid at the upper side are entirely visible, for cluster maps overlaid at the lower side, part or the entirety of the cluster maps is not visible. Accordingly, by placing cluster maps in the manner as shown in FIG. 40, for example, cluster maps displayed in an overlaid manner can be scattered apart from each other. Therefore, even those cluster maps which are not visible in their entirety become partially visible, thereby making it possible to recognize cluster maps placed on the map.

### [Example of Display of Map View]

FIG. 41 is a diagram showing an example of a map view screen displayed on the display section 680 according to the second embodiment of the present invention. A map view screen 780 shown in FIG. 41 is a display screen that displays a map in which cluster maps coordinate-transformed by a non-linear zoom process are placed. It should be noted that FIG. 41 shows an example of display in the case where the cluster maps shown in FIG. 40 coordinate-transformed by a non-linear zoom process are placed on a map 770. That is, the cluster map groups 771 and 772 shown in FIG. 41 are the same as those shown in FIG. 40. Thus, the cluster maps 771 and 772 are denoted by the same reference numerals, and their description is omitted.

The map view screen 780 includes a scale-changing bar 781. By operating the scale-changing bar 781, the user can change the scale of a map displayed on the map view screen 780. When the scale of a map is changed in this way, every time the scale of a map is changed, the above-described non-linear zoom process is performed, and placement of map clusters is changed.

Also, when a desired cluster map is selected by a user operation from among cluster maps displayed on the map view screen 780, a listing of contents belonging to the selected cluster map is displayed in a content listing display area 782. FIG. 41 shows an example of display of a listing of contents in the content listing display area 782 in the case when a cluster map 784 is selected. Also, in an area 783 connecting between the selected cluster map 784 and the content listing display area 782, various kinds of information related to the contents belonging to the selected cluster map 784 are displayed. For example, as the various kinds of information related to the contents belonging to the selected cluster map 784, the number of contents “170” is displayed.

Also, in the cluster map groups 771 and 772, the display control section 670 overlays cluster maps with higher precedence at the upper side for display, on the basis of pieces of information stored in the content storing section 210 or the cluster information storing section 240.

By placing cluster maps on the map in this way for display, overlapping cluster maps are spread out in accordance with a predetermined condition. Therefore, the geographical correspondence between contents can be intuitively grasped, and a listing screen that is easy for the user to view can be provided.

Also, the display control section 670 may display a background image while changing its display state on the basis of the straight lines corresponding to coordinates shown in FIG. 40. For example, by changing color in accordance with the size of distortion in each of the near-rectangles 773 and 774, a content density map can be displayed. For example, it is supposed that in regions where cluster maps are densely packed, the size of each cluster is small. Therefore, by changing display color in accordance with the size of distortion, the relative sizes of clusters can be expressed smoothly substantially in the manner of contour lines on a map. This makes it possible to provide the user with additional information related to contents and clusters.

### [Example of Force-Directed Relocation Process]

Next, a description will be given of a case in which a listing of cluster maps is displayed so that the geographical correspondence between the cluster maps can be intuitively grasped.

FIG. 42 is a diagram schematically showing cluster maps that are subject to a force-directed relocation process by the relocation processing section 650 according to the second embodiment of the present invention.

In this force-directed relocation process, processing is performed to achieve the criteria (4) to (6) below.

(4) The positional relationship between cluster maps is to be maintained.

(5) Cluster maps are not to overlap each other.

(6) There is to be no unnecessary gap between cluster maps.

FIG. 42 shows a case in which four cluster maps 730 to 733 that have been coordinate-transformed by a non-linear zoom process are placed on their corresponding coordinates. Here, in the second embodiment of the present invention, it is assumed that each of the cluster maps receives from each of the other cluster maps a force acting to cause these cluster maps to repel from each other, in accordance with the distance between the center positions of the corresponding cluster maps. In the description of this example, the force acting to cause cluster maps to repel from each other will be referred to as “repulsive force”. Here, a repulsive force means a force acting to cause two objects to repel from each other. The repulsive force according to the second embodiment of the present invention becomes greater as the distance between the center positions of the corresponding clusters becomes shorter.

The relocation processing section 650 finds a repulsive force vector Fᵢⱼ exerted on a cluster map i (0≦i≦N−1: N is the number of cluster maps) from another cluster map j (i#j, and 0≦j≦N−1: N is the number of cluster maps) by equation (12) below.

Fᵢⱼ=K×K/Dᵢⱼ (12)

Here, Dᵢⱼ is a vector from the center position of the cluster map j to the center position of the cluster map i. Also, K is a parameter identified by the size of the display screen and the number of cluster maps, and can be found by equation (13) below.

K=√/(DW1×DH1/N) (13)

Here, DW1 is the length in the left-right direction of the display screen of the display section 680 (the width of the display screen), and DH1 is the length in the top-bottom direction of the display screen of the display section 680 (the height of the display screen). Also, N is the number of cluster maps. It should be noted that the width and height of the display screen correspond to the number of pixels in the display screen. When the display area of cluster maps on the display screen is to be magnified or shrunk, the values of DW1 and DH1 are changed as appropriate in accordance with the size of the display area.

Then, by using equation (12), the relocation processing section 650 calculates the repulsive force vectors Fᵢⱼ with respect to the cluster map i, for all the other cluster maps. That is, repulsive force vectors Fᵢₗ to F_{iN} (where i≠1, N) with respect to the cluster map i are calculated.

Then, after finishing calculation of the repulsive force vectors Fᵢ₁ to F_{iN} with respect to all cluster maps, the relocation processing section 650 calculates the mean of the repulsive force vectors Fᵢⱼ with respect to the cluster map i (repulsive force vector Fᵢ). The mean of the repulsive force vectors Fᵢⱼ (repulsive force vector Fᵢ) is a value indicating a repulsive force supposed to be exerted on the cluster map i from each of the other cluster maps.

Subsequently, the relocation processing section 650 performs coordinate transformation on the cluster map i by using the repulsive force vector Fᵢ. Specifically, the absolute value |Fᵢ| of the repulsive force vector Fᵢ is compared with the parameter K, and coordinate transformation is performed on the cluster map i on the basis of this comparison result. For example, if |Fᵢ| is equal to or smaller than the parameter K (that is, if |Fᵢ|≦K), coordinate transformation is performed so as to move the coordinates of the center position of the cluster map i by the repulsive force vector Fᵢ. On the other hand, if |Fᵢ| is larger than the parameter K (that is, if |Fᵢ|>K), coordinate transformation is performed so as to move the coordinates of the center position of the cluster map i by the distance of K in the direction of the repulsive force vector Fᵢ. That is, coordinate transformation is performed so as to move the coordinates by a vector K (Fᵢ/|Fᵢ|). Here, the parameter K is scalar. Therefore, by multiplying the unit vector of the repulsive force vector Fᵢ by K so that the direction becomes the same as the repulsive force vector Fᵢ, the amount of movement (vector K(Fᵢ/|Fᵢ|) is determined.

In this way, the relocation processing section 650 performs a coordinate transformation process using a repulsive force vector with respect to each of cluster maps. That is, until coordinate transformation using a repulsive force vector is performed with respect to all of cluster maps, the relocation processing section 650 sequentially selects a cluster map on which a coordinate transformation process has not been performed, and repetitively performs the above-described coordinate transformation process.

Then, if coordinate transformation using a repulsive force vector has been performed with respect to all of cluster maps, it is judged whether or not the repulsive force vectors |Fᵢ| (0≦i≦N−1: N is the number of cluster maps) calculated with respect to individual cluster maps are less than a threshold th11. If all the repulsive force vectors |Fᵢ| are less than the threshold th11, the coordinate transformation process is ended.

If any one of the repulsive force vectors |Fᵢ| is equal to or greater than the threshold th11, the coordinate transformation process is repeated until all the repulsive force vectors |Fᵢ| become less than the threshold th11.

Here, for example, if the threshold th11 is set to a relatively large value (for example, th11>1), the iteration count becomes small, and thus the computation time becomes short. Also, since the relocation process is discontinued midway, the probability of overlapping of cluster maps becomes higher.

On the other hand, for example, if the threshold th11 is set to a relatively small value (for example, th11<1), the iteration count becomes large, and thus the computation time becomes long. Also, due to the larger number of iterations, the probability of overlapping of cluster maps becomes lower.

For example, the threshold th11 can be set as th11=1. If the threshold th11 is set as th11=1 in this way, a plurality of cluster maps can be displayed with substantially no overlap. Also, for example, if the threshold th11 is set as th11=0, by appropriately determining the size of each cluster map with respect to the display area on the display screen, a plurality of cluster maps can be displayed with no overlap without fail. In this regard, for example, since cluster maps have a circular shape, a gap occurs between the cluster maps. Also, in this example, relocation is performed so as to maintain the positional relationship between cluster maps. Thus, it is necessary to make the total surface area occupied by the cluster maps to be displayed smaller than the display area. For this reason, it is necessary to set an appropriate cluster map size. It should be noted that a description regarding a cluster map size will be described later in detail with reference to FIGS. 43A and 43B.

It should be noted that while the threshold th11 is used in this example as the criterion for judging whether or not to repeat a coordinate transformation process, this may be judged on the basis of whether or not another criterion is satisfied. For example, whether or not “|Fᵢ|<th11” and “iteration count <upper limit count” are satisfied with respect to all repulsive force vectors Fᵢ may serve as the criterion for judging whether or not to repeat a coordinate transformation process. This iteration count is a count indicating how many times a loop based on this conditional expression has been passed.

Now, a description will be given of a case in which, as shown in FIG. 42, a force-directed relocation process is performed with respect to the four cluster maps 730 to 733 that have been coordinate-transformed by a coordinate transformation process.

The relocation processing section 650 calculates repulsive force vectors F₀₁, F₀₂, and F₀₃ with respect to the cluster map 730 by using equation (12). It should be noted that the repulsive force vector F₀₁ is a repulsive force vector on the cluster map 730 with respect to the cluster map 731. Also, the repulsive force vector F₀₂ is a repulsive force vector on the cluster map 730 with respect to the cluster map 732, and the repulsive force vector F₀₃ is a repulsive force vector on the cluster map 730 with respect to the cluster map 733.

Then, upon finishing calculation of the repulsive force vectors F₀₁, F₀₂, and F₀₃ with respect to the cluster map 730, the relocation processing section 650 calculates the mean (repulsive force vector F₀) of the repulsive force vectors F₀₁, F₀₂, and F₀₃.

Subsequently, the relocation processing section 650 performs coordinate transformation on the cluster map 730 by using the repulsive force vector F₀. Specifically, if |F₀| is equal to or smaller than the parameter K, coordinate transformation is performed so as to move the coordinates of the center position of the cluster map 730 by the repulsive force vector F₀. On the other hand, if |F₀| is larger than the parameter K, coordinate transformation is performed so as to move the coordinates of the center position of the cluster map 730 by the distance of K in the direction of the repulsive force vector F₀.

Thereafter, likewise, the coordinate transformation process using a repulsive force vector is repetitively performed for the cluster maps 731 to 733. For example, let the repulsive force vector calculated with respect to the cluster map 731 be a repulsive force vector F₁, the repulsive force vector calculated with respect to the cluster map 733 be a repulsive force vector F₂, and the repulsive force vector calculated with respect to the cluster map 733 be a repulsive force vector F₃.

Subsequently, when coordinate transformation using a repulsive force vector has been performed with respect to all of the cluster maps 730 to 733, it is judged whether or not all of the repulsive force vectors calculated with respect to the respective cluster maps 730 to 733 are smaller than the threshold th11. That is, it is judged whether or not all of |F₀|, |F₁|, |F₂|, and |F₃| are smaller than the threshold th11. If all of |F₀|, |F₁|, |F₂|, and |F₃| are smaller than the threshold th11, the coordinate transformation process is ended.

If any one of |F₀|, |F₁|, |F₂|, and |F₃| is equal to or larger than the threshold th11, the coordinate transformation process is repeated until all of |F₀|, |F₁|, |F₂|, and |F₃| become smaller than the threshold th11.

### [Example of Magnification/Shrinkage Process]

FIGS. 43A and 43B are diagrams schematically showing cluster maps that are subject to a magnification/shrinkage process by the magnification/shrinkage processing section 660 according to the second embodiment of the present invention.

In this magnification/shrinkage process, processing is performed to achieve criteria (7) and (8) below.

(7) All cluster maps are to fit within a single screen.

(8) There is to be no unnecessary gap between cluster maps.

FIGS. 43A and 43B show a case in which 22 cluster maps (#1 to #22) that have been coordinate-transformed by a force-directed relocation process are corrected in accordance with the size of the display screen on the display section 680. Also, in FIGS. 43A and 43B, for the 22 cluster maps (#1 to #22), pieces of identification information (#1 to #22) corresponding to the respective cluster maps are shown attached inside the circles representing the respective cluster maps.

FIG. 43A shows 22 cluster maps (#1 to #22) coordinate-transformed by the relocation processing section 650, and a rectangle 740 corresponding to the coordinates of these cluster maps (#1 to #22) to be transformed. The rectangle 740 is a rectangle corresponding to the coordinates in the case when the 22 cluster maps (#1 to #22) are coordinate-transformed by the relocation processing section 650. In FIG. 43A, the size of the rectangle 740 is CW1×CH1. Here, CW1 is the length in the left-right direction of the rectangle 740, and CH1 is the length in the top-bottom direction of the rectangle 740.

In FIG. 43A, a rectangle having a size corresponding to the display screen of the display section 680 is indicated by a dotted rectangle 750, and the size of the rectangle 750 is set as DW1×DH1. It should be noted that DW1 and DH1 are the same as those indicated in equation (13). That is, DW1 is the width of the display screen of the display section 680, and DH1 is the height of the display screen of the display section 680.

Here, if relocation is performed with respect to the cluster maps (#1 to #22) by a force-directed relocation process as shown in FIG. 42, it is supposed that gaps occur between individual cluster maps. Also, in the case when relocation is performed in this way, it is supposed that the rectangle including the 22 cluster maps (#1 to #22) becomes large in comparison to the size of the display screen on the display section 680. Accordingly, a magnification process or a shrinkage process is performed so as to satisfy the criteria (7) and (8) described above. In the example shown in FIG. 43A, since gaps are present between the cluster maps (#1 to #22), for example, the coordinates of the respective cluster maps (#1 to #22) can be corrected as indicated by arrows 741 to 744. In this coordinate transformation, only the center coordinates of the cluster maps are transformed, and the size of the cluster maps is not changed. By correcting the coordinates so that the rectangle 740 fits in the rectangle 750 in this way, appropriate correction can be performed.

Also, for example, with respect to the center coordinates (x, y) of all cluster maps, the coordinates of the respective cluster maps after correction can be found by using xy coordinates with the respective minimum values x0 and y0 of x and y coordinates taken as an origin. For example, in FIG. 43A, with the left-right direction defined as the x axis, and the top-bottom direction defined as the y axis, the respective minimum values x0 and y0 of the x and y coordinates are set. For example, the x coordinate of the center position of the cluster map #1 located at the leftmost end of the rectangle 740 is taken as the minimum value x0, and the y coordinate of the center position of the cluster map #8 located at the uppermost end of the rectangle 740 is taken as the minimum value y0. Then, in the xy coordinates whose origin is (x0, y0), the center coordinates CC1(x_{CC1}, y_{CC1}) of individual cluster maps after correction can be found by equation (14) below, with respect to the center coordinates (x, y) of the individual cluster maps. Here, let the radius of each cluster map be R.

CC1(x_{CC1},y_{CC1})=((x−x0)×(DW1−R)/(CW1−R)+R/2,(y−y0)×(DH1−R)/(CH1−R)+R/2) (14)

Here, the transformation performed using equation (14) involves transformation of only the center coordinates CC1(x_{CC1}, y_{CC1}) of each cluster map, and does not change the size of each cluster map.

FIG. 43B shows 22 cluster maps (#1 to #22) that have been coordinate-transformed by using equation (14), and a display screen 751 of the display section 680 on which these cluster maps (#1 to #22) are displayed. The display screen 751 has the same size as the rectangle 740 shown in FIG. 43A.

As shown in FIG. 43B, by transforming the center coordinates CC1(x_{CC1}, y_{CC1}) of individual cluster maps by using equation (14), all the cluster maps can be placed so as to fit in a single screen. Also, since only the center coordinates CC1(x_{CC1}, y_{CC1}) of cluster maps are transformed, and the size of the cluster maps is not changed, the cluster maps can be placed in such a way that no unnecessary gaps are present between the cluster maps.

Here, if the number of cluster maps to be displayed is large, cases can be supposed where not all the cluster maps fit within a single screen. For example, letting the radius of each cluster map be R, and the number of cluster maps to be displayed be N, not all the cluster maps fit within a single screen if equation (15) below does not hold.

DW1×DH1>N×π×R² (15)

Here, the left side of equation (15) represents the surface area of the display screen 751, and the right side of equation (15) represents the sum of the surface areas of cluster maps to be displayed.

It should be noted that considering the facts that relocation is determined by taking the positional correspondence into account to some extent in the force-directed relocation process, and that gaps occur between cluster maps having a circular shape, it is necessary to set the value of the right side of equation (15) to a further smaller value.

In the case when the value of the right side of equation (15) is set to a further smaller value in this way, if equation (15) does not hold, it is supposed that not all the cluster maps fit within a single screen. In this case, for example, to ensure that the cluster maps can fit within a single screen, the cluster maps may be shrunk, and then the above-mentioned three processes (the non-linear zoom process, the force-directed relocation process, and the magnification/shrinkage process) may be performed anew. In this case, it is preferable to set the shrinkage ratio for cluster maps appropriately by taking the size of the display screen 751 and the number of cluster maps into account.

In this regard, if cluster maps are excessively shrunk, it is supposed that the cluster maps displayed on the display screen 751 become hard to view. For this reason, if the number of cluster maps is relatively large (for example, if the number of cluster maps exceeds a threshold th12), the cluster maps may be placed so as to be presented across a plurality of screens to prevent the cluster maps from becoming extremely small. In this case, for example, cluster maps included in the display screens can be displayed by a user's scroll operation.

When displaying a listing of cluster maps coordinate-transformed through the three processes (the non-linear zoom process, the force-directed relocation process, and the magnification/shrinkage process) described above, for example, a wide-area map corresponding to a cluster map that has been selected can be displayed as a background image. Thus, the location where contents constituting each cluster are generated can be grasped more easily. As this wide-area map, for example, a map with a diameter that is 10 times the diameter of the corresponding cluster map can be used. However, it is supposed that depending on the size of the cluster map selected, this size may not be an appropriate size. Accordingly, in the following, a description will be given of a case in which a wide-area map (cluster wide-area map) corresponding to such maps is generated.

### [Example of Wide-Area Map Generation]

FIGS. 44A and 44B are diagrams schematically showing a background map generation process by the background map generating section 610 according to the second embodiment of the present invention.

FIG. 44A shows a cluster map 801 corresponding to cluster information stored in the cluster information storing section 240. The cluster map 801 is a simplified map corresponding to the region in the vicinity of the Shinagawa station that exists in the Tokyo-prefecture.

FIG. 44B shows an example of a map corresponding to map data stored in the map information storing section 220. A map 802 shown in FIG. 44B is a simplified map corresponding to the region in the vicinity of the Shinagawa station that exists in the Tokyo-prefecture. It should be noted that in the map 802, an area 803 corresponding to the cluster map 801 shown in FIG. 44A is indicated by a dotted circle.

First, the background map generating section 610 acquires map data from the map information storing section 220, on the basis of cluster information stored in the cluster information storing section 240. Then, on the basis of the acquired map data, the background map generating section 610 generates a background map (cluster wide-area map) corresponding to the cluster information.

For example, as shown in FIG. 44B, the background map generating section 610 sets an area including the area 803 corresponding to the cluster map 801, as an extraction area 804 out of maps corresponding to the map data stored in the map information storing section 220. Then, the background map generating section 610 generates a map included in the extraction area 804 as a background map (cluster wide-area map) corresponding to the cluster map 801. Here, the extraction area can be set as, for example, a rectangle of a predetermined size centered about the center position of the cluster map. Also, for example, with the radius of the cluster map taken as a reference value, the extraction area can be set as a rectangle whose one side has a length equal to predetermined times of the reference value.

Here, as described above, the scale of each cluster map varies with the generated position of each content constituting the corresponding cluster. That is, the size of a location corresponding to a cluster map varies from cluster to cluster. For example, when the diameter of a cluster map is relatively large, this means that a map covering a relatively wide area is included, so the general outline of the cluster map is easy to grasp. Therefore, it is considered that when the diameter of a cluster map is relatively large, it is not necessary for the background map corresponding to the cluster map to cover a relatively wide area.

In contrast, for example, when the diameter of a cluster map is relatively small, this means that only a map covering a relatively narrow area is included, so it is supposed that the general outline of the cluster map is hard to grasp. For this reason, when the diameter of a cluster map is relatively small, it is preferable that the background map corresponding to the cluster map be relatively large with respect to the cluster map.

Accordingly, for example, the size of an extraction area may be changed in accordance with the diameter of a cluster map. In the following, a description will be given of a case in which the size of an extraction area is changed in accordance with the diameter of a cluster map.

FIG. 45 is a diagram showing the relationship between the diameter of a cluster wide-area map generated by the background map generating section 610, and the diameter of a cluster map according to the second embodiment of the present invention.

In the graph shown in FIG. 45, the horizontal axis represents the diameter (s) of a cluster map corresponding to cluster information stored in the cluster information storing section 240, and the vertical axis represents the diameter (w) of a cluster wide-area map generated by the background map generating section 610.

Here, for example, let S₀ be the minimum value of the diameter of a cluster map generated by the cluster information generating section 170 (shown in FIG. 1) according to the first embodiment of the present invention, and let R₀ be the magnification ratio with respect to the diameter of the cluster map when s=S₀. In this case, the diameter w of the cluster wide-area map generated by the background map generating section 610 can be found by equation (16) below.

w=a(s−2π)²+2π (16)

Here, a=(R₀S₀−2π/(S₀−2π)². Also, equation (16) corresponds to a curve 805 of the graph shown in FIG. 45.

In this way, the minimum value S₀ of the cluster map generated by the cluster information generating section 170 is set in advance, and the minimum value R₀S₀ of the diameter of the cluster wide-area map corresponding to this minimum value S₀ is set in advance. Then, as the diameter size of the cluster map becomes larger, the magnification ratio per unit of the diameter of the cluster wide-area map with respect to the diameter of the cluster map is decreased. As a result, a more appropriate cluster wide-area map can be generated.

### [Example of Display of Scatter View]

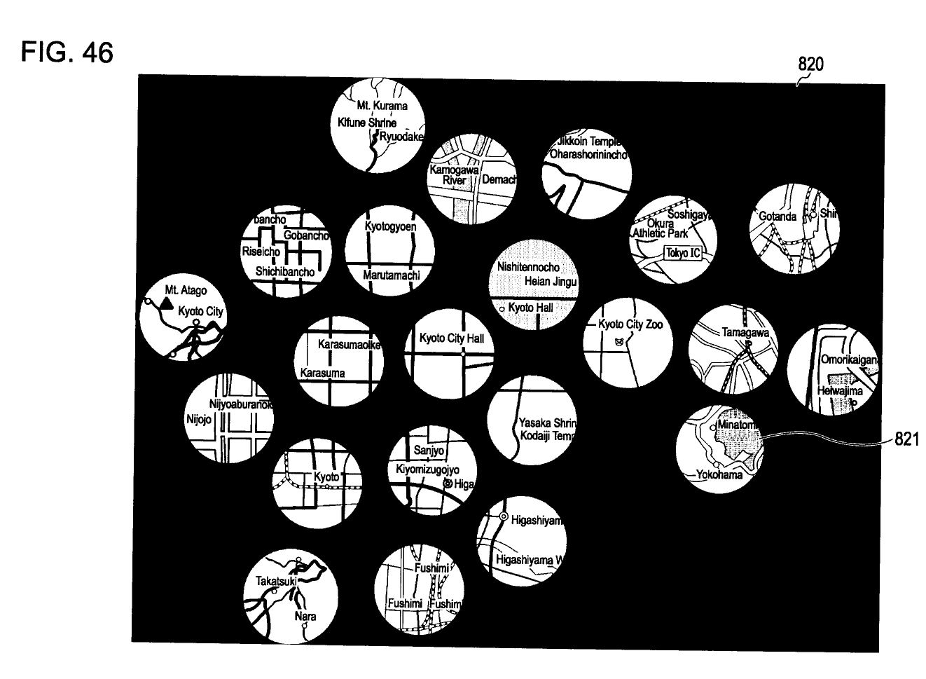

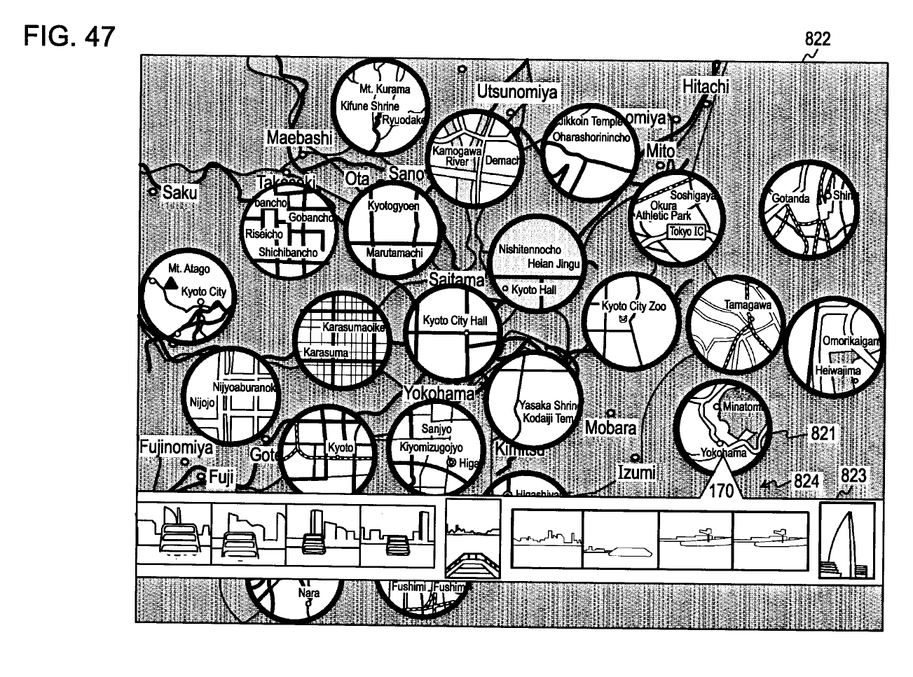

FIGS. 46 and 47 are diagrams each showing an example of a scatter view screen displayed on the display section 680 according to the second embodiment of the present invention. Here, the word scatter means, for example, the state of being scattered, and the scatter view screen means, for example, a screen that displays a listing of cluster maps while scattering the cluster maps apart from each other on the basis of a predetermined rule.

A scatter view screen 820 shown in FIG. 46 is a display screen that displays a listing of cluster maps coordinate-transformed through the three coordinate transformation processes (the non-linear zoom process, the force-directed relocation process, and the magnification/shrinkage process) described above. On the scatter view screen 820, the area (background area) other than the display areas of cluster maps can be displayed in a relatively inconspicuous color (for example, black color).

When a desired cluster map is selected by a user operation from among the listing of cluster maps displayed on the scatter view screen 820, a background map (cluster wide-area map) corresponding to the selected cluster map is displayed in the background area.

FIG. 47 shows an example of display of a scatter view screen 822 in the case when a cluster map 821 is selected. As shown in FIG. 47, a background map (cluster wide-area map) corresponding to the selected cluster map is displayed in the background area.

Also, a listing of contents belonging to the selected cluster map is displayed in a content listing display area 823. FIG. 47 shows an example of display of a listing of contents in the content listing display area 823 when the cluster map 821 is selected. It should be noted that since information displayed in the content listing display area 823, and various kinds of information displayed in an area 824 connecting between the cluster map 821 and the content listing display area 823 are the same as those in the case of the map view screen shown in FIG. 41, description thereof is omitted here.

In this way, the scatter view screen can provide a display of a listing of contents which satisfies the criteria (4) to (8) mentioned above. This allows a display of a listing of cluster maps to be viewed by the user while taking the geographical positional relationship into consideration. Since a cluster map is a map obtained by extracting only an area corresponding to a cluster, cases can be supposed where when there are no characteristic place names, geographical features, or the like within the cluster map. Accordingly, by displaying a background map (cluster wide-area map) corresponding to a cluster map that has been selected, it becomes easier to grasp which location is indicated by the cluster.

[Example of Display when Plural Cluster Maps are Selected]

The above description is directed to the case in which one cluster map is selected. Here, suppose a case in which a plurality of cluster maps can be selected simultaneously with a single operation (for example, a multi-tap). For example, when two cluster maps are selected by using two fingers, it is supposed that the respective background maps (cluster wide-area maps) corresponding to the selected cluster maps are different from each other. In this case, a case can be also supposed where one of the background maps does not include the position corresponding to the other selected cluster map. Accordingly, when a plurality of cluster maps are selected, it is preferable to display background maps corresponding to the respective cluster maps selected. Also, when a plurality of cluster maps are selected in this way, it is supposed that the selected cluster maps have different sizes. Accordingly, when a plurality of cluster maps are selected, it is preferable to display the cluster maps at the same scale (or at such scales that allow their relative size comparison) so that the sizes of the selected cluster maps can be grasped intuitively.

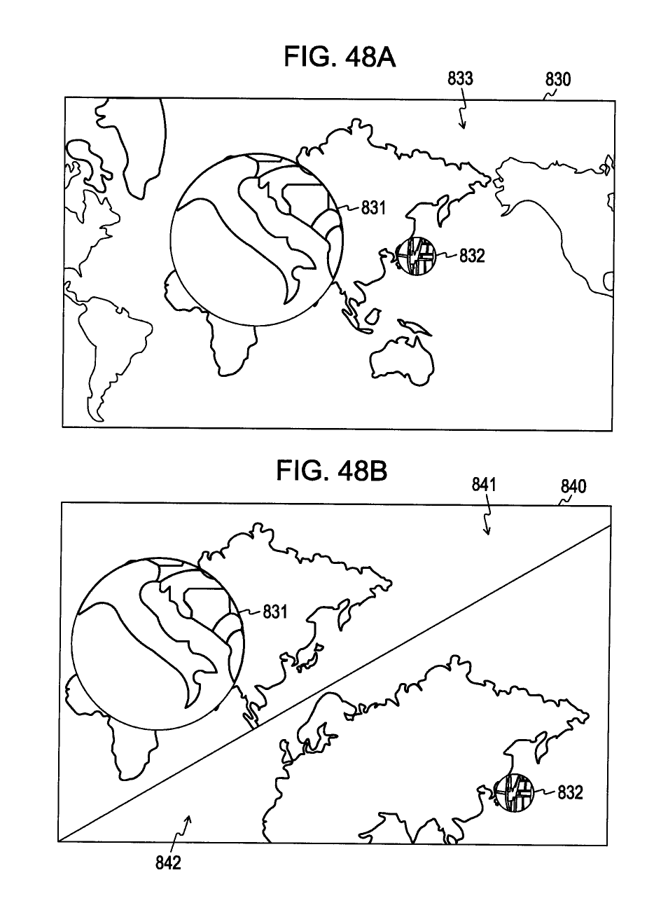

FIGS. 48A and 48B are diagrams each showing an example of a scatter view screen displayed on the display section 680 according to the second embodiment of the present invention. This example illustrates an example of display in the case when two cluster maps are selected on the scatter view screen. For example, a case is shown in which a cluster map (cluster map of Italy) 831 to which a cluster generated throughout Italy belongs, and a cluster map (cluster map of the vicinity of the Shinagawa station) 832 to which a cluster generated in the vicinity of the Shinagawa station belongs are selected.

FIG. 48A shows an example of display in the case when two cluster maps (the cluster map 831 and the cluster map 832) are selected. In this example, with the center position of each of the two selected cluster maps (the cluster map 831 and the cluster map 832) taken as a reference, a background map generated on the basis of this reference is displayed. For example, a background map 833 whose center position is the middle position of the line segment connecting the center positions of the two cluster maps is generated, and the background map 833 is displayed. This background map may be generated sequentially every time a plurality of cluster maps are selected, or may be generated in advance for every combination of cluster maps. Also, for example, a world map may be used as the background map.

Also, for example, the two selected cluster maps (the cluster map 831 and the cluster map 832) are displayed at such scales that allow their relative size comparison. For example, with the cluster map 832 of the smaller size taken as a reference, the other cluster map 831 is displayed in magnified form.

FIG. 48B shows another example of display in the case when two cluster maps (the cluster map 831 and the cluster map 832) are selected. In this example, the two selected cluster maps are each set to a scale that allows a relative size comparison, and the display area of the background map is separated for each of the two cluster maps. For example, the background map for the cluster map 831 is displayed in a background map display area 841, and the background map for the cluster map 832 is displayed in a background map display area 842. While the background map display areas are divided from each other by an oblique line running from the upper right to the lower left in this example, the background map display areas may be divided from each other by another dividing method. Also, while two cluster maps are selected in these examples, the same applies to the case when three or more cluster maps are selected.

### [Example of Display Screen Transition]

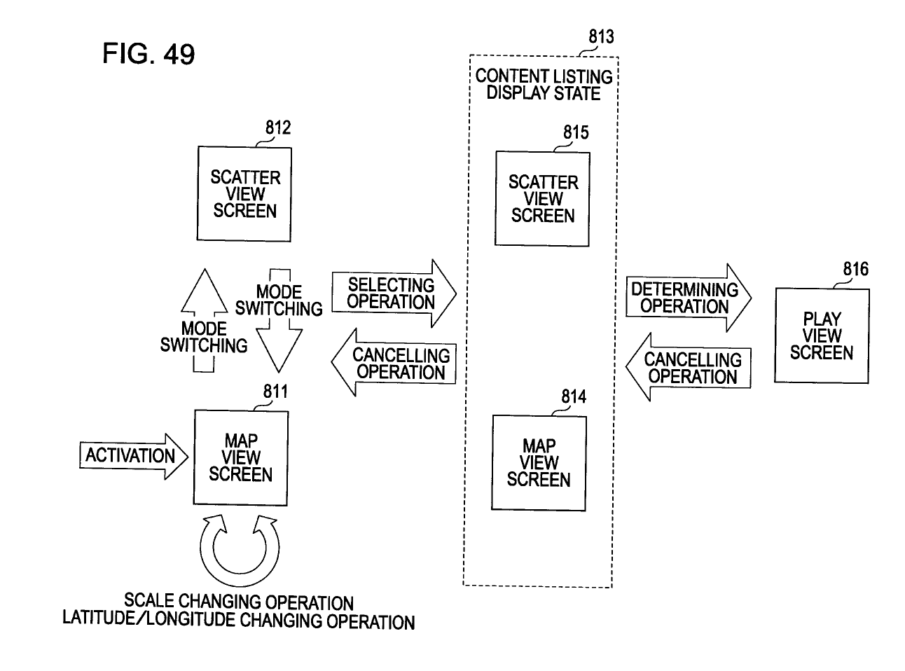

FIG. 49 is a diagram showing an example of transition of the display screen of the display section 680 which is performed by the display control section 670 according to the second embodiment of the present invention. The second embodiment of the present invention is directed to a case in which contents are displayed by three different display screens, a map view screen, a scatter view screen, and a play view screen.

For example, when an operational input for activating a content playback application is accepted by the operation accepting section 690 in the information processing apparatus 600, the display control section 670 displays a map view screen 811 on the display section 680. Also, when the operational input for activating a content playback application is accepted, the coordinate calculating section 630 calculates the coordinates of the center position of each cluster map on the display screen, on the basis of cluster information stored in the cluster information storing section 240.

The map view screen 811 is a display screen that displays cluster maps in an overlaid manner on a map, and corresponds to the map view screen 780 shown in FIG. 41. By performing an operational input with the operation accepting section 690 in the state with the map view screen 811 displayed on the display section 680, the user can change the scale or latitudes and longitudes of the displayed background map for cluster maps.

Such an operational input can be made by using, for example, an operating member such as a mouse including two left and right buttons, and a wheel placed between these two buttons. In the following, a description will be given of a case in which a mouse is used as the operating member. For example, a cursor (mouse pointer) that moves with each mouse movement is displayed. The cursor is a mouse pointer used on the screen displayed on the display section 680 to point to an object of instruction or operation.

For example, by operating the mouse's wheel up and down, the scale of a background map can be changed. Also, by a drag operation on a background map, the latitudes and longitudes of the background map can be changed. This drag operation is, for example, an operation of moving a target image by moving the mouse while keeping on pressing the left-side button of the mouse.

When a changing operation for changing the scale or latitudes and longitudes of a background map is made by the user in the state with the map view screen 811 displayed on the display section 680 in this way, the coordinate calculating section 630 calculates new coordinates of the corresponding cluster maps in accordance with the changing operation. That is, in accordance with updating of the background map, the corresponding coordinates are calculated and updated.

A mode switch from the map view screen 811 to the scatter view screen 812 is effected by performing a right click operation in the state with the map view screen 811 displayed on the display section 680. Also, a mode switch from the scatter view screen 812 to the map view screen 811 is effected by performing a right click operation in the state with the scatter view screen 812 displayed on the display section 680. That is, the modes are switched between each other every time a right click operation is done by the user in the state with the map view screen 811 or the scatter view screen 812 displayed on the display section 680. The scatter view screen 812 is a display screen that displays a listing of cluster maps, and corresponds to, for example, the scatter view screens 820 and 822 respectively shown in FIGS. 46 and 47.

In the state with the map view screen 811 or the scatter view screen 812 displayed on the display section 680, one of cluster maps can be selected by a user's mouse operation. For example, in the state with the map view screen 811 or the scatter view screen 812 displayed on the display section 680, a cursor is moved over (moused-over) one of cluster maps by a user's mouse operation. By this mouse operation, the moused-over cluster map becomes selected (focused). It should be noted that when, in the state with a cluster map selected, a cursor is moved from the selected cluster map to another display area by a user's mouse operation, the selection is deselected. It should be noted, however, that when a cursor is moved from a selected cluster map to another cluster map, the cluster map to which the cursor has been moved becomes newly selected.

When a selecting operation is performed in the state with the map view screen 811 or the scatter view screen 812 displayed on the display section 680 in this way, a content listing display area is displayed on the view screen on which the selecting operation has been performed (a content listing display state 813). This content listing display area is an area that displays a listing of contents belonging to a cluster corresponding to the cluster map being selected. Such an example of display is shown in each of FIGS. 41 and 47.

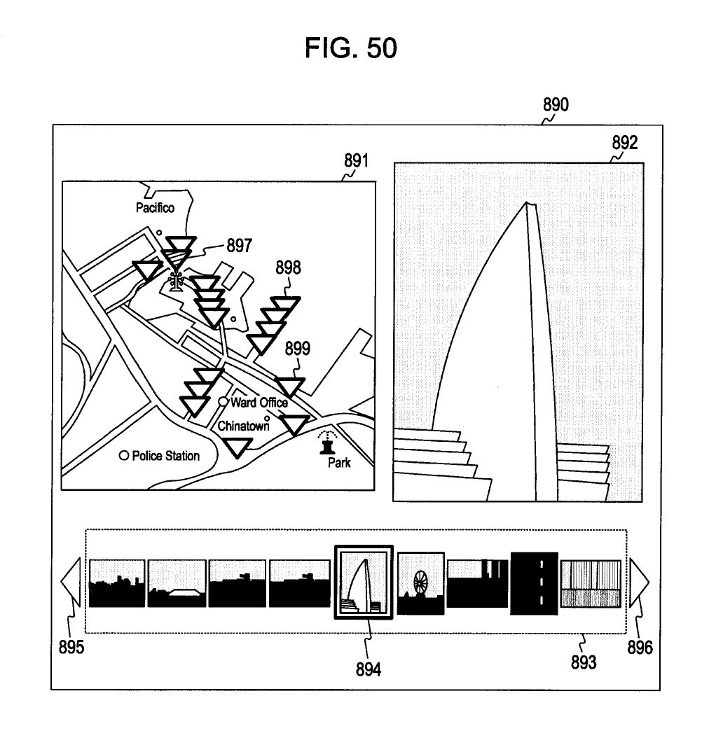

When a left click operation is performed in the state with one of cluster maps selected on the map view screen 811 or the scatter view display screen 812, a play view screen 816 is displayed. That is, this left click operation corresponds to a determining operation. The play view screen 816 displays a listing of contents belonging to a cluster corresponding to the cluster map on which a determining operation has been made, a content's magnified image, and the like. Also, for example, when a right click operation is performed in the state with the play view screen 816 displayed on the display section 680, the state returns to the state before the display of the play view screen 816. That is, this right click operation corresponds to a deselecting operation. An example of display of this play view screen will be described later in detail with reference to FIG. 50.

### [Example of Display of Play View]

FIG. 50 is a diagram showing an example of a play view screen displayed on the display section 680 according to the second embodiment of the present invention.

As described above, a play view screen 890 shown in FIG. 50 is a screen that is displayed when a left click operation is performed in the state with one of cluster maps selected on the map view screen or the scatter view screen. Then, on the play view screen 890, images related to a cluster corresponding to the cluster map on which a determining operation has been made are displayed. For example, a listing of contents belonging to the cluster, a content's magnified image, and the like are displayed.

The play view screen 890 includes, for example, three display areas, a map display area 891, a magnified image display area 892, and a content listing display area 893. It should be noted that although not shown in FIG. 50, in the area other than these three display areas, a wide-area map (cluster wide-area map) related to the corresponding cluster can be displayed as a background image. In this case, the wide-area map may be displayed in an inconspicuous color (for example, grey).

In the map display area 891, a map related to the corresponding cluster (for example, a magnified map of the cluster map corresponding to the cluster) is displayed. In the example shown in FIG. 50, a map of the vicinity of the Yokohama Chinatown is displayed. Also, on the map displayed in the map display area 891, marks indicating the generated positions of contents belonging to the corresponding cluster are displayed. In the example shown in FIG. 50, inverted triangles (marks 897 to 899 and the like) having a thick-lined contour are displayed as such marks. These marks are plotted while having their placement determined on the basis of the latitudes and longitudes of the corresponding contents. The mark 897 indicating the generated position of the content (the content with a selection box 894 attached) being selected in the content listing display area 893 is displayed in a different manner of display from that of the other marks. For example, the inverted triangle of the mark 897 is an inverted triangle with oblique lines drawn inside, and the inverted triangle of each of the other marks (898, 899, and the like) is an inverted triangle that is painted with white inside.

In the magnified image display area 892, an image corresponding to the content (the content with the selection box 894 attached) being selected in the content listing display area 893 is displayed in magnified form.

In the content listing display area 893, a listing of contents belonging to the corresponding cluster is displayed as thumbnails. For example, if there is a large number of contents to be listed for display, only some of the contents to be listed for display may be displayed in the content listing display area 893, and the other contents may be displayed by a scroll operation. For example, the other contents may be scroll displayed by a scroll operation using a left button 895 and a right button 896. Also, at least one content can be selected from among the listing of contents displayed in the content listing display area 893. In the example shown in FIG. 50, the content displayed at the center portion of the content listing display area 893 is selected. The content thus selected is displayed while being attached with the selection box 894 indicating the selected state. This selection box 894 can be in, for example, yellow color. A selecting operation on a content can be made by using a cursor. An image corresponding to the content attached with the selection box 894 in the content listing display area 893 is displayed in magnified form in the magnified image display area 892. Editing, processing, and the like can be performed on each content by a user operation.

### [Example of Operation of Information Processing Apparatus]

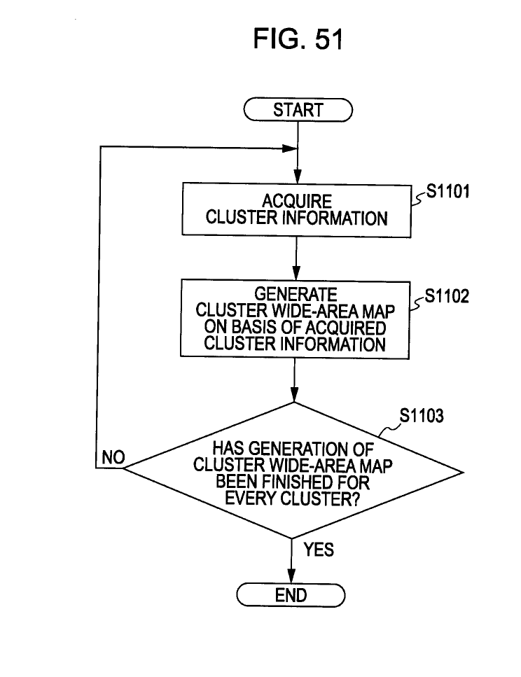

FIG. 51 is a flowchart showing an example of the procedure of a background map generation process by the information processing apparatus 600 according to the second embodiment of the present invention.

First, the background map generating section 610 acquires cluster information stored in the cluster information storing section 240 (step S1101). Subsequently, on the basis of the acquired cluster information, the background map generating section 610 generates a background map (cluster wide-area map) corresponding to the cluster, and stores the generated background map into the background map information storing section 620 in association with the cluster (step S1102). Subsequently, it is judged whether or not generation of a background image (cluster wide-area map) has been finished for every cluster (step S1103). If generation of a background image has not been finished for every cluster, the process returns to step S1101. On the other hand, if generation of a background image has been finished for every cluster (step S1103), the operation of the background map generation process is ended.

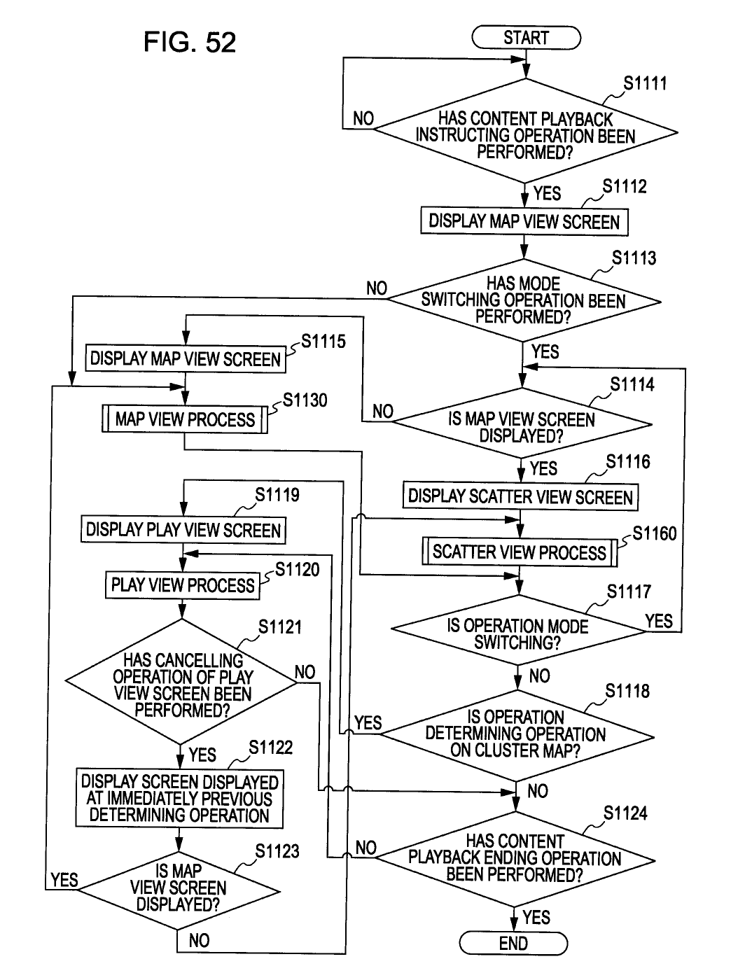

FIG. 52 is a flowchart showing an example of the procedure of a content playback process by the information processing apparatus 600 according to the second embodiment of the present invention.

First, it is judged whether or not a content playback instructing operation for instructing content playback has been performed (step S1111). If a content playback instructing operation has not been performed, monitoring is continuously performed until a content playback instructing operation is performed. If a content playback instructing operation has been performed (step S1111), a map view screen is displayed (step S1112).

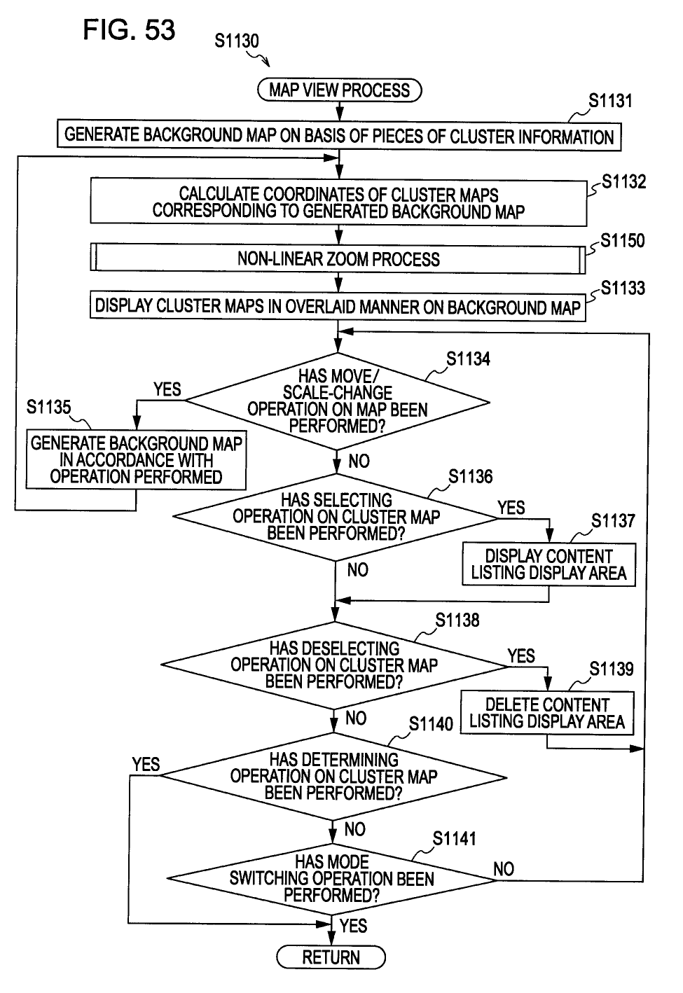

Subsequently, it is determined whether or not a mode switching operation has been performed (step S1113). If a mode switching operation has been performed (step S1113), it is determined whether or not a map view screen is displayed (step S1114). If a map view screen is not displayed, a map view screen is displayed (step S1115). Subsequently, a map view process is performed (step S1130), and the process proceeds to step S1117. This map view process will be described later in detail with reference to FIG. 53.

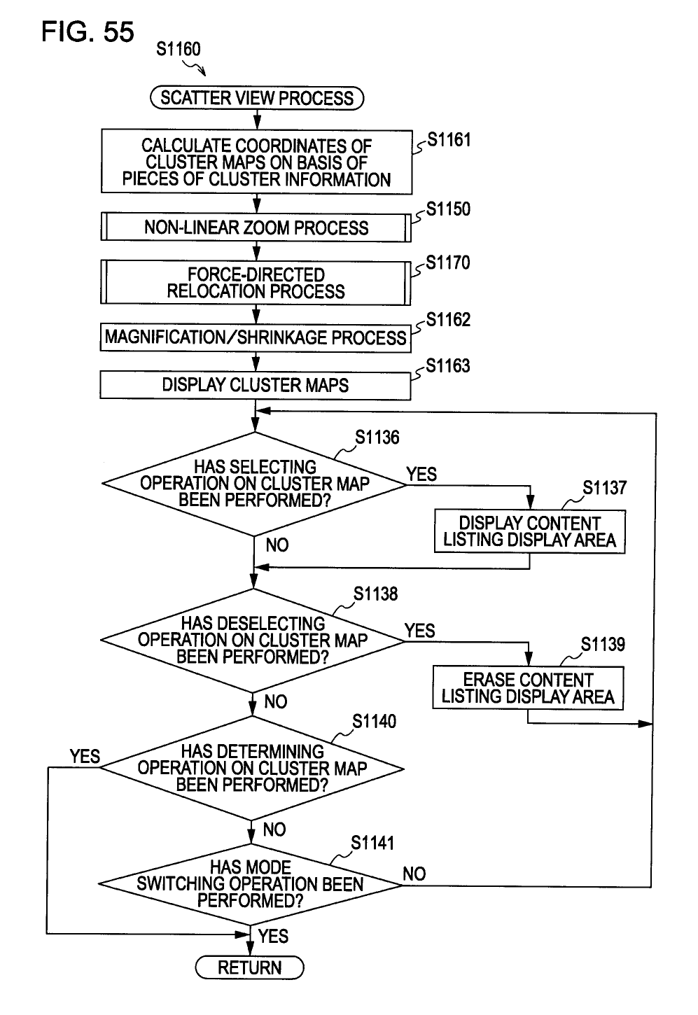

If a map view screen is displayed (step S1114), a scatter view screen is displayed (step S1116), a scatter view process is performed (step S1160), and the process proceeds to step S1117. This scatter view process will be described later in detail with reference to FIG. 55.

Subsequently, it is judged whether or not the accepted operation is a mode switching operation (step S1117). If the accepted operation is a mode switching operation (step S1117), the process returns to step S1114. If the accepted operation is not a mode switching operation (step S1117), it is judged whether or not the operation is a determining operation on a cluster map (step S1118). If the operation is a determining operation on a cluster map (step S1118), a play view map is displayed (step S1119), and a play view process is performed (step S1120). Subsequently, it is determined whether or not a cancelling operation on the play view screen has been performed (step S1121). If a cancelling operation on the play view screen has been performed, a screen (a map view screen or scatter view screen) displayed at the time of the determining operation on the current play view screen is displayed (step S1122). Subsequently, it is judged whether or not the displayed screen is a map view screen (step S1123). If the displayed screen is a map view screen, the process returns to step S1130. On the other hand, if the displayed screen is not a map view screen (that is, if the displayed screen is a scatter view screen) (step S1123), the process returns to step S1160.

If a cancelling operation on the play view screen has not been performed (step S1121), it is judged whether or not a content playback ending operation for instructing the end of content playback has been performed (step S1124). If the content playback ending operation has not been performed, the process returns to step S1120. On the other hand, if the content playback ending operation has been performed (step S1124), the operation of the content playback process is ended.

FIG. 53 is a flowchart showing an example of the map view process (the procedure of step S1130 shown in FIG. 52) of the procedure of the content playback process by the information processing apparatus 600 according to the second embodiment of the present invention.

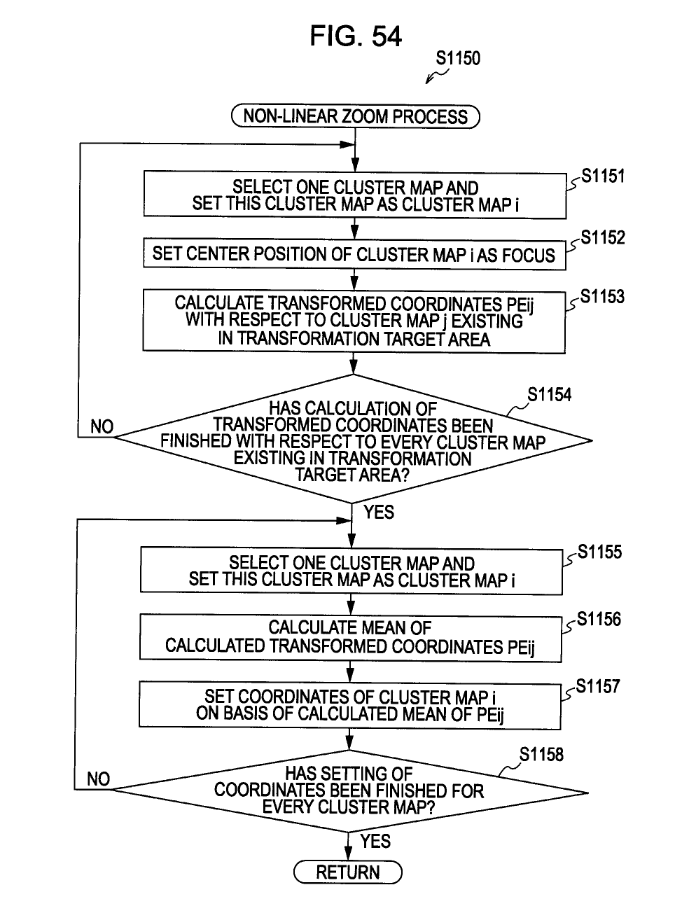

First, on the basis of cluster information stored in the cluster information storing section 240, the display control section 670 acquires map data from the map information storing section 220, and generates a background map (step S1131). Subsequently, the coordinate calculating section 630 calculates the coordinates of cluster maps corresponding to the generated background map (step S1132), and the non-linear zoom processing section 640 performs a non-linear zoom process (step S1150). This non-linear zoom process will be described later in detail with reference to FIG. 54.

Subsequently, the display control section 670 displays the cluster maps while overlaying the cluster maps on the coordinates on the map found by the non-linear zoom process (step S1133). It should be noted that step S1133 is an example of a display control step described in the claims. Subsequently, it is judged whether or not a move/scale-change operation on a map has been performed (step S1134). If a move/scale-change operation on a map has been performed (step S1134), in accordance with the operation performed, the display control section 670 generates a background map (step S1135), and the process returns to step S1132. On the other hand, if a move/scale-change operation on a map has not been performed (step S1134), it is judged whether or not a selecting operation on a cluster map has been performed (step S1136). If a selecting operation on a cluster map has been performed (step S1136), the display control section 670 displays a content listing display area on the map view screen (step S1137), and the process proceeds to step S1138.

If a selecting operation on a cluster map has not been performed (step S1136), it is judged whether or not a deselecting operation on a cluster map has been performed (step S1138). If a deselecting operation on a cluster map has been performed (step S1138), the display control section 670 erases the content listing display area displayed on the map view screen (step S1139), and the process returns to step S1134.

If a deselecting operation on a cluster map has not been performed (step S1138), it is judged whether or not a determining operation on a cluster map has been performed (step S1140). If a determining operation on a cluster map has been performed (step S1140), the operation of the map view process is ended. On the other hand, if a determining operation on a cluster map has not been performed (step S1140), it is judged whether or not a mode switching operation has been performed (step S1141). If a mode switching operation has been performed (step S1141), the operation of the map view process is ended. On the other hand, if a mode switching operation has not been performed (step S1141), the process returns to step S1134.

FIG. 54 is a flowchart showing an example of the non-linear zoom process (the procedure of step S1150 shown in FIG. 53) of the procedure of the content playback process by the information processing apparatus 600 according to the second embodiment of the present invention.

First, the non-linear zoom processing section 640 selects one cluster map from among cluster maps whose coordinates have been calculated by the coordinate calculating section 630, and sets this cluster map as a cluster map i (step S1151). Subsequently, the non-linear zoom processing section 640 sets the coordinates (center position) of the cluster map i as a focus (step S1152), and calculates transformed coordinates PEij with respect to every cluster map j existing within a transformation target area (step S1153). It should be noted that steps S1151 to S1153 are each an example of a transformed coordinate calculating step described in the claims.

Subsequently, it is judged whether or not calculation of transformed coordinates has been finished with every one of the cluster maps whose coordinates have been calculated by the coordinate calculating section 630 set as a focus (step S1154). If calculation of transformed coordinates has not been finished with every cluster map set as a focus (step S1154), a cluster map for which the calculation has not been finished is selected, and this cluster map is set as the cluster map i (step S1151). On the other hand, if calculation of transformed coordinates has been finished with every one of cluster maps set as a focus (step S1154), one cluster map is selected from among the cluster maps for which calculation of the transformed coordinates has been finished, and this cluster map is set as the cluster map i (step S1155). Subsequently, the non-linear zoom processing section 640 calculates the mean of the calculated transformed coordinates PEij (step S1156), and set the calculated mean as the coordinates of the cluster map i (step S1157). It should be noted that steps S1155 to 1157 are each an example of a coordinate setting step described in the claims.

Subsequently, it is judged whether or not setting of coordinates has been finished with respect to every one of the cluster maps for which calculation of the transformed coordinates has been finished (step S1158). If setting of coordinates has been finished with respect to every cluster map (step S1158), a cluster map for which the setting has not been finished is selected, and this cluster map is set as the cluster map i (step S1155). On the other hand, if setting of coordinates has been finished with respect to every cluster map (step S1158), the operation of the non-linear zoom process is ended.

FIG. 55 is a flowchart showing an example of the scatter view process (the procedure of step S1160 shown in FIG. 52) of the procedure of the content playback process by the information processing apparatus 600 according to the second embodiment of the present invention.

First, the coordinate calculating section 630 calculates the coordinates of cluster maps on the basis of cluster information stored in the cluster information storing section 240 (step S1161). Subsequently, the non-linear zoom processing section 640 performs a non-linear zoom process (step S1150). Since this non-linear zoom process is the same as the procedure shown in FIG. 54, the non-linear zoom process is denoted by the same symbol, and description thereof is omitted here.

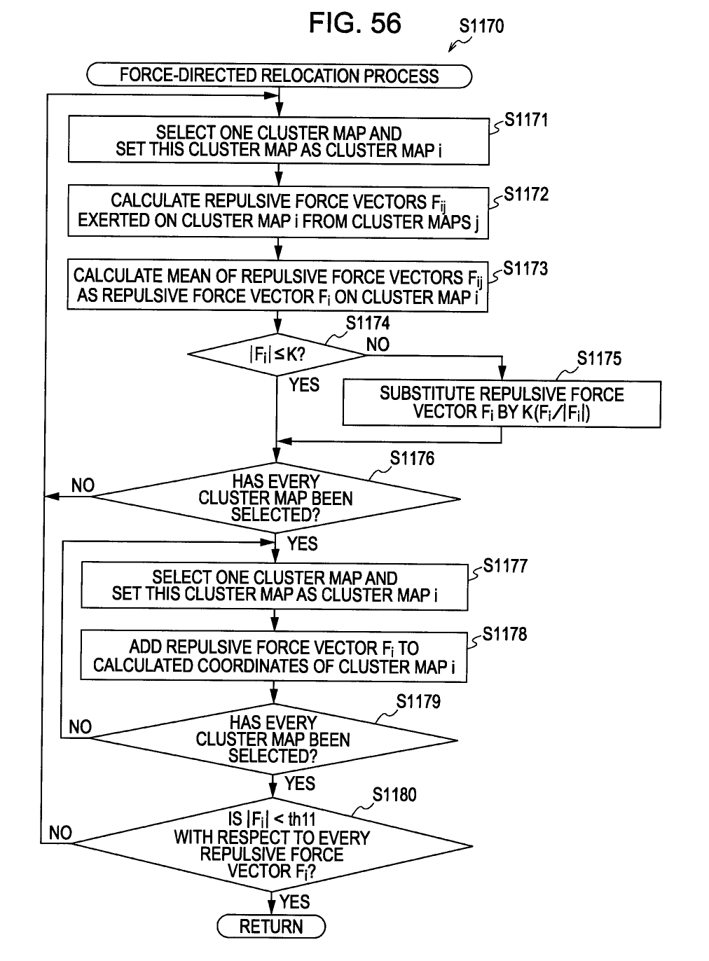

Subsequently, the relocation processing section 650 performs a force-directed relocation process (step S1170). This force-directed relocation process will be described later in detail with reference to FIG. 56.

Subsequently, the magnification/shrinkage processing section 660 performs coordinate transformation by a magnification/shrinkage process, on the basis of the size of an area subject to coordinate transformation by the relocation process, and the size of the display screen on the display section 680 (step S1162).

Subsequently, the display control section 670 displays the cluster maps while superimposing the cluster maps on coordinates on the map found by the magnification/shrinkage process (step S1163). It should be noted that since steps S1136 to S1141 are the same as those of the procedure shown in FIG. 53, these steps are denoted by the same symbols, and description thereof is omitted here.

FIG. 56 is a flowchart showing an example of the force-directed relocation process (the procedure of step S1170 shown in FIG. 55) of the procedure of the content playback process by the information processing apparatus 600 according to the second embodiment of the present invention.

First, the relocation processing section 650 selects one cluster map from among the cluster maps whose coordinates have been set by the non-linear zoom processing section 640, and sets this cluster map as a cluster map i (step S1171). Subsequently, the relocation processing section 650 calculates all of repulsive force vectors Fᵢⱼ exerted on the cluster map i from cluster maps j (step S1172). Subsequently, the relocation processing section calculates the mean of the calculated repulsive force vectors Fᵢⱼ as a repulsive force vector Fᵢ on the cluster map i (step S1173).

Subsequently, it is judged whether or not the absolute value |Fᵢ| of the calculated repulsive force vector Fᵢ is equal to or smaller than K (step S1174). If |Fᵢ| is equal to or smaller than K, the process proceeds to step S1176. On the other hand, if |Fᵢ| is larger than K (step S1174), the relocation processing section 650 substitutes the repulsive force vector Fᵢ by K(Fᵢ/|Fᵢ|) (step S1175).

Subsequently, it is judged whether or not calculation of the repulsive force vector Fᵢ has been finished with respect to every one of the cluster maps whose coordinates have been set by the non-linear zoom processing section 640 (step S1176). If calculation of the repulsive force vector Fᵢ has not been finished with respect to every cluster map (step S1176), a cluster map for which the calculation has not been finished is selected, and this cluster map is set as the cluster map i (step S1171). On the other hand, if calculation of the repulsive force vector Fᵢ has been finished with respect to every cluster map (step S1176), a cluster map is selected from among the cluster maps whose coordinates have been set by the non-linear zoom processing section 640, and this cluster map is set as the cluster map i (step S1177). Subsequently, the relocation processing section 650 adds the repulsive force vector Fᵢ to the coordinates of the cluster map i (step S1178).

Subsequently, it is judged whether or not addition of the repulsive force vector Fᵢ has been finished with respect to every one of the cluster maps whose coordinates have been set by the non-linear zoom processing section 640 (step S1179). If addition of the repulsive force vector Fᵢ has not been finished with respect to every cluster map (step S1179), a cluster map for which the addition has not been finished is selected, and this cluster map is set as the cluster map i (step S1177). On the other hand, if addition of the repulsive force vector Fᵢ has been finished with respect to every cluster map (step S1179), it is judged whether or not repulsive force vectors |Fᵢ| calculated with respect to individual cluster maps are smaller than the threshold th11 (step S1180). If all the repulsive force vectors |Fᵢ| are smaller than the threshold th11 (step S1180), the force-directed relocation process is ended. On the other hand, if any one of the repulsive force vectors |Fᵢ| is equal to or larger than the threshold th11 (step S1180), the process returns to step S1171, and the force-directed relocation process is repeated (steps S1171 to S1179).

It should be noted that while the second embodiment of the present invention is directed to the case in which a listing of cluster maps is displayed, the second embodiment of the present invention is also applicable to a case in which a listing of superimposed images other than cluster maps is displayed. For example, the second embodiment of the present invention is also applicable to a case in which icons representing individual songs are placed as superimposed images (for example, a music playback app) on the xy-coordinate system (background image) with the mood of each song taken along the x-axis and the tempo of each song taken along the y-axis. Also, the second embodiment of the present invention is applicable to a case in which short-cut icons or the like superimposed on the wallpaper displayed on a personal computer or the like are placed as superimposed images. For example, a non-linear zoom process can be performed with the superimposed image to be selected taken as the center. Also, a non-linear zoom process can be performed also when a plurality of superimposed images are to be selected.

Also, for example, in the case when a specific button is to be selected with respect to a group of buttons placed in a predetermined positional relationship, a non-linear zoom process can be performed with the button to be selected taken as the center. Also, a non-linear zoom process can be performed in the case when a plurality of buttons are to be selected. By these processes, overlapping of superimposed images is eliminated, thereby making it possible to provide a user interface that is easy to view and operate for the user.

### 3. Modifications

The first embodiment of the present invention is directed to the case of generating binary tree structured data while calculating distances between individual contents and sequentially extracting a pair with the smallest distance. In the following, a description will be given of a case in which binary tree structured data is generated by performing an initial grouping process and a sequential clustering process. By performing this initial clustering process, the number of pieces of data to be processed in tree generation can be reduced. That is, a faster clustering process can be achieved by reducing the number of nodes to be processed. Also, by performing a sequential clustering process, the amount of computation can be reduced as compared with a case in which exhaustive clustering (for example, the tree generation process shown in FIG. 8 and step S910 of FIG. 28) is performed, thereby achieving a faster clustering process. Further, a sequential clustering process can be used even in situations where not all pieces of data are available at the beginning. That is, when a new piece of data is added after binary tree structured data is generated by using pieces of data (content) that exist at the beginning, a clustering process can be performed with respect to the new piece of data by using the already-generated binary tree structured data.

### [Example of Tree Generation Process]

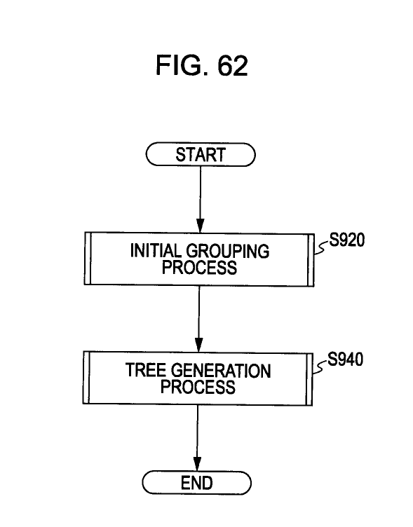

FIGS. 57A to 61B are diagrams for explaining a tree generation process performed by the tree generating section 120 according to a modification of the first embodiment of the present invention. FIGS. 57A to 61B will be described in detail with reference to the flowcharts shown in FIGS. 62 to 66. Here, an initial grouping process is a process performed before the tree generating section 120 performs a tree generation process, and contributes to faster processing speed. FIG. 57A shows a case in which contents e to m are placed virtually at positions identified by respective pieces of positional information associated with the contents. That is, FIG. 57A shows a case in which the contents e to m are placed virtually at their generated positions. Also, the times of shooting identified by respective pieces of date and time information associated with the contents e to m are in the order of the contents e, f, . . . , M.

FIGS. 62 to 66 are flowcharts each showing an example of the procedure of a clustering process by the information processing apparatus 100 according to a modification of the first embodiment of the present invention.

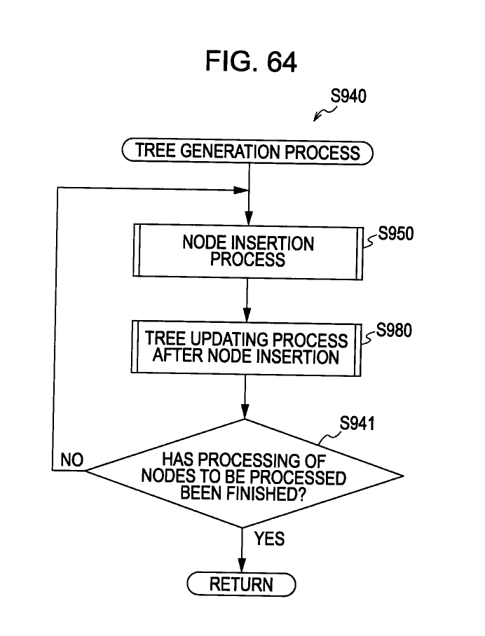

FIG. 62 shows an example of the procedure of the clustering process. First, an initial grouping process is performed (step S920). This initial grouping process will be described later in detail with reference to FIG. 63. Subsequently, a tree generation process is performed (step S940). This tree generation process will be described later in detail with reference to FIG. 64. The procedure of this tree generation process is a modification of step S910 shown in FIG. 28. It should be noted that the initial grouping process (step S920) may be performed before step S910 (shown in FIG. 28) according to the first embodiment of the present invention.

FIG. 63 shows an example of the initial grouping process (the procedure of step S920 shown in FIG. 62) of the procedure of the clustering process.

First, a variable i is initialized (step S921), and a content ni is set in a set S (step S922). Subsequently, “1” is added to the variable i (step S923), and a distance d(head(S), ni) is calculated (step S924). Here, head(S) represents the first content along the temporal axis among contents included in the set S. Also, the distance d(head(S), ni) is the distance between head(S) and the content ni.

Subsequently, it is judged whether or not the calculated distance d(head(S), ni) is smaller than a threshold (INITIAL_GROUPING_DISTANCE) th20 (step S925). If the calculated distance d(head(S), ni) is smaller than the threshold th20 (step S925), the content ni is added to the set S (step S926), and the process proceeds to step S930. On the other hand, if the calculated distance d(head(S), ni) is equal to or larger than the threshold th20 (step S925), a tree generation process is performed with respect to the contents included in the set S (step S940). This tree generation process will be described later in detail with reference to FIG. 64.

Subsequently, the results of the tree generation process are held (step S927), the contents in the set S are deleted (step S928), and the content ni is set in the set S (step S929).

Subsequently, it is judged whether or not the variable i is smaller than N (step S930), and if the variable i is smaller than N, the process returns to step S923. On the other hand, if the variable i is equal to or larger than N (step S930), the held results of the tree generation process are used as nodes to be processed (step S931), and the operation of the initial grouping process is ended. In this regard, while individual contents are inputted as elements to be processed in the tree generation process described above with reference to the first embodiment of the present invention, in the case when the initial grouping process is performed, a plurality of nodes held in step S927 are inputted as elements subject to a tree generation process. That is, nodes inputted as elements subject to a tree generation process (the plurality of nodes held in step S927) serve as the nodes to be processed.

That is, in the initial grouping process, respective pieces of positional information of the first content and the second content along the temporal axis are acquired, and the distance d between the two contents is calculated on the basis of the acquired pieces of positional information of the two contents. Subsequently, the calculated distance d and the threshold th20 are compared with each other, and it is judged whether or not the distance d is less than the threshold th20. If the distance d is less than the threshold th20, the two contents with respect to which the distance d has been calculated are determined as being subject to initial grouping, and these contents are added to the set S.

Subsequently, respective pieces of positional information of the first content and the third content along the temporal axis are acquired, and the distance d between the two contents is calculated on the basis of the acquired pieces of positional information of the two contents. Subsequently, the calculated distance d and the threshold th20 are compared with each other, and it is judged whether or not the distance d is less than the threshold th20. If the distance d is less than the threshold th20, the two contents with respect to which the distance d has been calculated are determined as being subject to initial grouping, and these contents are added to the set S. That is, the first to third contents are set in the set S. Thereafter, likewise, with respect to the N-th (N is an integer not smaller than 2) content, addition of the corresponding content to the set S is performed until the distance d becomes larger than the threshold th20. On the other hand, when the distance d becomes equal to or larger than the threshold th20, the N-th content with respect to which this distance d has been calculated is determined as not being subject to initial grouping. That is, at the point in time when the distance d becomes equal to or larger than the threshold th20, contents up to the content ((N−1)-th content) immediately preceding the N-th content with respect to which this distance d has been calculated become subject to initial grouping. That is, a grouping is interrupted at the N-th content. Then, by taking the N-th content where a grouping is interrupted as the first content along the temporal axis, with respect to the (N+1)-th content (N is an integer not smaller than 2), addition of the corresponding content to a new set S is performed until the distance d becomes larger than the threshold th20.

For example, suppose that in the example shown in FIG. 57A, respective distances between contents e and f, e and g, f and g, i and j, and h and m are less than the threshold th20, and distances between the other contents are equal to or larger than the threshold th20. Also, in FIG. 57A, each two contents to be compared are depicted as being connected by a dotted arrow. If the distance between contents is less than the threshold th20, a circle (◯) is attached on the corresponding arrow, and if the distance between contents is equal to or larger than the threshold th20, an X (×) is attached on the corresponding arrow.

In the example shown in FIG. 57A, contents from the first content e to the content g to be compared with each other are subject to initial grouping, and set in the set S. Subsequently, by taking the content i where a grouping is interrupted as the first content, the contents i and j become subject to initial grouping, and are set in a new set S. While the initial grouping process is thereafter performed in a similar way, since the distances between contents are equal to or larger than the threshold th20, no grouping is performed. It should be noted that although the distance between contents h and m is less than the threshold th20, since contents where a grouping is interrupted exist between the contents h and m, and the contents h and m are thus not compared with each other, the contents h and m do not become subject to initial grouping. An example of grouping in the case when initial grouping is performed in this way is shown in FIG. 57B. Also, respective contents that have undergone initial grouping are depicted as being bounded by circles 531 to 533.

FIG. 64 shows an example of the tree generation process (the procedure of step S940 shown in FIG. 62) of the procedure of the clustering process.

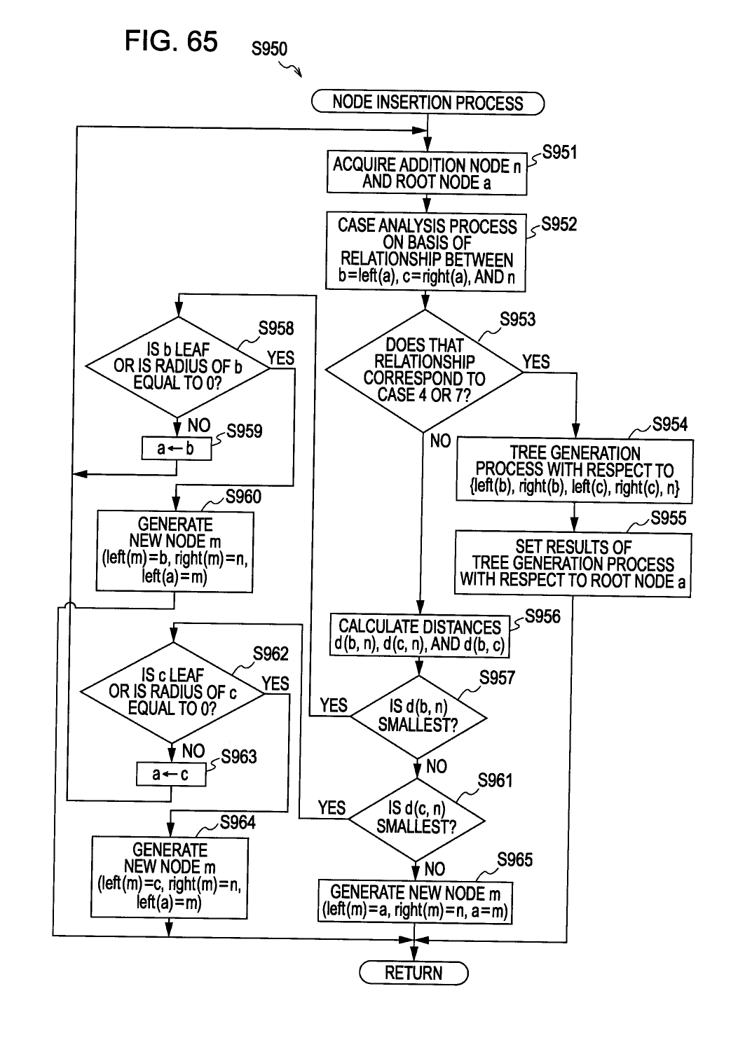

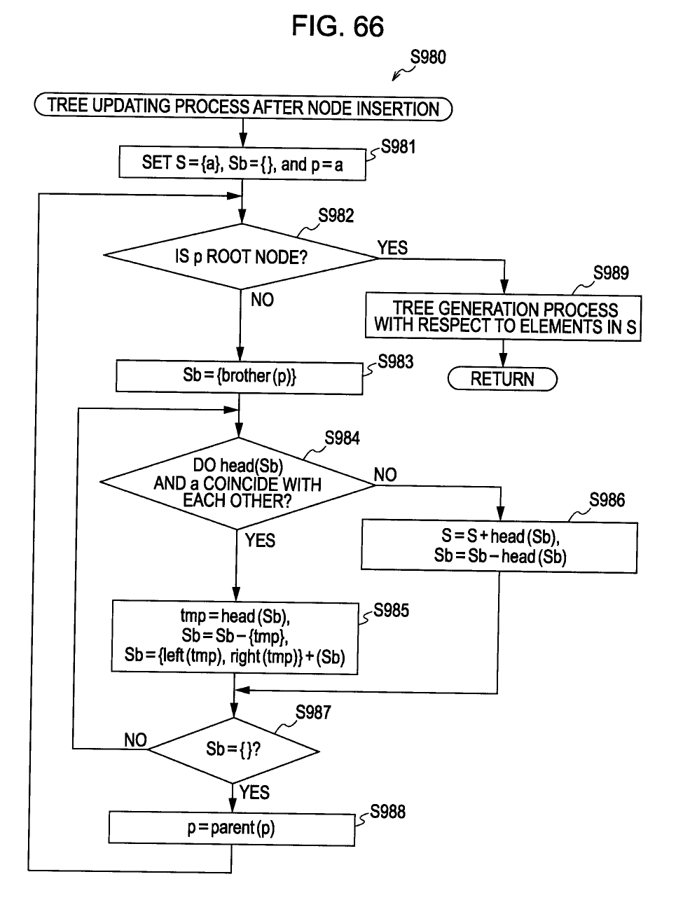

First, a node insertion process is performed (step S950). This node insertion process will be described later in detail with reference to FIG. 65. Subsequently, a tree updating process after node insertion is performed (step S980). This tree updating process after node insertion will be described later in detail with reference to FIG. 66. Subsequently, it is judged whether or not processing of nodes to be processed has been finished (step S941). If processing of nodes to be processed has not been finished, the process returns to step S950. On the other hand, if processing of nodes to be processed has been finished (step S941), the operation of the tree generation process is ended.

FIG. 65 shows an example of the node insertion process (the procedure of step S950 shown in FIG. 64) of the procedure of the tree generation process. In this example, an internal tree is generated by using the results of an initial grouping process as nodes to be processed. Also, for contents that have undergone initial grouping, their root nodes are regarded as contents to be handled in an internal tree. Further, in the generation of an internal tree, insertion of one piece of data to an already-created internal tree at a time is repeated. In the following, child nodes or leaves of each node are denoted by left( ) and right( ) For example, two child nodes of node a are denoted by left(a) and right(a). In this case, let left(a) be the first child of the node a, and right(a) be the second child of the node a. It should be noted that when no initial grouping process is performed, individual contents are inputted as elements to be processed. That is, individual contents are inputted as nodes to be processed.

First, on the basis of two contents at the beginning, a minimum tree structure is generated with the two contents taken as leaves, and a new node containing the two contents taken as root node a. Then, each of the third and subsequent contents (addition node n) is acquired (step S951). That is, a node insertion process is performed with respect to the root node a and the addition node n. FIG. 58A schematically shows the relationship between the root node a (501) and the addition node n (504).

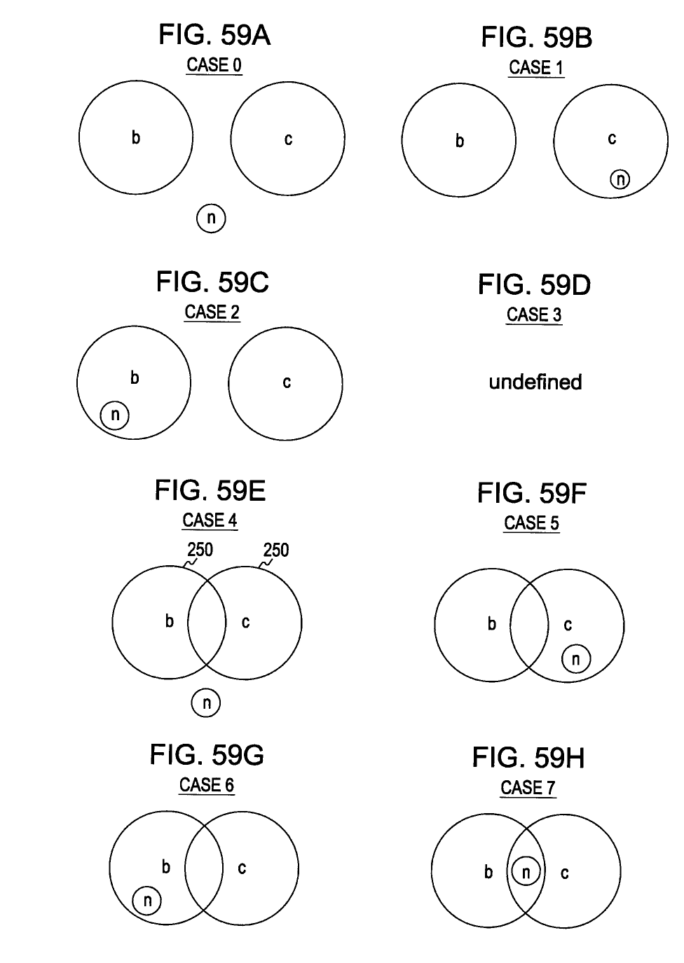

Subsequently, on the basis of the relationship between the root node a and the addition node n, case analysis is performed in accordance with the relationships shown in FIG. 58B and FIGS. 59A to 59H (step S952). Specifically, it is judged which one of Cases 0 to 7 shown in FIGS. 58B and 59A to 59H corresponds to the relationship between the child elements (node b (502) and node c (503)) of the node a (501) (the root node in the initial state) with respect to which node addition is performed, and the addition node n (504).

If the relationship between the root node a and the addition node n corresponds to the relationship in Case 4 or 7 shown in FIG. 58B and FIGS. 59A to 59H (step S953), the node b (502) and the node c (503) are decomposed into their respective child elements (b1, b2, c1, c2). It should be noted that b1=left(b), b2=right(b), c1=left(c), and c2=right(c). Then, a tree generation process is performed with respect to {b1, b2, c1, c2} (step S954). This tree generation process is the same as the tree generation process described above with reference to the first embodiment of the present invention, in which with respect to target nodes, a pair with the smallest distance is detected, and a new node having this detected pair of nodes as child elements is sequentially generated. By repeating this tree generation process until the number of target nodes becomes 1, binary tree structured data is generated. Subsequently, the root node of the tree generated by the tree generation process is substituted by the root node a (step S955), and the operation of the node insertion process is ended.

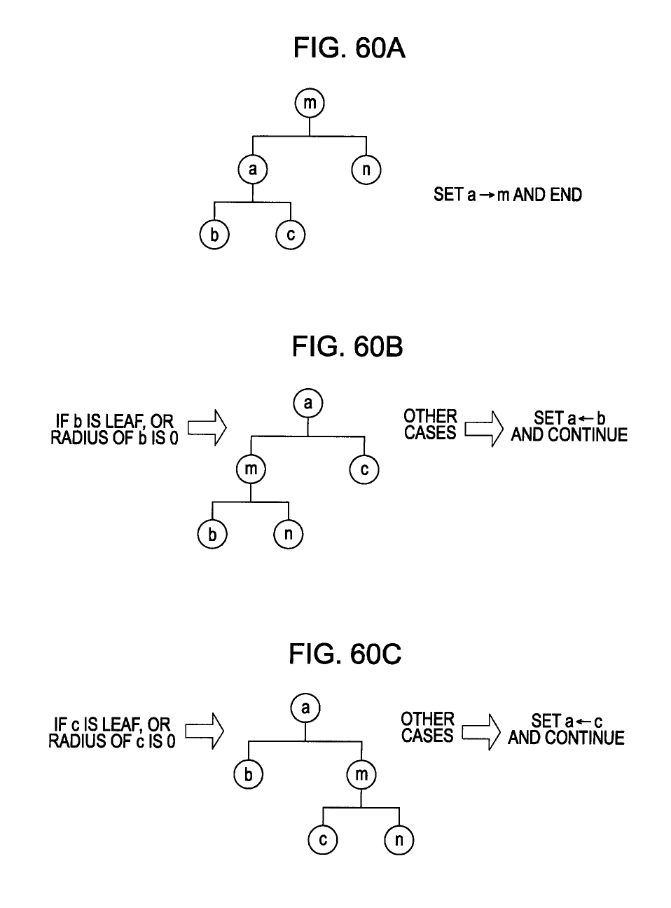

Also, if the relationship between the root node a and the addition node n is the relationship corresponding to any one of Cases 0 to 2, 5, and 6 shown in FIG. 58B and FIGS. 59A to 59H (step S953), distances between individual nodes are calculated. That is, distances d(b, n), d(c, n), and d(b, c) are calculated. It should be noted that the distance d(b, n) means the distance between the node b and the node n. Subsequently, a pair of nodes with the smallest distance is extracted from among the calculated distances between individual nodes (steps S957 and S961), and as shown in FIGS. 60A to 60C, processing according to each such pair is performed (steps S958 to 5960, and S962 to S965).

Specifically, when the distance d(b, n) is the smallest among the calculated distances between individual nodes (step S957), it is judged whether or not the node b is a leaf, or whether or not the radius of the node b is equal to 0 (step S958). If the radius of a node is equal to 0, this means that all the child elements exist at the same position. If the node b is not a leaf, and the radius of the node b is not equal to 0 (step S958), the node b is substituted by “a”, and the process returns to step S951. On the other hand, if the node b is a leaf, or the radius of the node b is equal to 0 (step S958), a new node m having the nodes b and n as child elements is generated, and the position of the original node b is substituted by the new node m (step S960). Then, the node m is substituted by “a” (step S960), and the operation of the node insertion process is ended. A schematic of these processes is shown in FIG. 60B.

Also, when the distance d(c, n) is the smallest among the calculated distances between individual nodes (step S961), by reading “b” in steps S958 to S960 described above as “c”, the same processes are performed (steps S962 and S963). A schematic of these processes is shown in FIG. 60C.

Also, when the distance d(b, c) is the smallest among the calculated distances between individual nodes, the state of the existing tree is held, and a new node m having the nodes a and n as child nodes is generated (step S965). Then, the node m is substituted by “a” (step S965), and the operation of the node insertion process is ended. A schematic of these processes is shown in FIG. 60A.

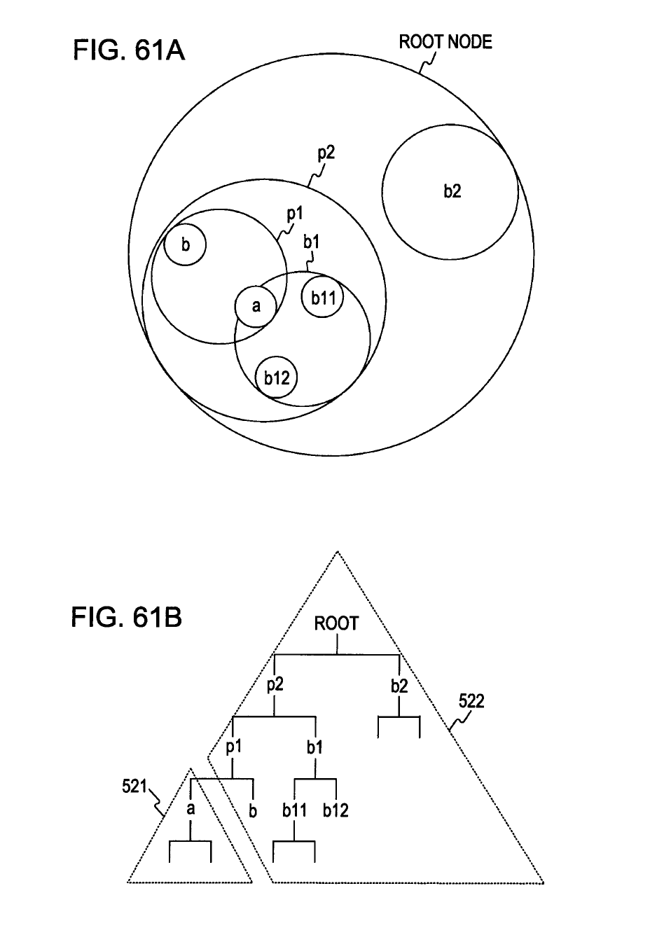

FIG. 66 shows an example of the tree updating process after node insertion (the procedure of step S980 shown in FIG. 64) of the procedure of the tree generation process. This is a process for adjusting the relationship between the node a and other nodes which is affected by an increase in the size of the node a due to node insertion. In this example, S and Sb each denote a set. Also, parent(a) denotes a parent node of the node a. Further, brother(a) denotes a brother (the other child as seen from the parent) of the node a. Also, head(S) denotes the first element of the set S. Also, tmp denotes an element to be held. FIGS. 61A and 61B show a schematic of the tree updating process after node insertion. The example shown in FIG. 61A illustrates the case of {a, b, b11, b12, b2} being subject to clustering. Also, FIG. 61B shows the relationship between an insertion position 521 and a portion to be restructured 522 in the example shown in FIG. 61A.

First, S={a}, Sb={ }, and p=a are set (step S981). Subsequently, it is judged whether or not p is a root node (step S982). If p is a root node, a tree generation process is performed with respect to elements within S (step S989), and the operation of the tree updating process after node insertion is ended. This tree generation process is the same as the process described in step S954. On the other hand, if p is not a root node (step S982), Sb={brother(p)} is set (step S983), and it is judged whether or not head(Sb) and “a” coincide with each other (step S984).

If head(Sb) and “a” coincide with each other (step S984), tmp=head(Sb), Sb=Sb−{tmp}, and Sb={left(tmp), right(tmp)}+Sb are set (step S985). Subsequently, it is judged whether or not Sb={ } (step S987). That is, it is judged whether or not the set Sb is empty. If Sb={ } does not hold, the process returns to step S984. On the other hand, if Sb={ } (step S987), p=parent(p) is set (step S988), and the process returns to step S982.

Also, if head(Sb) and “a” do not coincide with each other (step S984), S=S+head(Sb) and Sb=Sb−head(Sb) are set (step S986), and the process proceeds to step S987.

It should be noted that while the embodiments of the present invention are directed to the case in which still images are used as contents, for example, the embodiments of the present invention can be also applied to cases where moving image contents are used. For example, in a case where one piece of positional information is assigned to one moving image content, the embodiments of the present invention can be applied in the same manner as in the case of still image contents. Also, in a case where a plurality of pieces of positional information (for example, for every frame or for every predetermined interval of frames) are assigned to one moving image content, by determining one piece of positional information with respect to one moving image content, the embodiments of the present invention can be applied in the same manner as in the case of still image contents. For example, one piece of positional information can be determined with respect to one moving image content by using the start position of shooting of a moving image content, the end position of shooting of a moving image content, the mean of positions assigned to a moving image content, or the like. Also, the embodiments of the present invention can be also applied to contents such as text files and music files with which positional information and date and time information are associated.

Also, the embodiments of the present invention can be applied to information processing apparatuses capable of handling contents, such as a portable telephone with an image capturing function, a personal computer, a car navigation system, and a portable media player.

It should be noted that the embodiments of the present invention are illustrative of an example for implementing the present invention, and as explicitly stated in the embodiments of the present invention, there is a mutual correspondence between matters in the embodiments of the present invention, and invention-defining matters in the claims. Likewise, there is a mutual correspondence between invention-defining matters in the claims, and matters in the embodiments of the present invention which are denoted by the same names as those of the invention-defining matters. It should be noted, however, that the present invention is not limited to the embodiments, and the present invention can be implemented by making various modifications to the embodiments without departing from the scope of the present invention.

The process steps described above with reference to the embodiments of the present invention may be grasped as a method having a series of these steps, or may be grasped as a program for causing a computer to execute a series of these steps or a recording medium that stores the program. As this recording medium, for example, a CD (Compact Disc), an MD (MiniDisc), a DVD (Digital Versatile Disk), a memory card, a Blur-ray Disc (registered trademark), or the like can be used.

The present application contains subject matter related to that disclosed in Japanese Precedence Patent Application JP 2009-268661 filed in the Japan Patent Office on Nov. 26, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus comprising:
a transformed-coordinate calculating section that calculates transformed coordinates for each of a plurality of superimposed images associated with coordinates in a background image, by taking one superimposed image of the plurality of superimposed images as a reference image, and transforming coordinates of other superimposed images on the basis of corresponding coordinates of the reference image in the background image, distances in the background image from the reference image to the other superimposed images, and a distance in the background image from the reference image to a boundary within a predetermined area with respect to the reference image, the coordinates of the other superimposed images being transformed in such a way that coordinate intervals within the predetermined area become denser with increasing distance from the reference image toward the boundary within the predetermined area;
a coordinate setting section that sets coordinates of the reference image on the basis of a mean value obtained by calculating a mean of the calculated coordinates of the other superimposed images with respect to the reference image; and
a display control section that displays the background image and the plurality of superimposed images on a display section in such a way that the reference image is placed at the set coordinates in the background image.

2. The information processing apparatus according to claim 1, further comprising:
a second transformed-coordinate calculating section that calculates transformed coordinates for each of the superimposed images by transforming the set coordinates on the basis of a size of the background image on a display screen of the display section, the number of the superimposed images, and distances between the superimposed images in the background image, the set coordinates being transformed in such a way that the distances between the superimposed images increase under a predetermined condition in accordance with the distances between the superimposed images in the background image,
wherein the display control section displays the background image and the plurality of superimposed images in such a way that the superimposed images are placed at the coordinates in the background image calculated by the second transformed-coordinate calculating section.

3. The information processing apparatus according to claim 2, further comprising:
a magnification/shrinkage processing section that magnifies or shrinks the coordinates calculated by the second transformed-coordinate calculating section with reference to a specific position on the display screen, on the basis of a coordinate size subject to coordinate transformation by the second transformed-coordinate calculating section, and a size of the background image on the display screen of the display section,
wherein the display control section displays the background image and the plurality of superimposed images in such a way that the superimposed images are placed at the coordinates in the background image magnified or shrunk by the magnification/shrinkage processing section.

4. The information processing apparatus according to claim 1, wherein:
the background image is an image representing a map; and
the superimposed images are images representing a plurality of contents with each of which positional information indicating a position in the map is associated.

5. The information processing apparatus according to claim 4, further comprising:
a group setting section that sets a plurality of groups by classifying the plurality of contents on the basis of the positional information; and
a mark generating section that generates marks representing the groups on the basis of the positional information associated with each of contents belonging to the set groups,
wherein the display control section displays a listing of the marks representing the groups as the superimposed images.

6. The information processing apparatus according to claim 5, wherein the mark generating section generates maps as the marks representing the groups, the maps each corresponding to an area including a position identified by the positional information associated with each of the contents belonging to the set groups.

7. The information processing apparatus according to claim 6, wherein the mark generating section generates the marks representing the groups by changing a map scale for each of the set groups so that each of the maps becomes an image with a predetermined size.

8. The information processing apparatus according to claim 6, further comprising:
a background map generating section that generates a background map corresponding to each of the groups at a scale determined in accordance with a scale of each of maps generated as the marks representing the groups; and
the display control section displays, as the background image, the background map generated with respect to a group corresponding to a map selected from among the displayed listing of maps.

9. An information processing method comprising the steps of:
calculating transformed coordinates for each of a plurality of superimposed images associated with coordinates in a background image, by taking one superimposed image of the plurality of superimposed images as a reference image, and transforming coordinates of other superimposed images on the basis of corresponding coordinates of the reference image in the background image, distances in the background image from the reference image to the other superimposed images, and a distance in the background image from the reference image to a boundary within a predetermined area with respect to the reference image, the coordinates of the other superimposed images being transformed in such a way that coordinate intervals within the predetermined area become denser with increasing distance from the reference image toward the boundary within the predetermined area;
setting coordinates of the reference image on the basis of a mean value obtained by calculating a mean of the calculated coordinates of the other superimposed images with respect to the reference image; and
displaying the background image and the plurality of superimposed images on a display section in such a way that the reference image is placed at the set coordinates in the background image.

10. A program for causing a computer to execute the steps of:
calculating transformed coordinates for each of a plurality of superimposed images associated with coordinates in a background image, by taking one superimposed image of the plurality of superimposed images as a reference image, and transforming coordinates of other superimposed images on the basis of corresponding coordinates of the reference image in the background image, distances in the background image from the reference image to the other superimposed images, and a distance in the background image from the reference image to a boundary within a predetermined area with respect to the reference image, the coordinates of the other superimposed images being transformed in such a way that coordinate intervals within the predetermined area become denser with increasing distance from the reference image toward the boundary within the predetermined area;
setting coordinates of the reference image on the basis of a mean value obtained by calculating a mean of the calculated coordinates of the other superimposed images with respect to the reference image; and
displaying the background image and the plurality of superimposed images on a display section in such a way that the reference image is placed at the set coordinates in the background image.
